(19) United States
(12) Patent Application Publication
(10) Pub. No.: US 2026/0308975 A1
(43) Pub. Date: Oct. 8, 2026

(54) A FLUIDIC SYSTEM FOR CLIMATE CONTROL

(71) Applicant: President and Fellows of Harvard College, Cambridge, MA (US)

(72) Inventors: Joanna AIZENBERG, Cambridge, MA (US); Raphael M. KAY, Cambridge, MA (US); Thomas SCHROEDER, Cambridge, MA (US)

(21) Appl. No.: 19/483,022

(22) PCT Filed: May 10, 2024
(86) PCT No.: PCT/US24/28944

§ 371 Date: Nov. 10, 2025

Related U.S. Application Data
(60) Provisional application No. 63/501,657, filed on May 11, 2023.

(51) Int. Cl. E06B 9/24; E06B 3/67

(52) U.S. Cl. CPC E06B 9/24; E06B 3/6722; E06B 2009/2411

(57) ABSTRACT

Disclosed herein are systems that can dynamically and independently control the amount (or intensity), the spectrum (or wavelength), and/or the angle (or dispersion) of a beam of transmitted light and/or thermal radiation, conduction, and/or convection using fluids. In some embodiments, the present disclosure describes systems capable of universally controlling light and/or thermal radiation. In some embodiments, disclosed herein are systems that can orthogonally manipulate the intensity, spectrum, direction and/ or distribution of a beam of light using fluids. In some embodiments, disclosed herein are systems that can tune optical transmission and thermal conduction orthogonally using fluids. In some embodiments, disclosed herein is a system that can simultaneously control visible and thermal radiation or visible, thermal and near-IR radiation using fluids. In some embodiments, disclosed herein are systems that can dynamically control radiative, conductive, and convective heat exchange using fluids.

### CROSS-REFERENCES TO RELATED APPLICATIONS

This patent application claims the benefit of U.S. Provisional Application No. 63/501,657, filed on May 11, 2023, the contents of which is herein incorporated by reference in its entirety.

### STATEMENT REGARDING FEDERALLY SPONSORED RESEARCH OR DEVELOPMENT

This invention was made with government support under DE-SC0005247 awarded by U.S. Department of Energy (DOE). The U.S. Government has certain rights in the invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The instant application relates to universal indoor climate control. In particular, the instant application relates to multilayer systems including fluids that can be dynamically changed.

### BACKGROUND

Climate control in buildings is a significant energy end-use. More than one-quarter of global energy consumption is spent heating, cooling, and lighting indoor environments. Universally adaptive systems to control indoor climate in response to the environment outside of and operation inside of a building do not exist. There is a need for systems and devices that can dynamically adapt to environmental and operational conditions to facilitate indoor climate control.

### SUMMARY

Certain embodiments of the present disclosure describe a system including a first layer including a first transparent solid material; a second layer including a second transparent solid material, the second transparent solid material including a scattering surface; and a first gap between the first layer and the scattering surface of the second layer configured to allow a first fluid to selectively flow into and out of the first gap, the presence of the first fluid in the first gap configured to at least one of selectively absorb light between the first layer and the second layer or selectively control scattering of light between the first layer and the second layer by one or more of: the scattering surface of the second layer; a refractive index difference between the first fluid and the scattering surface of the second layer; or suspended particles in the first fluid configured to selectively scatter light; wherein the system is configured to independently control two or more of intensity of light transmitted, distribution of forward scattering, direction of scattering, and wavelength of light transmitted.

In some embodiments, the system further includes a third layer including a third transparent solid material; and a second gap between the third layer and the first layer or between the third layer and the second layer and configured to allow a second fluid into and out of the second gap, and the presence of the second fluid configured to at least one of selectively scatter, reflect, or absorb light in the second gap.

In some embodiments, one or more of the first transparent solid material, the second transparent solid material, or the third transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, one or more of the first transparent solid material, the second transparent solid material, and the third transparent solid material includes glass, polydimethylsiloxane, polyethylene, polymethylmethacrylate, or any combination thereof.

In some embodiments, the first transparent solid material and the third transparent solid material each include glass and the second transparent solid material includes polydimethylsiloxane.

In some embodiments, the second transparent solid material includes polydimethylsiloxane, polyethylene, polymethylmethacrylate, or a combination thereof.

In some embodiments, the scattering surface includes a roughened surface, a frosted surface, a patterned surface, a porous surface, an ordered surface, a grated surface, a lens-like surface, a photonic crystal surface, a Fresnel surface, or any combination thereof.

In some embodiments, the scattering surface includes a roughened surface.

In some embodiments, the roughened surface has a root-mean-squared surface roughness of between 0.5 μm and 5 μm, between 1.5 μm and 3.0 μm, between 1.0 μm and 1.5 μm, or between 1.5 μm and 2.5 μm; and a mean roughness value of between 0.5 μm and 5 μm, between 1.5 μm and 3.0 μm, between 1.0 μm and 1.5 μm, or between 1.5 μm and 2.5 μm.

In some embodiments, the roughened surface has a root-mean-squared surface roughness value of between 1.5 μm and 2.5 μm and a mean roughness value of between 1.5 μm and 2.5 μm.

In some embodiments, the scattering surface has a refractive index between 1.0 and 2.0, between 1.2 and 1.8, between 1.3 and 1.7, between 1.3 and 1.5, or between 1.5 and 1.7.

In some embodiments, the scattering surface has a refractive index between 1.3 and 1.5.

In some embodiments, the first gap defines a distance between the first layer and the second layer of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm.

In some embodiments, the first gap defines a distance between the first layer and the second layer of between 1 mm and 5 mm.

In some embodiments, the second gap defines a distance between the second layer and the third layer of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm.

In some embodiments, the second gap defines a distance between the second layer and the third layer of between 1 mm and 5 mm.

In some embodiments, the first fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the first fluid includes isopropanol, index-matching silicone oil, mineral oil, or a combination thereof.

In some embodiments, the first fluid has a refractive index of between 1 and 1.7, between 1.3 and 1.5, between 1 and 1.3, or between 1 and 1.5.

In some embodiments, the first fluid has a refractive index of between 1.3 and 1.5.

In some embodiments, the first fluid and the scattering surface have the refractive index difference, the refractive index difference is between 0 and 0.6, between 0 and 0.5, between 0.2 and 0.5, or between 0.4 and 0.5.

In some embodiments, the first fluid and the scattering surface have a refractive index difference of between 0 and 0.5.

In some embodiments, the refractive index of the scattering surface is the same as the refractive index of the first fluid such that lack of the first fluid in the first gap results in scattering of light due to the scattering surface and presence of the first fluid in the first gap diminishes the scattering of light.

In some embodiments, the first fluid includes a plurality of first fluids, the plurality of first fluids having different refractive indices and being configured to selectively and independently fill the first gap.

In some embodiments, the first fluid includes a pigment.

In some embodiments, the pigment in the first fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the first fluid includes carbon black.

In some embodiments, the pigment has a concentration in the first fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the first fluid of between 0 mg/mL and 0.5 mg/mL.

In some embodiments, the system is configured to dynamically increase or decrease the concentration of the pigment in the first fluid.

In some embodiments, the first fluid includes the suspended particles and the suspended particles include TiO₂, MgO, BaSO₄, CaCO₃, CaHPO4, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the first fluid includes the suspended particles and the suspended particles include TiO₂, MgO, BaSO₄, ZrO₂, or a combination thereof.

In some embodiments, the first fluid includes the suspended particles and the suspended particles in the first fluid have a size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the first fluid includes the suspended particles and the suspended particles in the first fluid have a concentration in the first fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the first fluid.

In some embodiments, the first fluid is water and the suspended particles in the first fluid comprise TiO₂ particles having a size of between 10 nm and 50 nm and a concentration of between 0 mg/mL and 64 mg/mL.

In some embodiments, the concentration and the size of the suspended particles in the first fluid control the intensity and proportion of light that is scattered forward or backward.

In some embodiments, the refractive index of the scattering surface is the same as the refractive index of the first fluid and the first fluid further includes suspended particles configured to scatter light backward in the first gap such that lack of the first fluid in the first gap results in diffuse forward scattering of light due to the scattering surface and presence of the first fluid in the first gap back-scatters light in the first gap and diminishes the forward scattering of light due to the scattering surface.

In some embodiments, the suspended particles in the first fluid are configured to back scatter light having a wavelength of between 300 nm and 700 nm, between 700 nm and 2500 nm, or between 300 nm and 2500 nm.

In some embodiments, the selective scattering of light is defined by the proportion of light scattered forward or backward.

In some embodiments, the first fluid includes a plurality of first fluids, and proportion of light scattered forward directly or diffusely by the scattering surface is dynamically changed by exchanging fluids in the plurality of the first fluids within the first gap to decrease or increase the refractive index difference between the fluid in the first gap and the scattering surface.

In some embodiments, dynamically increasing or decreasing the concentration of the suspended particles in the first fluid dynamically decreases or increases the intensity of light that is scattered forward and dynamically increases or decreases the intensity of light that is scattered backward between the first layer and the second layer.

In some embodiments, the refractive index of the first fluid and the second layer are the same, the system scatters light directly forward when the first fluid is present, and the scattering surface is configured to scatter light diffusely forward at the scattering surface when the first fluid is not present in the first gap.

In some embodiments, the refractive index of the first fluid and the second layer are the same, the scattering surface is configured to selectively scatter light diffusely forward at the scattering surface when the first fluid is not present in the first gap, and the suspended particles in the first fluid selectively scatter light backward.

In some embodiments, one or both of the first fluid in the first gap and the scattering surface are configured to scatter light having a wavelength of between 300 nm and 700 nm, between 700 nm and 2500 nm, and 300 nm and 2500 nm.

In some embodiments, the first fluid selectively scatters, reflects, or absorbs light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the first fluid selectively scatters, reflects, or absorbs light having a wavelength of between 300 nm and 700 nm, 300 nm and 2500 nm, or 700 nm and 2500 nm.

In some embodiments, the first fluid selectively scatters, reflects, or absorbs light having a wavelength of between 300 nm and 700 nm.

In some embodiments, the first fluid selectively scatters, reflects, or absorbs light having a wavelength of between 700 nm and 2500 nm.

In some embodiments, one or more of the first fluid or the second fluid includes a plurality of fluids, the plurality of fluids being configured to selectively and independently fill the respective first gap or second gap.

In some embodiments, at least one of the plurality of fluids is a cleansing fluid, the cleansing fluid being immiscible with at least one of the other plurality of fluids, and the cleansing fluid and at least one of the other plurality of fluids are configured to be dynamically exchanged with each other such that the cleansing fluid removes the at least one of the other plurality of fluids from the respective first gap or second gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a combination thereof.

In some embodiments, the second fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the second fluid includes water, isopropanol, glycerol, or any combination thereof.

In some embodiments, the second fluid includes a pigment.

In some embodiments, the pigment in the second fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the second fluid includes carbon black.

In some embodiments, the pigment has a concentration in the second fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the second fluid of between 0 mg/mL and 0.5 mg/mL.

In some embodiments, the system is configured to dynamically increase or decrease the concentration of the pigment in the second fluid.

In some embodiments, the second fluid includes suspended particles.

In some embodiments, the suspended particles in the second fluid include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the second fluid have size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles in the second fluid have a concentration in the second fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the second fluid.

In some embodiments, the second fluid is water and the suspended particles in the second fluid include TiO₂ particles having a size of between 10 nm and 50 nm and a concentration of between 0 mg/mL and 64 mg/mL in the second fluid.

In some embodiments, the concentration and the size of the suspended particles in the second fluid selectively scatter light.

In some embodiments, the selective scattering of light is defined by the proportion of light scattered forward or backward.

In some embodiments, the concentration and size of the suspended particles in the second fluid control the intensity and proportion of light that is scattered forward or backward.

In some embodiments, dynamically increasing or decreasing the concentration of the suspended particles in the second fluid dynamically decreases or increases the intensity of light that is scattered forward and dynamically increases or decreases the intensity of light that is scattered backward between the third layer and the first layer.

In some embodiments, the second fluid selectively scatters, reflects, or absorbs light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the second fluid selectively scatters, reflects, or absorbs light having a wavelength of between 300 nm and 700 nm, 300 nm and 2500 nm, or 700 nm and 2500 nm.

In some embodiments, the second fluid selectively scatters, reflects, or absorbs light having a wavelength of between 300 nm and 700 nm.

In some embodiments, the second fluid selectively scatters, reflects, or absorbs light having a wavelength of between 700 nm and 2500 nm.

In some embodiments, the system includes a fourth layer: the fourth layer including a fourth transparent solid material; the fourth layer disposed on the opposite side of the third layer from the first layer; a third gap between the third layer and the fourth layer configured to allow a third fluid to selectively flow into and out of the third gap, the presence of the third fluid in the third gap configured to selectively reduce transmission of light between the fourth layer and the third layer.

In some embodiments, the presence of the third fluid in the third gap is configured to reduce transmission of light by at least one of selectively scattering, reflecting, or absorbing light between the third layer and the fourth layer.

In some embodiments, the fourth transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the third gap defines a distance of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm between the third layer and the fourth layer.

In some embodiments, the third fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the third fluid includes water, mineral oil, isopropanol, or any combination thereof.

In some embodiments, the third fluid includes a plurality of third fluids, the plurality of third fluids being configured to selectively and independently fill the third gap.

In some embodiments, at least one of plurality of third fluids is a cleansing fluid, the cleansing fluid being immiscible with at least one of the other plurality of third fluids, and the cleansing fluid and at least one of the other plurality of third fluids are configured to be dynamically exchanged with each other such that the cleansing fluid removes the at least one of the other plurality of third fluids from the third gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a combination thereof.

In some embodiments, the third fluid includes suspended particles.

In some embodiments, the suspended particles in the third fluid include TiO₂, MgO, BaSO₄, CaCO₃, CaHPO4, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the third fluid have size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles in the third fluid have a concentration in the third fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the third fluid.

In some embodiments, the third fluid is water and the suspended particles in the third fluid include TiO₂ particles having a size of between 10 nm and 50 nm and a concentration of between 0 mg/mL and 64 mg/mL in the third fluid.

In some embodiments, the concentration and the size of the suspended particles in the third fluid selectively scatter light.

In some embodiments, the selective scattering of light is defined by the proportion of light scattered forward or backward.

In some embodiments, the concentration and size of the suspended particles in the third fluid control the intensity and proportion of light that is scattered forward or backward.

In some embodiments, dynamically increasing or decreasing the concentration of the suspended particles in the third fluid dynamically decreases or increases the intensity of light that is scattered forward and dynamically increases or decreases the intensity of light that is scattered backward between the second layer and the third layer.

In some embodiments, the third fluid includes a pigment.

In some embodiments, the pigment in the third fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the third fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, or a combination thereof.

In some embodiments, the pigment has a concentration in the third fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the third fluid of between 0 mg/mL and 0.5 mg/mL.

In some embodiments, the system is configured to dynamically increase or decrease the concentration of the pigment in the third fluid.

In some embodiments, the presence of the third fluid in the third gap is configured to at least one of selectively scatter, reflect, or absorb light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the presence of the third fluid in the third gap is configured to at least one of selectively scatter, reflect, or absorb light having a wavelength of between 300 nm and 700 nm, 300 nm and 2500 nm, or 700 nm and 2500 nm.

In some embodiments, the presence of the third fluid in the third gap is configured to absorb light having a wavelength of between 700 nm and 30000 nm or between 2500 nm and 30000 nm.

In some embodiments, the presence of the third fluid in the third gap is configured to absorb light having a wavelength of between 300 nm and 2500 nm.

In some embodiments, the presence of the third fluid in the third gap is configured to absorb light, the light having a wavelength of between 300 nm and 700 nm.

In some embodiments, the presence of the third fluid in the third gap is configured to scatter light, the light having a wavelength of between 300 nm and 700 nm.

In some embodiments, the system includes a fifth layer: the fifth layer including a fifth transparent solid material; the fifth layer disposed opposite the second layer from the first layer; a fourth gap defining a distance of between 5 mm and 50 mm between the second layer and the fifth layer configured to allow a fourth fluid to selectively flow into and out of the fourth gap, the presence of the fourth fluid in the third gap configured to control the convection of heat within the fourth gap and conduction of heat through the fourth gap.

In some embodiments, the fourth fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, one or more of the first solid material, the second solid material, the third solid material, the fourth solid material, or the fifth solid material includes a transparent coating.

In some embodiments, the transparent coating includes a metal, a metal oxide, a metal-oxide/metal/metal-oxide sandwich, or a combination thereof.

In some embodiments, the transparent coating includes indium tin oxide.

In some embodiments, the transparent coating reflects light in the wavelength band between 2500 nm and 30000 nm.

In some embodiments, the transparent coating is configured to reduce transfer of heat through the second gap in absence of the second fluid.

Certain embodiments of the present disclosure describe a system including a first layer including a first transparent solid material; a second layer including at least one second transparent solid material; at least a first gap between the first layer and the second layer configured to allow at least a first fluid to selectively flow into and out of the first gap, presence of the first fluid in the first gap is configured to at least one of selectively scatter light, reflect light, or absorb light between the first layer and the second layer; a third layer including a third transparent solid material; and a second gap defining a distance of 5-50 mm between the second layer and the third layer and configured to allow a second fluid to selectively flow into and out of the second gap, the second gap being on an opposite side of the second layer from the first gap, and presence of the second fluid in the second gap is configured to transfer heat energy through the second gap based on convection and conduction of heat in the second fluid.

In some embodiments, one or more of the first transparent solid material, the second transparent solid material, or the third transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the first transparent solid material, the second transparent solid material, and the third transparent solid material each include glass.

In some embodiments, the second transparent solid material includes a transparent coating, the transparent coating configured to reflect light in at least one wavelength band.

In some embodiments, the transparent coating includes a metal, a metal oxide, a metal-oxide/metal/metal-oxide sandwich, or a combination thereof.

In some embodiments, the transparent coating includes indium tin oxide.

In some embodiments, the transparent coating reflects light in the wavelength band between 2500 nm and 30000 nm.

In some embodiments, the transparent coating is configured to reduce transfer of heat through the second gap in absence of the second fluid.

In some embodiments, the first gap defines a distance of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm between the first layer and the second layer.

In some embodiments, the first gap defines a distance of between 0.1 mm and 5 mm between the first layer and the second layer.

In some embodiments, the second gap defines a distance of between 5 mm and 50 mm, between 5 mm and 20 mm, between 5 mm and 12 mm, between 5 mm and 8 mm, between 8 mm and 50 mm, between 8 mm and 20 mm, or between 20 mm and 50 mm between the second layer and the third layer.

In some embodiments, the second gap defines a distance of between 5 mm and 12 mm between the second layer and the third layer.

In some embodiments, one or both of the first fluid and the second fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the first fluid includes isopropanol, water, mineral oil, ethylene glycol, or any combination thereof.

In some embodiments, the second fluid includes water.

In some embodiments, one or more of the first fluid or the second fluid includes a plurality of fluids, the plurality of fluids being configured to selectively and independently fill the respective first gap or second gap.

In some embodiments, at least one of the plurality of fluids is a cleansing fluid, the cleansing fluid being immiscible with at least one of the other plurality of fluids, and the cleansing fluid and at least one of the other plurality of fluids are configured to be dynamically exchanged with each other such that the cleansing fluid removes the at least one of the other plurality of fluids from the first gap or second gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives.

In some embodiments, one or more of the first fluid and the second fluid includes suspended particles.

In some embodiments, the suspended particles in the first fluid or the second fluid include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the first fluid or the second fluid have size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles have a concentration in the first fluid or the second fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the first fluid or the second fluid.

In some embodiments, the first fluid or the second fluid is water and the suspended particles include TiO₂ particles having a size of between 10 nm and 50 nm, and a concentration of between 0 mg/mL and 64 mg/mL in the first fluid or the second fluid.

In some embodiments, the suspended particles in the first fluid or the second fluid selectively scatter light.

In some embodiments, the selective scattering of light is defined by the proportion of light scattered forward or backward.

In some embodiments, the concentration and size of the suspended particles in the first fluid or the second fluid control the intensity and proportion of the light that is scattered forward or backward.

In some embodiments, dynamically increasing or decreasing the concentration of the suspended particles in the first fluid or the second fluid dynamically decreases or increases the intensity of light that is scattered forward and dynamically increases or decreases the intensity of light that is scattered backward between the first layer and the second layer or between the second layer and the third layer.

In some embodiments, one or more of the first fluid or the second fluid includes a pigment.

In some embodiments, the pigment in the first fluid or the second fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the first fluid or the second fluid includes carbon black.

In some embodiments, the pigment has a concentration in the first fluid or the second fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the first fluid or the second fluid of between 0 mg/mL and 0.5 mg/mL.

In some embodiments, the system is configured to dynamically increase or decrease the concentration of the pigment in the first fluid or the second fluid.

In some embodiments, one or more of the presence of first fluid in the first gap or the presence of the second fluid in the second gap is configured to at least one of selectively scatter, reflect, or absorb light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, one or more of the presence of the first fluid in the first gap or the presence of the second fluid in the second gap is configured to at least one of selectively scatter, reflect, or absorb light having a wavelength of between 300 nm and 700 nm, 300 nm and 2500 nm, or 700 nm and 2500 nm.

In some embodiments, one or more of the presence of the first fluid in the first gap or the presence of the second fluid in the second gap is configured to absorb light having a wavelength of between 700 nm and 30000 nm.

In some embodiments, wherein one or more of the presence of the first fluid in the first gap or the presence of the second fluid in the second gap is configured to absorb light having a wavelength of between 300 nm and 2500 nm.

In some embodiments, one or more of the presence of the first fluid in the first gap or the presence of the second fluid in the second gap is configured to absorb light having a wavelength of between 300 nm and 700 nm.

In some embodiments, one or more of the first fluid or the second fluid includes the suspended particles and the presence of the first fluid in the first gap or the presence of the second fluid in the second gap is configured to back scatter light having a wavelength of between 300 nm and 700 nm, between 700 nm and 2500 nm, or between 300 nm and 2500 nm.

In some embodiments, the one or more of the first fluid or the second fluid includes the suspended particles and the presence of the first fluid in the first gap or presence of the second fluid in the second gap is configured to back scatter light having a wavelength of between 300 nm and 700 nm.

In some embodiments, one or more of the presence of the first fluid in the first gap or presence of the second fluid in the second gap is further configured to transfer heat energy through the first gap by one or more of conduction or convection.

In some embodiments, the first fluid is configured to absorb light and the presence of the first fluid in the first gap is configured to transfer heat energy from the absorbed light to the second layer through conduction.

In some embodiments, the presence of the first fluid in the first gap and the presence of the second fluid in the second gap is configured to transfer heat energy through the system at a greater rate than either absence of the second fluid in the second gap and presence of the first fluid in the first gap or absence of the second fluid in the second gap and absence of the first fluid in the first gap due convection and conduction of heat energy from the first fluid in the first gap through the second fluid in the second gap.

In some embodiments, the second layer further includes a scattering surface disposed on the same side of the second layer as the first gap configured to selectively control scattering of light between the first layer and the second layer by one or more of: presence of the first fluid in the first gap, a refractive index difference between the first fluid and the scattering surface, and suspended particles in the first fluid configured to selectively scatter light.

In some embodiments, the first layer is transparent to light having a wavelength between 700 nm and 30000 nm, the first fluid includes a heat emissive fluid configured to absorb heat energy having a wavelength of between 700 nm and 30000 nm, the presence of the first fluid in the first gap and presence of the second fluid in the second gap is configured to transfer heat energy through the system at a greater rate than either absence of the second fluid in the second gap and the presence of the first fluid in the first gap or absence of the second fluid in the second gap and absence of the first fluid in the first gap due to conduction of heat energy from the first fluid in the first gap through the second fluid in the second gap.

In some embodiments, the first layer includes polyethylene; the first fluid includes water or glycerol, wherein the presence of the first fluid in the first gap is configured to absorb heat energy having a wavelength of between 700 nm and 2500 nm; the second fluid includes mineral oil, silicone oil, water, ethanol, isopropanol, glycerol, ethylene glycol, or any combination thereof; and presence of the first fluid in the first gap and the presence of the second fluid in the second gap is configured to transfer heat energy through the system at a greater rate than either absence of the second fluid in the second gap and the presence of the first fluid in the first gap or absence of the second fluid in the second gap and absence of the first fluid in the first gap due to conduction of heat energy from the first fluid in the first gap through the second fluid in the second gap.

In some embodiments, the first layer includes polyethylene; the first fluid includes water or glycerol, and a pigment, wherein the presence of the first fluid in the first gap is configured to selectively absorb light having a wavelength of between 300 nm and 2500 nm; the second fluid includes mineral oil, silicone oil, water, ethanol, isopropanol, glycerol, ethylene glycol, or any combination thereof; and presence of the first fluid in the first gap and the presence of the second fluid in the second gap is configured to transfer heat energy through the system at a greater rate than either absence of the second fluid in the second gap and the presence of the first fluid in the first gap or absence of the second fluid in the second gap and absence of the first fluid in the first gap due to conduction of heat energy from the first fluid in the first gap through the second fluid in the second gap.

In some embodiments, the system includes a fourth layer: the fourth layer including a fourth transparent solid material; the fourth layer disposed on the opposite side of the first layer from the second layer; a third gap between the first layer and the fourth layer configured to allow a third fluid to selectively flow into and out of the third gap, presence of the third fluid in the third gap is configured to at least one of selectively scatter light, reflect light, or absorb light between the first layer and the second layer; or transfer heat energy based on one or more of convection and conduction of heat in the third fluid.

In some embodiments, the fourth transparent solid material includes glass, transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the third gap defines a distance of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm between the first layer and the fourth layer.

In some embodiments, the third fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the third fluid includes isopropanol, water, mineral oil, ethylene glycol, or any combination thereof.

In some embodiments, the third fluid includes a plurality of third fluids, the plurality of third fluids being configured to selectively and independently fill the third gap.

In some embodiments, at least one of plurality of third fluids is a cleansing fluid, the cleansing fluid being immiscible with at least one of the other plurality of third fluids, and the cleansing fluid and at least one of the other plurality of third fluids are configured to be dynamically exchanged with each other such that the cleansing fluid removes the at least one of the other plurality of third fluids from the third gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a combination thereof.

In some embodiments, the third fluid includes suspended particles.

In some embodiments, the suspended particles in the third fluid include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the third fluid have size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles in the third fluid have a concentration in the third fluid of between between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the third fluid.

In some embodiments, the third fluid is water and the suspended particles include TiO₂ particles having a size of between 10 nm and 50 nm, and a concentration of between 0 mg/mL and 64 mg/mL in the third fluid.

In some embodiments, the suspended particles in the third fluid selectively scatter light.

In some embodiments, the selective scattering of light is defined by the proportion of light scattered forward or backward.

In some embodiments, the concentration and the size of the suspended particles in the third fluid control the intensity and proportion of light that is scattered forward or backward.

In some embodiments, dynamically increasing or decreasing the concentration of the suspended particles in the third fluid dynamically decreases or increases the intensity of light that is scattered forward and dynamically increases or decreases the intensity of light that is scattered backward between the fourth layer and the first layer.

In some embodiments, the third fluid includes a pigment.

In some embodiments, the pigment in the third fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the third fluid includes carbon black.

In some embodiments, the pigment has a concentration in the third fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the third fluid of between 0 mg/mL and 0.5 mg/mL.

In some embodiments, the system is configured to dynamically increase or decrease the concentration of the pigment in the third fluid.

In some embodiments, the presence of the third fluid in the third gap is configured to at least one of selectively scatter, reflect, or absorb light, the light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the presence of the third fluid in the third gap is configured to at least one of selectively scatter, reflect, or absorb light, the light having a wavelength of between 300 nm and 700 nm, 300 nm and 2500 nm, or 700 nm and 2500 nm.

In some embodiments, the presence of the third fluid in the third gap is configured to absorb light, the light having a wavelength of between 700 nm and 30000 nm.

In some embodiments, the presence of the third fluid in the third gap is configured to absorb light, the light having a wavelength of between 300 nm and 2500 nm.

In some embodiments, the presence of the third fluid in the third gap is configured to absorb light, the light having a wavelength of between 300 nm and 700 nm.

In some embodiments, the presence of the third fluid in the third gap is configured to scatter light, the light having a wavelength of between 300 nm and 700 nm.

In some embodiments, the first gap defines a distance of between 5 mm and 50 mm between the first layer and the second layer; the second gap defines a distance of between 5 mm and 50 mm between the second layer and the third layer; the third gap defines a distance of between 5 mm and 50 mm between the first layer and the fourth layer; the presence of the first fluid in the first gap is configured to at least one of selectively absorb light; or transfer heat energy to one or both of the first layer and the second layer based on convection and conduction of heat in the first fluid; the presence of the second fluid in the second gap is configured to at least one of selectively absorb light; or transfer heat energy to one or both of the first layer and the second layer based on convection and conduction of heat in the second fluid; and the presence of the third fluid in the third gap is configured to at least one of selectively absorb light; or transfer heat energy to one or both of the first layer and the second layer based on convection and conduction of heat in the third fluid.

In some embodiments, the system of claim 191, wherein the first solid material includes a first transparent coating disposed on both sides of the first solid material, and the second solid material includes a second transparent coating disposed on both sides of the second solid material.

In some embodiments, one or both of the first transparent coating and the second transparent coating is configured to reflect light in at least one wavelength band.

In some embodiments, one or both of the first transparent coating or the second transparent coating includes a metal, a metal oxide, a metal-oxide/metal/metal-oxide sandwich, or a combination thereof.

In some embodiments, one or both of the first transparent coating or the second transparent coating includes indium tin oxide, or a TiO₂/Ag/TiO₂.

In some embodiments, one or more of the first fluid, the second fluid, and the third fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, one or more of the first fluid, the second fluid, and the third fluid includes a pigment.

In some embodiments, the system is configured to selectively transition between at least two of: a first state in which the first fluid is not present in the first gap, the second fluid is not present in the second gap, the third fluid is not present in the third gap, such that the absence of the first fluid, the second fluid, and the third fluid insulates from heat transfer through the system; a second state in which the first fluid is present in the first gap, the second fluid is not present in the second gap, and the third fluid is present in the third gap, such that heat energy in the first fluid is transferred to the third fluid through the first layer by convection and conduction of the first fluid and such that the absence of the second fluid in the second gap insulates heat transfer from the first fluid through the second gap; a third state in which the first fluid present in the first gap, the second fluid is not present in the second gap, and the third fluid is not present in the third gap, wherein the absence of the second fluid in the second gap and the third fluid in the third gap insulates heat transfer from the first fluid through second gap and the third gap, respectively, such that heat energy is stored in the first fluid; a fourth state in which the first fluid is present in the first gap, the second fluid is present in the second gap, and the third fluid is not present in the third gap such that heat energy from the first fluid is transferred to the second fluid through the second layer by convection and conduction of the first fluid, and heat energy in the second layer is transferred to the third layer by convection and conduction of the second fluid; and a fifth state in which the first fluid is present in the first gap, the second fluid is present in the second gap, and the third fluid is present in the third gap, such that heat energy in the third fluid is transferred to the first fluid through the first layer by convection and conduction of the third fluid and such that the heat energy in the first fluid is transferred to the second fluid through the second layer by convection and conduction of the first fluid.

Certain embodiments of the present disclosure describe a system including a first layer including a first transparent solid material; a second layer including a second transparent solid material and a transparent coating, the transparent coating configured to transmit light having a wavelength between 300 nm and 2500 nm and reflect light having wavelength between 2500 nm and 30000 nm; a first gap between the first layer and the second layer configured to allow a first fluid to selectively flow into and out of the first gap, the presence of the first fluid in the first gap configured to be heat emissive and absorb heat energy having a wavelength between 2500 nm and 30000 nm such that the first fluid in the system absorbs heat energy from an environment outside the first layer or emits heat energy from the first fluid into the environment outside the first layer, and absence of the first fluid reduces absorption or emission of heat energy through the first gap due to the transparent coating of the second layer; a third layer comprising a third transparent solid material; and a second gap between the second layer and the third layer configured to allow a second fluid to selectively flow into and out of the second gap, the second gap being on an opposite side of the second layer from the first gap, and the presence of the second fluid in the second gap configured to one or more of selectively scatter, reflect, or absorb light between the second layer and the third layer, or transfer heat energy based on conduction of heat through the second fluid.

In some embodiments, one or more of the first transparent solid material, the second transparent solid material, or the third transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the first transparent solid material includes polyethylene.

In some embodiments, the second transparent solid material includes glass or polymethylmethacrylate.

In some embodiments, the third transparent solid material includes glass or polymethylmethacrylate.

In some embodiments, the transparent coating includes a metal, metal oxide, a metal-oxide/metal/metal-oxide sandwich, or a combination thereof.

In some embodiments, the transparent coating includes 100-300 nm thick indium tin oxide.

In some embodiments, the first gap defines a distance of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm between the first layer and the second layer.

In some embodiments, the first gap defines a distance of 1 mm and 5 mm between the first layer and the second layer.

In some embodiments, the second gap defines a distance of 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 50 mm, between 5 and 20 mm, or between 1 mm and 5 mm between the second layer and the third layer.

In some embodiments, the second gap defines a distance of between 5 mm and 20 mm between the second layer and the third layer.

In some embodiments, one or both of the first fluid or the second fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the first fluid includes glycerol, isopropanol, ethanol, or mineral oil.

In some embodiments, the second fluid includes water, isopropanol, or ethanol.

In some embodiments, one or more of the first fluid or the second fluid includes a plurality of fluids, the plurality of fluids being configured to selectively and independently fill the respective first gap or second gap.

In some embodiments, at least one of the plurality of fluids is a cleansing fluid, the cleansing fluid being immiscible with at least one of the other plurality of fluids, and the cleansing fluid and at least one of the other plurality of fluids are configured to be dynamically exchanged with each other such that the cleansing fluid removes the at least one of the other plurality of fluids from the respective first gap or second gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a combination thereof.

In some embodiments, the second fluid includes a pigment.

In some embodiments, the pigment in the second fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the second fluid includes carbon black.

In some embodiments, the pigment in the second fluid has a concentration in the second fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the second fluid of between 0 mg/mL and 0.5 mg/mL.

In some embodiments, the system is configured to dynamically increase or decrease the concentration of the pigment in the second fluid.

In some embodiments, the second fluid absorbs light, the light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the second fluid absorbs light, the light having a wavelength of between 300 nm and 700 nm, 300 nm and 2500 nm, or 700 nm and 2500 nm.

In some embodiments, the second fluid absorbs light, the light having a wavelength of between 300 nm and 700 nm.

In some embodiments, the second fluid includes suspended particles.

In some embodiments, the suspended particles in the second fluid include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the second fluid have a size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles have a concentration in the second fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the second fluid.

In some embodiments, the second fluid is water and the suspended particles include TiO₂ particles having a size of between 10 nm and 50 nm, and a concentration of between 0 mg/mL and 64 mg/mL in the second fluid.

In some embodiments, the suspended particles in the second fluid selectively scatter light.

In some embodiments, the selective scattering of light is defined by the proportion of light scattered forward or backward.

In some embodiments, the concentration and size of the suspended particles in the second fluid control the intensity and proportion of light that is scattered forward or backward.

In some embodiments, dynamically increasing or decreasing the concentration of the suspended particles in the second fluid dynamically decreases or increases the intensity of light that is scattered forward and dynamically increases or decreases the intensity of light that is scattered backward between the second layer and the third layer.

In some embodiments, presence of the first fluid in the first gap and absence of the second fluid in the second gap reduces transfer of heat energy from the first fluid through the second gap.

In some embodiments, the system includes a fourth layer: the fourth layer including a fourth transparent solid material; the fourth layer disposed on the opposite side of the first layer from the second layer; a third gap between the first layer and the fourth layer configured to allow a third fluid to selectively flow into and out of the third gap, the presence of the third fluid in the third gap configured to selectively scatter light or absorb light between the first layer and the fourth layer.

In some embodiments, the system of claim 236, wherein the fourth transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the third gap defines a distance of between 1 mm and 5 mm between the first layer and the fourth layer.

In some embodiments, the third fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the third fluid includes water, mineral oil, isopropanol, or any combination thereof.

In some embodiments, the third fluid includes a plurality of third fluids, the plurality of third fluids being configured to selectively and independently fill the third gap.

In some embodiments, at least one of plurality of third fluids is a cleansing fluid, the cleansing fluid being immiscible with at least one of the other plurality of third fluids, and the cleansing fluid and at least one of the other plurality of third fluids are configured to be dynamically exchanged with each other such that the cleansing fluid removes the at least one of the other plurality of third fluids from the third gap.

In some embodiments, the cleansing fluid is water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a combination thereof.

In some embodiments, the third fluid includes suspended particles.

In some embodiments, the suspended particles in the third fluid include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

In some embodiments, the suspended particles in the third fluid have size of 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm.

In some embodiments, the suspended particles in the third fluid have a concentration in the third fluid of between 0 mg/mL and 200 mg/mL, between 0 mg/mL and 100 mg/mL, between 0 mg/mL and 64 mg/mL, or between 0 mg/mL and 40 mg/mL, between 0 mg/mL and 4 mg/mL, or between 4 mg/mL and 64 mg/mL.

In some embodiments, the system is configured to dynamically increase or decrease the concentration of the suspended particles in the third fluid.

In some embodiments, the third fluid is water and the suspended particles comprise TiO₂ particles having a size of between 10 nm and 50 nm, and a concentration of between 0 mg/mL and 64 mg/mL in the third fluid.

In some embodiments, the suspended particles in the third fluid selectively scatter light.

In some embodiments, the selective scattering of light is defined by the proportion of light scattered forward or backward.

In some embodiments, the concentration and size of the suspended particles in the third fluid control the intensity and proportion of light that is scattered forward or backward.

In some embodiments, dynamically increasing or decreasing the concentration of the suspended particles in the third fluid dynamically decreases or increases the intensity of light that is scattered forward and dynamically increases or decreases the intensity of light that is scattered backward between the fourth layer and the first layer.

In some embodiments, the third fluid includes a pigment.

In some embodiments, the pigment in the third fluid includes carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or a combination thereof.

In some embodiments, the pigment in the third fluid includes carbon black.

In some embodiments, the pigment has a concentration in the third fluid of between 0 mg/mL and 200 mg/mL, 0 mg/mL and 100 mg/mL, 0 mg/mL and 10 mg/mL, 0 mg/mL and 2 mg/mL, 0 mg/mL and 0.5 mg/mL, 100 mg/mL and 200 mg/mL, 50 mg/mL and 100 mg/mL, 10 mg/mL and 50 mg/mL, 2 mg/mL and 10 mg/mL, or 0.5 mg/mL and 10 mg/mL.

In some embodiments, the pigment includes carbon black having a concentration in the third fluid of between 0 mg/mL and 0.5 mg/mL.

In some embodiments, the system is configured to dynamically increase or decrease the concentration of the pigment in the third fluid.

In some embodiments, the presence of the third fluid in the third gap is configured to at least one of selectively scatter, reflect, or absorb light, the light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

In some embodiments, the presence of the third fluid in the third gap is configured to at least one of selectively scatter, reflect, or absorb light, the light having a wavelength of between 300 nm and 700 nm, 300 nm and 2500 nm, or 700 nm and 2500 nm.

In some embodiments, the presence of the third fluid in the third gap is configured to absorb light, the light having a wavelength of between 700 nm and 30000 nm.

In some embodiments, the presence of the third fluid in the third gap is configured to absorb light, the light having a wavelength of between 300 nm and 2500 nm.

In some embodiments, the presence of the third fluid in the third gap is configured to absorb light, the light having a wavelength of between 300 nm and 700 nm.

In some embodiments, the presence of the third fluid in the third gap is configured to scatter light, the light having a wavelength of between 300 nm and 700 nm.

In some embodiments, the system of any one of claims 236-265, wherein the system comprises a fifth layer: the fifth layer comprising a fifth transparent solid material; the fifth layer disposed on the opposite side of the third layer from the second layer; a fourth gap defining a distance of between 5 mm and 50 mm between the second layer and the third layer configured to allow a fourth fluid to selectively flow into and out of the third gap, the presence of the fourth fluid in the third gap configured to at least one of selectively absorb light or control the convection and conduction of heat.

In some embodiments, the fourth fluid includes water, ethanol, isopropanol, glycerol, ethylene glycol, mineral oil, or silicone oil.

In some embodiments, the fourth fluid includes a pigment.

In some embodiments, the pigment is carbon black.

In some embodiments, the fourth fluid includes a pigment and is configured to absorb light and control the convection and conduction of heat such that the fourth fluid absorbs light and transfers the energy absorbed as light through the fourth fluid by one or more of convective or conductive heat exchange.

In some embodiments, the presence of the first fluid in the first gap and the fifth fluid in the fifth gap is configured to transfer heat energy through the system at a greater rate than either absence of the fifth fluid in the fifth gap and presence of the first fluid in the first gap or absence of the fifth fluid in the fifth gap and absence of the first fluid in the first gap due to convection and conduction of heat energy from the first fluid in the first gap through the fifth fluid in the fifth gap.

Certain embodiments of the present disclosure describe a system including a first layer including a first transparent solid material emissive to light having a wavelength between 2500 nm and 30000 nm; a second layer comprising a second transparent solid material; and a first gap defining a distance of between 5 mm and 50 mm between the first layer and the second layer and configured to allow a first fluid to selectively flow into and out of the first gap, the presence of the first fluid in the first gap configured to transfer heat energy through the first gap based on convection and conduction of heat in the first fluid.

In some embodiments, the first transparent solid material is transparent to light having a wavelength of between 300 nm and 2500 nm.

In some embodiments, the first transparent solid material is transparent to light having a wavelength of between 300 nm and 700 nm.

In some embodiments, the first transparent solid material is transparent to light having a wavelength of between 700 nm and 2500 nm.

In some embodiments, the first transparent solid material reflects light having a wavelength of between 300 nm and 2500 nm.

In some embodiments, the first transparent solid material reflects light having a wavelength of between 300 nm and 700 nm.

In some embodiments, the first transparent solid material reflects light having a wavelength of between 700 nm and 2500 nm.

In some embodiments, one or more of the first transparent solid material or the second transparent solid material includes transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

In some embodiments, the first transparent solid material includes fused silica.

In some embodiments, the second transparent solid material includes fused silica, glass, and combinations thereof.

In some embodiments, the first layer includes a structured surface configured to be emissive to light to light having a wavelength between 2500 nm and 3000 nm.

In some embodiments, the structured surface includes a roughened surface, a frosted surface, a patterned surface, a porous surface, an ordered surface, a grated surface, a lens-like surface, a photonic crystal surface, or any combination thereof.

In some embodiments, the structured surface includes repeated structures.

In some embodiments, the structured surface includes structures having feature sizes of about 3 μm to about 1000 μm, about 3 μm to about 50 μm, about 3 μm to about 15 μm, about 8 μm to about 50 μm, or about 8 μm to about 20 μm.

In some embodiments, the first layer includes a transparent coating, the transparent coating configured to reflect light in at least one wavelength band.

In some embodiments, the transparent coating includes a metal, a metal oxide, a metal-oxide/metal/metal-oxide sandwich, or a combination thereof.

In some embodiments, the transparent coating includes indium tin oxide.

In some embodiments, the transparent coating reflects light in the wavelength band between 2500 nm and 30000 nm.

In some embodiments, the transparent coating is configured to reduce transfer of heat through the first gap in absence of the first fluid.

In some embodiments, the first gap defines a distance of between 5 mm and 50 mm, between 5 mm and 20 mm, between 5 mm and 12 mm, between 5 mm and 8 mm, between 8 mm and 50 mm, between 8 mm and 20 mm, or between 20 mm and 50 mm between the second layer and the third layer.

In some embodiments, the first gap defines a distance of between 5 mm and 12 mm between the first layer and the second layer.

In some embodiments, the first fluid includes water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

In some embodiments, the second fluid includes water, silicone oil, mineral oil or any combination thereof.

In some embodiments, the system includes a plurality of reservoirs, each reservoir independently containing one or more fluids.

In some embodiments, each reservoir is independently connected to one or more of the gaps of the system; and each reservoir is configured to dynamically flow fluid into and out of any gap to which it is connected.

In some embodiments, the system is configured to be used in a window, shade, blind, light shelf, a sunroof, or a combination thereof.

In some embodiments, the system further includes a heat exchange layer configured to transfer heat within the system.

In some embodiments, the heat exchange layer includes a plurality of channels configured to selectively flow a heat transfer fluid into and out of the channels, wherein the presence of the heat transfer fluid is configured to transfer heat within the system in a direction within a plane of the heat exchange layer.

In some embodiments, the plurality of channels have dimensions of between 3 μm and 1 cm in width, and between 3 μm and 5 mm in depth.

In some embodiments, the heat exchange layer includes epoxy, glass, fused silica, polydimethylsiloxane, and combinations thereof.

Certain embodiments of the present disclosure describe a method of using a system described herein, including selectively flowing the first fluid into and out of the first gap to selectively control selectively control scattering of light between the first layer and the second layer by one or more of: the scattering surface of the second layer; a refractive index difference between the first fluid and the scattering surface of the second layer, or suspended particles in the first fluid configured to selectively scatter light.

In some embodiments, the system further includes a third layer comprising a third transparent layer, and a second gap configured to allow a second fluid into and out of the second gap, the presence of the second fluid configured to at least one of selectively scatter, reflect, or absorb light in the second gap; and the method further includes selectively flowing a second fluid into and out of a second gap to selectively scatter, reflect, or absorb light between either the third layer and the first layer or the third layer and the second layer.

In some embodiments, one or more of the first fluid or the second fluid includes a plurality of fluids, and the method further includes selectively and independently filling the respective first gap or second gap with the plurality of fluids.

In some embodiments, the method further includes flowing a cleansing fluid into one or more of the first gap or the second gap, the cleansing fluid being immiscible with at least one of the first fluid or the second fluid such that the cleansing fluid removes the at least one of the first fluid or the second fluid from the respective first gap or second gap.

In some embodiments, the first fluid further comprises a plurality of first fluids having different refractive indices, and the method includes selectively and independently exchanging fluids in the plurality of first fluids to decrease or increase the refractive index difference between the fluid in the first gap and the scattering surface.

In some embodiments, the first fluid includes a plurality of suspended particles, and the method further includes dynamically increasing or decreasing the concentration of suspended particles in the first fluid.

In some embodiments, the first fluid includes a pigment, and the method further includes dynamically increasing or decreasing the concentration of pigment in the first fluid.

In some embodiments, the second fluid includes a plurality of suspended particles, and the method further includes dynamically increasing or decreasing the concentration of suspended particles in the second fluid.

In some embodiments, the second fluid includes a pigment, and the method further includes dynamically increasing or decreasing the concentration of pigment in the second fluid.

In some embodiments, the system further includes a fourth layer including a fourth transparent solid material disposed on the opposite side of the third layer from the first layer, and a third gap between the third layer and the fourth layer; and the method further includes selectively flowing a third fluid into and out of the third gap to selectively reduce transmission of light between the third layer and the fourth layer when the third fluid is present in the third gap.

In some embodiments, the system further includes a fifth layer including a fifth transparent solid material disposed opposite the second layer from the first layer, and a fourth gap defining a distance of between 5 mm and 50 mm between the second layer and the fifth layer; and the method further includes selectively flowing a fourth fluid into and out of the fourth gap to selectively control the convection of heat within the fourth gap and conduction of heat through the fourth gap.

Certain embodiments of the present disclosure describe a method of using a system described herein, including selectively flowing the first fluid into and out of the first gap, to at least one of selectively scatter light, reflect light, or absorb light between the first layer and the second layer when the first fluid is present in the first gap; and selectively flowing the second fluid into and out of the second gap to transfer heat energy through the second gap based on convection and conduction of heat in the second fluid when the second fluid is present in the second gap.

In some embodiments, the first fluid includes a plurality of fluids, and the method further includes selectively and independently filling the first gap with the plurality of fluids.

In some embodiments, the method further includes flowing a cleansing fluid into the first gap, the cleansing fluid being immiscible with the first fluid such that the cleansing fluid removes the first fluid or the second fluid from the first gap.

In some embodiments, the first fluid includes a plurality of suspended particles, and the method further includes dynamically increasing or decreasing the concentration of suspended particles in the first fluid.

In some embodiments, the first fluid includes a pigment, and the method further includes dynamically increasing or decreasing the concentration of pigment in the first fluid.

In some embodiments, the method further includes flowing the first fluid into the first gap and flowing the second fluid into the second gap to increase the transfer of heat energy through the system due to convection and conduction of heat energy from the first fluid in the first gap through the second fluid in the second gap.

In some embodiments, the method further includes removing the first fluid from the first gap to reduce the transfer of heat energy through the system.

In some embodiments, the second layer further includes a scattering surface disposed on the same side of the second layer as the first gap configured to selectively control scattering of light between the first layer and the second layer by one or more of: presence of the first fluid in the first gap, a refractive index difference between the first fluid and the scattering surface, and suspended particles in the first fluid configured to selectively scatter light; wherein the first fluid comprises a plurality of first fluids having different refractive indices; and wherein the method includes selectively and independently exchanging fluids in the plurality of first fluids to decrease or increase the refractive index difference between the fluid in the first gap and the scattering surface.

In some embodiments, the system further includes a fourth layer including a fourth transparent solid material disposed on the opposite side of the first layer from the second layer, and a third gap between the first layer and the fourth layer; and the method further includes selectively flowing a third fluid into and out of the third gap to at least one of selectively scatter light, reflect light, or absorb light between the first layer and the fourth layer; or transfer heat energy based on one or more of convection and conduction of heat in the third fluid.

Certain embodiments of the present disclosure describe a method of using a system disclosed herein, including selectively flowing the first fluid into and out of the first gap to transfer heat energy to one or both of the first layer and the second layer based on convection and conduction of heat in the first fluid; selectively flowing the second fluid into and out of the second gap to transfer heat energy to one or both of the second layer or the third layer based on convection and conduction of heat in the second fluid; and selectively flowing the third fluid into and out of the third gap to transfer heat energy to one of or both the first layer or the fourth layer based on convection and conduction of heat in the third fluid.

In some embodiments, the method includes selectively transitioning between at least two of: a first state in which the first fluid is not present in the first gap, the second fluid is not present in the second gap, the third fluid is not present in the third gap, such that the absence of the first fluid, the second fluid, and the third fluid insulates from heat transfer through the system; a second state in which the first fluid is present in the first gap, the second fluid is not present in the second gap, and the third fluid is present in the third gap, such that heat energy in the first fluid is transferred to the third fluid through the first layer by convection and conduction of the first fluid and such that the absence of the second fluid in the second gap insulates heat transfer from the first fluid through the second gap; a third state in which the first fluid present in the first gap, the second fluid is not present in the second gap, and the third fluid is not present in the third gap, wherein the absence of the second fluid in the second gap and the third fluid in the third gap insulates heat transfer from the first fluid through second gap and the third gap, respectively, such that heat energy is stored in the first fluid; a fourth state in which the first fluid is present in the first gap, the second fluid is present in the second gap, and the third fluid is not present in the third gap such that heat energy from the first fluid is transferred to the second fluid through the second layer by convection and conduction of the first fluid, and heat energy in the second layer is transferred to the third layer by convection and conduction of the second fluid; and a fifth state in which the first fluid is present in the first gap, the second fluid is present in the second gap, and the third fluid is present in the third gap, such that heat energy in the third fluid is transferred to the first fluid through the first layer by convection and conduction of the third fluid and such that the heat energy in the first fluid is transferred to the second fluid through the second layer by convection and conduction of the first fluid.

Certain embodiments of the present disclosure describe a method of using a system described herein, including selectively flowing the first fluid into and out of the first gap, such the first fluid in the system absorbs heat energy from an environment outside the first layer when the first fluid is present, and absorption of heat energy from outside the first layer is reduced when the first fluid is absent; and selectively flowing the second fluid into and out of the second gap to one or more of selectively scatter, reflect, or absorb light between the second layer and the third layer, or transfer heat energy based on conduction of heat through the second fluid when the second fluid is present.

In some embodiments, one or more of the first fluid or the second fluid includes a plurality of fluids, and the method further includes selectively and independently filling the respective first gap or second gap.

In some embodiments, the method further includes flowing a cleansing fluid into one or more of the first gap or the second gap, the cleansing fluid being immiscible with at least one of the first fluid or the second fluid such that the cleansing fluid removes the at least one of the first fluid or the second fluid from the respective first gap or second gap.

In some embodiments, the second fluid includes a plurality of suspended particles, and the method further includes dynamically increasing or decreasing the concentration of suspended particles in the second fluid.

In some embodiments, the second fluid includes a pigment, and the method further includes dynamically increasing or decreasing the concentration of pigment in the second fluid.

In some embodiments, the method further includes flowing the first fluid into the first gap and removing the second fluid from the second gap to reduce transfer of heat energy from the first fluid through the second gap.

In some embodiments, the system further includes a fourth layer including a fourth transparent solid material disposed on the opposite side of the first layer from the second layer, and a third gap between the first layer and the fourth layer; and the method further includes selectively flowing a third fluid into and out of the third gap to selectively scatter light or absorb light between the first layer and the fourth layer when the third fluid is present in the third gap.

In some embodiments, the system further includes a fifth layer including a fifth transparent solid material disposed between the second layer and the third layer, and a fourth gap defining a distance of between 5 mm and 50 mm between the second layer and the third layer; and wherein the method further comprises selectively flowing a fourth fluid into and out of the third gap to control the convection and conduction of heat.

Certain embodiments of the present disclosure describe a method of using a system described herein including selectively flowing the first fluid into and out of the first gap to transfer heat energy through the first gap based on convection and conduction of heat in the second fluid when the second fluid is present in the second gap.

In some embodiments, the method further includes removing the first fluid from the first gap to reduce the transfer of heat energy through the system.

In some embodiments, the system further comprises a heat exchange layer configured to transfer heat within the system and comprising a plurality of channels; and the method further includes selectively flowing a heat transfer fluid into and out of the channels to transfer heat within the system in a direction within a plane of the heat exchange layer when the heat transfer fluid is present in the channels.

Any one of the embodiments disclosed herein may be properly combined with any other embodiment disclosed herein. The combination of any one of the embodiments disclosed herein with any other embodiments disclosed herein is expressly contemplated.

### BRIEF DESCRIPTION OF THE DRAWINGS

The objects and advantages will be apparent upon consideration of the following detailed description, taken in conjunction with the accompanying drawings, in which like reference characters refer to like parts throughout, and in which:

FIGS. 1A-1D show exemplary illustrations of different types of lighting control related to a system for universal lighting control, according to some embodiments. FIG. 1A shows a plot illustrating one-dimensional lighting control. FIG. 1B shows a plot illustrating two-dimensional lighting control, according to some embodiments. FIG. 1C shows a plot illustrating three-dimensional, universal lighting control, according to some embodiments. FIG. 1D shows an exemplary schematic of a universal system for lighting control at the surface of a building, according to some embodiments.

FIGS. 2A-2B show schematics of an exemplary system used to control one or more of the direction, color, or intensity of light, or the absorption or emission of thermal radiation, according to some embodiments.

FIGS. 3A-3C show exemplary plots and illustrations of how light can be selectively scattered using a fluid, according to some embodiments. FIG. 3A is an exemplary plot showing the intensity of light distributed at different angles changes as a function of the concentration of suspended particles in a fluid according to some embodiments. FIG. 3B shows an illustration of increasing concentration of suspended particles in a fluid within an exemplary system, according to some embodiments. FIG. 3C shows an exemplary illustration of how light (arrows) is scattered off of suspended particles according to some embodiments.

FIGS. 4A-4B show exemplary images and illustrations demonstrating how changing the concentration of suspended particles in a fluid can change the direction of light, according to some embodiments.

FIGS. 5A-5C show exemplary plots and illustrations demonstrating how light can be selectively scattered forward by changing the refractive index mismatch between a scattering surface and a fluid that wets the scattering surface, according to some embodiments.

FIGS. 6A-6B show exemplary images and plots demonstrating how changing the refractive index mismatch between a scattering surface and a fluid selectively changes the distribution of light that is scattered forward by the scattering surface, according to some embodiments.

FIGS. 7A-7C show exemplary plots and illustrations of how the intensity of light transmitted through a system can be controlled using a fluid which includes a pigment, according to some embodiments.

FIGS. 8A-8B show an exemplary plot and images demonstrating how changing the concentration of a pigment in a fluid changes the intensity of light transmitted through a system according to some embodiments.

FIGS. 9A-9B show an exemplary plot and images demonstrating how changing the concentration of a pigment in a fluid can change the color of light transmitted through a system, according to some embodiments.

FIGS. 10A-10C show exemplary plots and illustrations of how fluids within a system can selectively absorb near-IR, according to some embodiments.

FIGS. 11A-11C show exemplary plots and images demonstrating the simultaneous and independent control of scattering and absorption of light within the system, according to some embodiments.

FIG. 12 shows exemplary plots of the angle of transmitted light vs. the wavelength of transmitted light which demonstrate the scattering control (forward scattering) with control of the transmitted color of light, according to some embodiments.

FIG. 13 shows exemplary plots of the angle of transmitted light vs. the wavelength of transmitted light which demonstrate the combination of scattering control with control of the absorbance of near-IR light, according to some embodiments.

FIG. 14 shows exemplary plots and images demonstrating the combination of spectral selectivity (absorption) of light using different pigments and angular selectivity (control of forward scattering), according to some embodiments.

FIGS. 15A-15B show exemplary illustrations demonstrating the independent tuning of two distinct hierarchical scales of scattering that collectively enable complementary directional and blurring behaviors, according to some embodiments.

FIGS. 16A-16F show exemplary plots and illustrations of control of the direction of scattering using the refractive index difference at the interface of a fluid and a scattering surface and control of the concentration of suspended particles in the fluid, according to some embodiments.

FIG. 17 shows plots and images of an exemplary system where the selective scattering of light and the color of light are independently controlled, according to some embodiments.

FIG. 18 shows how the transmission of light through a system can be controlled in three-dimensions (intensity, distribution, spectrum), according to some embodiments.

FIG. 19 shows how the transmission of light through a system can be controlled in three-dimensions (intensity, direction, spectrum), according to some embodiments.

FIG. 20 shows how the transmission of light through a system can be controlled in three-dimensions (total darkening, distribution, and near-IR selective darkening), according to some embodiments.

FIGS. 21A-21B show exemplary plots illustrating the capability of dependent and independent systems to occupy different states in a phase space, according to some embodiments.

FIGS. 22A-22C show an exemplary schematic of an embodiment of a FLUIDS platform related to the system shown in FIG. 2, according to some embodiments.

FIGS. 23A-23C show an exemplary schematic of an embodiment of a FLUIDS platform related to the system shown in FIG. 2, according to some embodiments.

FIG. 24 shows an exemplary schematic of a FLUIDS-H system, according to some embodiments.

FIG. 25 shows an exemplary schematic of a FLUIDS-H system and non-limiting exemplary states the system can exist in to configure heat transfer and light transmission, according to some embodiments, according to some embodiments.

FIG. 26 shows an exemplary schematic of an embodiment of the FLUIDS-H system related to the system shown in FIG. 24, according to some embodiments.

FIGS. 27A-27B shows an exemplary schematic of a thermal battery related to the system shown in FIG. 26, according to some embodiments.

FIG. 28 shows an exemplary schematic of a FLARES system, according to some embodiments.

FIG. 29 shows non-limiting exemplary states in which a FLARES system can exist, according to some embodiments.

FIG. 30A-30B show the phase space of accessible configurations for control of optical and thermal properties in 2-state binary systems compared to the 6-state FLARES system shown in FIGS. 28-29, according to some embodiments.

FIG. 31 shows an exemplary schematic of the FLARES system, according to some embodiments.

FIGS. 32A-32B show exemplary illustrations of the phase space of accessible configurations for control of optical and thermal properties in 2-state binary systems as compared to the 8-state FLARES system shown in FIG. 31, according to some embodiments.

FIG. 33 shows an exemplary schematic of the FLARES system according to some embodiments.

FIG. 34 shows an exemplary illustration of the phase space of accessible configurations for control of optical and thermal properties in the 8-state FLARES system shown in FIG. 32, according to some embodiments.

FIG. 35 shows an exemplary schematic of a FLUIDH system according to some embodiments.

FIGS. 36A-36C show images of the experimental setup and plots collected from an exemplary system for control of color, intensity, and blurring of light, according to some embodiments.

FIGS. 37A-37B show plots collected from an experimental setup for independent control of light intensity, according to some embodiments.

FIGS. 38A-38F show plots and images collected from two experimental systems for independent control of the distribution of forward scattered light, according to some embodiments.

FIGS. 39A-39D show a schematic, plots, and images of an experimental system for simultaneous and independent control of light intensity and dispersion of forward scattered light, according to some embodiments.

FIG. 40 shows plots collected from an experimental system for simultaneous and independent control of the color, direction, and intensity (absorption) of light, according to some embodiments.

FIG. 41 shows a schematic and spectra of an experimental system for simultaneous and independent control of thermal radiation and control of absorption and direction of light, according to some embodiments.

FIGS. 42A-42J show a microfabrication procedure of a first layer, i.e., a thermal radiator of an exemplary FLUIDH system according to some embodiments.

FIGS. 43A-43I show a microfabrication procedure for a second layer that includes a heat exchanger for an exemplary FLUIDH system according to some embodiments.

FIG. 44 shows the fully assembled system 4400 of FIGS. 42A-42J and 43A-43I according to some embodiments.

FIGS. 45A-E show an exemplary schematic of the system of FIG. 35 and illustrations of distinct environmental and operational conditions corresponding to distinct operational modes of the system.

### DETAILED DESCRIPTION

Indoor climate control is one of the largest global energy end-uses; roughly one-quarter of global energy and one-half of global electricity is spent to heat, cool, and illuminate interior spaces to maintain comfortable conditions at all times.

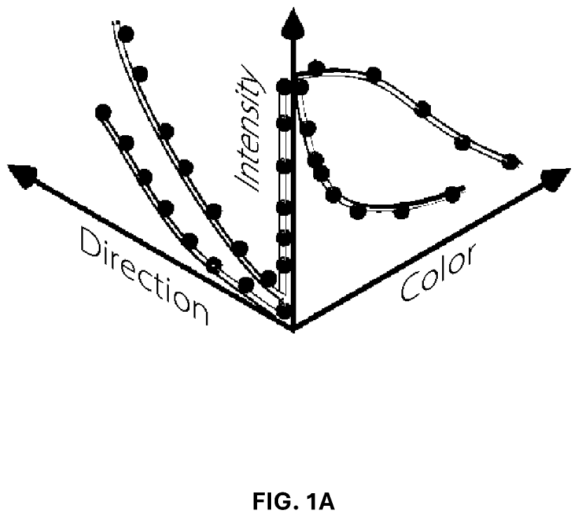

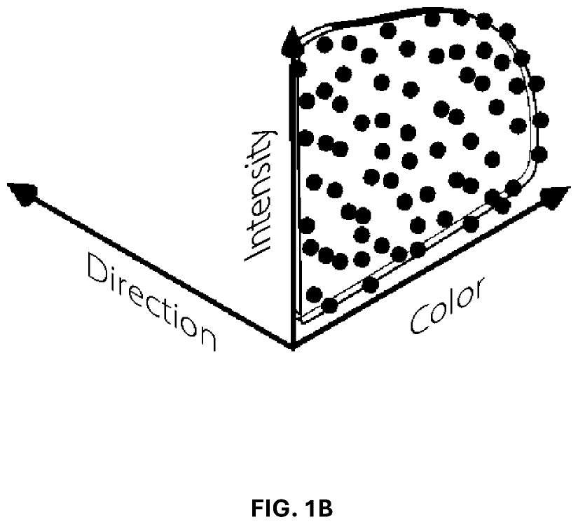

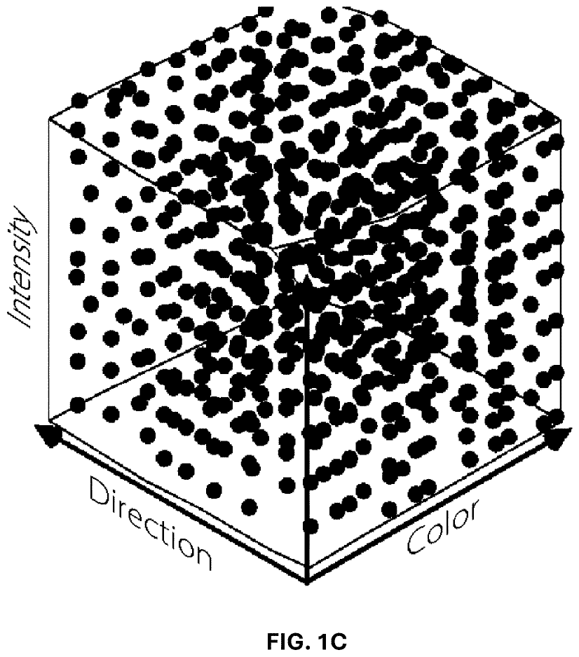

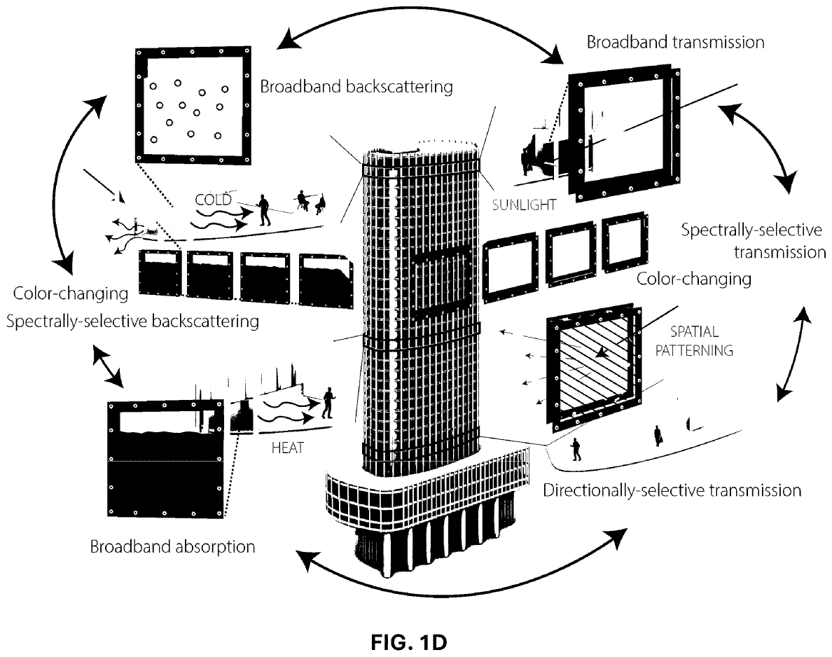

Universal solar configurability—the ability for a system to orthogonally control the intensity, distribution, and spectrum of solar radiation—can significantly reduce this enormous footprint. A universally adaptive window can directly manipulate the distribution of daylight and temperature spatiotemporally, achieving indoor climate control first-hand toward augmenting the performance of or replacing the indoor heating, cooling, and lighting systems that drive energy consumption and carbon emissions around the world. An illustration of this concept can be seen in FIGS. 1A-1D. One-dimensional systems, as shown in FIG. 1A allow control of one or more properties in a dependent manner along straight lines. Two-dimensional systems, as shown in FIG. 1B, allow control of two properties (e.g., intensity and color) within an area but do not allow universal control. Universal control is illustrated in FIG. 1C where, in a three-dimensional phase space, intensity, direction, and color can be controlled independently to reach a state at any point within the phase space. No existing technology has been able to control the intensity, direction, and color of sunlight orthogonally, and the development of a universal solar management platform represents an unmet prerequisite toward net-energy-neutral and sustainable buildings. Climate is instead largely regulated internally with energetically-costly heaters, coolers, and light. Buildings that can perform a homeostasis of sorts directly at their skin (e.g., building surfaces) as illustrated in FIG. 1D, in a manner analogous to biological processes for environmental regulation, would regulate indoor climate more efficiently. Thus, a large amount of global energy consumption related to indoor climate control would be eliminated.

In some embodiments, the present disclosure describes systems that can dynamically and independently control the amount (or intensity), the spectrum (or wavelength), and the angle (or dispersion) of a beam of transmitted light or thermal radiation, for example solar radiation. In some embodiments, light includes one or more wavelength bands, for example, visible light (300 nm to 700 nm), near-infrared light (700 nm to 2500 nm), and mid-infrared light (2500-30000 nm). In some embodiments, the present disclosure describes systems capable of universally controlling light and thermal radiation. In some embodiments, the present disclosure describes systems capable of universally controlling light.

In addition to control of light, the modulation of thermal radiation, convection and conduction can represent the other important but largely separate control knobs for energy management in buildings. While efficient control of light (e.g., sunlight) or thermal radiation can enable substantial energetic reductions individually, incompatibilities in the mechanisms and materials necessary to exert such control have prohibited integrated control of solar and thermal radiation together.

In some embodiments, the present disclosure describes systems capable of universally controlling one or more of absorption of light and thermal radiation and conduction and convection of heat. This functionality—enabling the ability to simultaneously manipulate two or more of the intensity, direction, and color of light (e.g., sunlight) and/or thermal radiation in combination with the conduction and convection of heat—is enabled by using fluids (e.g., liquids and gases). Fluids have unique advantages over solid material alternatives in achieving universal solar control. Solid materials cannot generally be dynamically controlled to fit any function at any time based on environmental conditions. In contrast, because fluids can be designed to take on multiple chemistries or wet various geometries, a system in which layers of fluids and fluid-coated solids reflect, redirect, and spectrally-filter light (e.g., a fluidic window) can accomplish a truly universal library of functional configurations and functionalities.

In some embodiments, a fluidic architecture, as a single platform, can simultaneously modulate two or more of light, thermal radiation, thermal convection, and thermal conduction toward unlocking simultaneous access to the entire suite of energy control knobs in buildings.

In some embodiments, the present disclosure discloses an infinitely reconfigurable material platform which exploits a set of simple but powerful properties in clean and replenishable fluids. Advantages of fluids include that (1) fluids can flow and be manipulated, (2) fluids can be compositionally tuned, and (3) fluids can wet.

Fluids flow, which means they can be manipulated quite easily. In some embodiments, fluids can be compositionally tuned to take on different optical states. For example, fluid compositions can be stacked within a multilayer system such that between the layers there are gaps which include one or more fluids with different and specific functions. In some embodiments, a fluid can be designed that controls the color, shade, and/or darkening of light. For example, a fluid can include a pigment that absorbs light of a certain wavelength band such that the darkening of light in that wavelength band can be controlled by the concentration of pigment in the fluid. In some embodiments, a fluid can be designed to control the direction of scattering of light. For example, a fluid can comprise suspended particles which result in different distributions of scattering when light passes through the solution depending on the concentration of the particles.

In some embodiments, fluids can be compositionally tuned to have different thermal functions. In some embodiments, a fluid can have at least one of the following functions: absorbing thermal radiation, being emissive for thermal radiation, controlling heat exchange by conduction, and controlling heat exchange by conduction and convection. In a non-limiting example, to actively control radiative cooling or heating, a fluid, by reversibly replacing a gas-filled (e.g., air-filled) gap between layers, can effectively open and close a thermal bridge to control radiative heat exchange or insulation. In a non-limiting example, a fluid, by reversibly replacing a gas-filled (e.g., air-filled) layer, can effectively activate a buoyancy-driven flow cycle to dynamically control convective heat exchange or stagnation. In some embodiments, a fluid that controls at least one of thermal radiation and heat exchange can include at least one of a pigment and suspended particles such that the fluid also controls at least one of the color, shade, darkening, and direction of scattering of light. In some embodiments, the thermal tunability of fluids coupled with the capacity for fluids to universally manipulate light, point toward a low-cost, scalable, and sustainable fluidic infrastructure for low-energy climate control in buildings.

An additional property of fluids other than their ability to flow and be compositionally tuned is that fluids can wet. In some embodiments, a fluid can behave not only as a medium to control light but also as a switch to turn on and off a photonic effect of a structured surface that itself controls light. In a non-limiting example, by reversibly wetting a structured surface, a fluid can effectively switch on and off a selective photonic response of the structured surface. For example, a fluid with a specific refractive index can control the scattering of light off of a structured surface that has a different refractive index by reversibly wetting or de-wetting the structured surface. In some embodiments, dynamically changing the refractive index of the fluid can change the magnitude of the refractive index difference between the fluid and the structured surface, thereby increasing or decreasing the distribution of the light.

In some embodiments, by putting together solution-based optical effects like tunable absorption, with solution interface-based optical effects like surface light scattering, combinatorial optical functions can be accessed. For example, a fluid can be designed to control scattering of light by reversibly wetting a structured surface that has a different refractive index than the fluid, while the fluid also includes pigments that absorb light to control the shade or color of light. The largely independent control knobs, e.g., independently moving along the dispersion (scattering) axis while independently moving along the absorption axis, allow any combination of light shading function with light scattering function to be achieved. Systems without independent control knobs move along 1-dimensional lines in this phase space where only one function is controlled at a time. In contrast and as a non-limiting example, the hybrid pigment-structure based approach allows independent modification of absorption and scattering, i.e., functional change in two-dimensions.

In some embodiments, combining different fluid functions gives access to a new dimension of optical control. As a non-limiting example, a spectral element can be added by tuning color through controlling the pigment-based absorption spectra of a fluid. In this example, scattering of light can also be independently tuned, for example, by controlling the refractive index of a second, or the same, fluid in a different layer, or the same layer.

In some embodiments, a system can independently control angular selectivity and wavelength selectivity. For example, on the basis of dynamic control over fluid compositions, the system can be changed from a state where there is specular transmission (e.g., little or no scattering) across all wavelengths of light, to a state where there is diffuse transmission (e.g., scattering) across all wavelengths of light, to a state where there is diffuse transmission in only certain wavelength bands of light (e.g., near-infrared, visible, mid-infrared, and others). Thus, there can be independent control over angular selectivity and wavelength selectivity. In some embodiments, by changing fluid composition along one axis, refractive index and/or dispersion of scattered light can be increased, while along another axis, the selective absorption and/or color can be adjusted by adjusting the identity and/or concentration of pigments in a fluid within the system. The resulting ability to filter and then spatially direct the color of transmitted light may have implications for controlling occupant circadian rhythm indoors. In some embodiments, a further independent axis of control can result in control of spectrum, distribution, and intensity. Thus, in some embodiments, within one system, independent axes of control can change the color of transmitted light, scatter that color, and then dim that color.

In a non-limiting example, a system can independently control angular selectivity and spectral selectivity for visible and near infrared light, giving access to designable temperature distributions indoors. For example, by dynamically changing the composition of one or more fluids within the system, the intensity of near infrared light transmission, the angle of that light transmission, and the intensity of total visible and near infrared light transmission can be changed in any order or manner. Compared to systems that control near infrared selective transmission and scattering dependently and move one-dimensionally in phase space, the described fluidic system can independently tune near infrared selective transmission on the y axis and the distribution of that transmission along the x axis. This gives ultimate freedom that other window technology cannot achieve, including combined spectrally and directionally selective tunability, allowing movement within an area in phase space.

In some embodiments, a system can be designed to control light in the fluid bulk and at the fluid interface. In a non-limiting example, a system can be designed, including at least a first layer and a second layer, where there is a gap between the layers to allow a fluid to be flowed in and out. In this example, the second layer has a scattering surface made up of a structured (e.g., microstructured) solid layer (e.g., frosted PDMS) on the side of the layer that is within the gap such that the scattering surface can be wet by the fluid to tune the scattering of light at the interface between the fluid and the second layer; and the fluid includes suspended particles, for example P25 titanium dioxide, suspended in the fluid bulk such that changing the concentration of the suspended particles changes the scattering of light within the fluid. With these two scales of scattering, in this example, one in the fluid, and one at the interface of the fluid and the scattering surface, there are different and complementary control levers for tuning the scattering of light through the system. First, for light scattering off of the suspended particles in solution, a control lever can be the particle concentration. For example, the number of particles in solution can control the number of interfaces at which light can be redirected. For example, as the concentration of particles increases, the fraction of light that is scattered backward increases while decreasing the fraction of light that is scattered forward. Second, for scattering off of the scattering surface, e.g., the microstructured PDMS features at the interface of the fluid and the scattering surface, a control lever can be the difference in the respective refractive indices of the scattering surface and the fluid. For example, as the refractive index difference is increased or decreased, the fraction of light that is scattered forward or backward is not significantly changed, but rather the blurriness of the light that is transmitted forward is changed, e.g., becoming sharper or more diffuse. By incorporating both control levers, the number of interfaces and the refractive index difference, in the same system, the properties of proportion of light scattered forward or backward and the blurriness of the forward scattered light can be independently controlled to match any desired function. Thus, the distribution (i.e., blurring) of scattered light in the forward direction and the dominant direction of scattering can be controlled by the concentration of particles (c) and the interfacial index mismatch (Δn). For example, distribution of scattered light can be achieved all in the forward direction using a small interfacial index mismatch and low particle concentration. For example, distribution of scattered light can be achieved in the forward and backward direction using a medium interfacial index mismatch and medium particle concentration. For example, distribution of scattered light can be achieved dominantly in the backward direction using any interfacial index mismatch and a high particle concentration.

In some embodiments, it is possible to transition from a transmission to absorption state by increasing pigment concentration in a fluid and/or from a transmission to scattering state by increasing concentration of suspended particles in the same fluid or another fluid within the same system. Such a system can transition between any combination of absorption and scattering states by independently changing the concentration of pigment and/or the concentration of suspended particles. For example, the system can be changed from a state where solar light is transmitted, to a state where solar light is absorbed as heat, to one where solar light is reflected entirely. In some embodiments, not only can the degree to which such a system blocks light be controlled, but the mechanism by which, or HOW, the system blocks light can be controlled. For example, the system can be dynamically changed such that the system is converting solar light to heat, via absorption, to be slowly released as thermal energy inside over time. For example, the system can be dynamically changed to reject the available solar light immediately, via scattering.

In some embodiments, the system disclosed herein can universally adapt the surface of a building to match environmental conditions for efficient energy use. For example, an exemplary fluidic system disclosed herein can involve a plurality of layers with a plurality of gaps between the layers such that different fluids can be flowed into and out of each gap. In this example, each fluid can independently control a different function based on the respective fluid composition. In some embodiments, disposing the fluid layers separately in the system allows for independent control of multiple properties based on presence or absence of each fluid, and/or combination of fluid within the system. For example, the system can independently do one or more of the following: (1) selectively transmit light, (2) selectively absorb light, (3) selectively scatter light, (4) selectively change the color of that scattered light, (5) selectively change the direction of the scattered light from backward to forward, (6) selectively blur that forward transmitted light to send it around the room in a programmable manner, (7) selectively change the color of the light that is sent around the room, not only in the visible but also in the near-infrared regions, to direct temperature fluxes spatially, or (8) unblur that light to return back to a near-100% transmission state. In some embodiments, these functions can be performed using a single fluidic interface to achieve a library of solar responses.

In some embodiments, the system disclosed herein provides the capacity, for example, to freely blur and darken light. In some embodiments, the system disclosed herein provides the capacity, for example, to freely change the color and direction of light, for independent spectral and directional control, in any proportion. In some embodiments the system disclosed herein provides the capacity, for example, to control how, and to what degree, light is extinguished in any proportion. In some embodiments, the system disclosed herein provides general light control: the ability to tune intensity, spectrum, and direction all independently, and all the potential energetic benefits that this newfound optical functionality may offer. In some embodiments, the system disclosed herein can allow effective programming of climate directionally and spectrally, right at the building surface.

Preliminary experiments validate that this multilayered fluid system enables independent tailoring of each of the energy control knobs, e.g., control over solar light (or radiation) absorbance and direction, thermal radiation, conductive heat exchange, and convective heat exchange. In some embodiments, fluid composition and sequence can control the absorption and directional dissipation of thermal radiation; the pathway and strength of convection and conduction; and the intensity, spectrum, and spatial distribution of transmitted solar radiation.

Compared to solid mechanisms, fluids are optically and thermally configurable and easily move, infiltrate, and wet. This complete performance uniquely positions a multilayered fluid window as a platform for universal indoor climate management. Such a system-leveraging a palette of clean and replenishable materials comprising mostly water and air-unlocks simultaneous access to the entire suite of energy control knobs in buildings, thereby providing a feasible pathway to carbon neutrality and climate sustainability.

### 1. Fluids: Flowable Universal Interface for Directing Sunlight

Certain embodiments of the present disclosure describe a system including a first layer including a first transparent solid material; a second layer including a second transparent solid material, the second transparent solid material including a scattering surface; and a first gap between the first layer and the scattering surface of the second layer configured to allow a first fluid to selectively flow into and out of the first gap. In some embodiments, the presence of the first fluid in the first gap is configured to at least one of selectively absorb light between the first layer and the second layer or selectively control scattering of light between the first layer and the second layer by one or more of: the scattering surface of the second layer; a refractive index difference between the first fluid and the scattering surface of the second layer; or suspended particles in the first fluid configured to selectively scatter light; wherein the system is configured to independently control two or more of intensity of light transmitted, distribution of forward scattering, direction of scattering, and wavelength of light transmitted.

In one embodiment, a system is disclosed which is the Flowable Universal Interface for Directing Sunlight (FLUIDS). However, the FLUIDS systems disclosed herein are not limited to sunlight and can be applied to directing any type of light.

In some embodiments, a system is disclosed that can orthogonally manipulate the intensity, spectrum, direction and/or distribution of a beam of light (e.g., sunlight). The disclosed system is capable of universally controlling light (e.g., sunlight), e.g., simultaneously and independently controlling the intensity, direction, distribution and/or color of solar radiation. This breakthrough is accomplished by implementing an untapped class of materials, fluids, that have unique advantages over solid alternatives toward achieving universal solar control. Fluids can be designed to carry many chemistries and wet many geometries. Thus, a fluidic system, in which layers of liquid flow in and atop structured solids to spectrally-filter and angularly-redirect light, can accomplish a universal library of never-before achieved functional configurations. FIGS. 1A-1D provide exemplary plots and schematics illustrating the disclosed system as the first technology that can orthogonally manipulate the intensity, spectrum, and/or distribution of light (e.g., sunlight), as discussed above. FIG. 1A shows examples of accessible states of lighting control that can be achieved in one-dimensional systems. In one-dimensional systems, one or more variables can be dependently changed such that the accessible states exist along a line within the phase space defined by the variables (e.g., intensity and direction). FIG. 1B shows examples of accessible states of lighting control that can be achieved in two-dimensional systems. In two-dimensional systems, two variables can be independently changed such that the accessible states exist within a two-dimensional area or plane defined by the variables (e.g. intensity and color). FIG. 1C shows examples of accessible states of lighting control that can be achieved in a universal, three-dimensional system. In a three-dimensional system, for example the disclosed system, three variables can be independently changed such that any state can be achieved within the three-dimensional phase-space defined by the variables (e.g., color, direction, and intensity). FIG. 1D shows an exemplary schematic illustrating exemplary configurations of the disclosed system as a fluidic window system for controlling light at the surface of a building. By incorporating different fluids in the system different types of control can be exerted on light and thermal radiation transmitted through the system. For example, the system can be configured to absorb broadband light and convert that absorbed light energy into heat to be exchanged with the indoor environment (FIG. 1D, bottom left).

For example, the system can be configured to backscatter or reflect broadband light and provide a cooling effect for the indoor environment through lack of absorption of light and heat energy (FIG. 1D, top left). For example, the spectrum of light absorbed can be selected to transmit a certain color to the indoor environment, while the spectrum of light that is backscattered is selectively controlled, for example, to 1) transmit colored visible light through the system and 2) reflect infrared light resulting in shading and cooling, respectively, of the indoor environment (FIG. 1D, middle left). For example, the system can be configured to transmit broadband light to light the indoor environment (FIG. 1D, top right). For example, the system can be configured to selectively control the direction of light to blur light transmitted through the system (FIG. 1D, bottom right). For example, the system can be configured to control the color and the direction of the light such that the system transmits colored or shaded light with narrow (clear) or diffuse scattering (blurred) through the system (FIG. 1D, middle right).

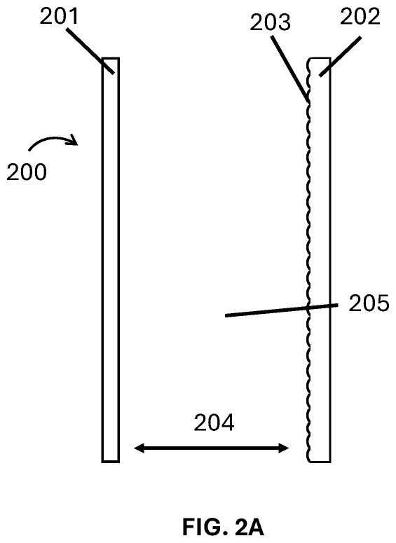

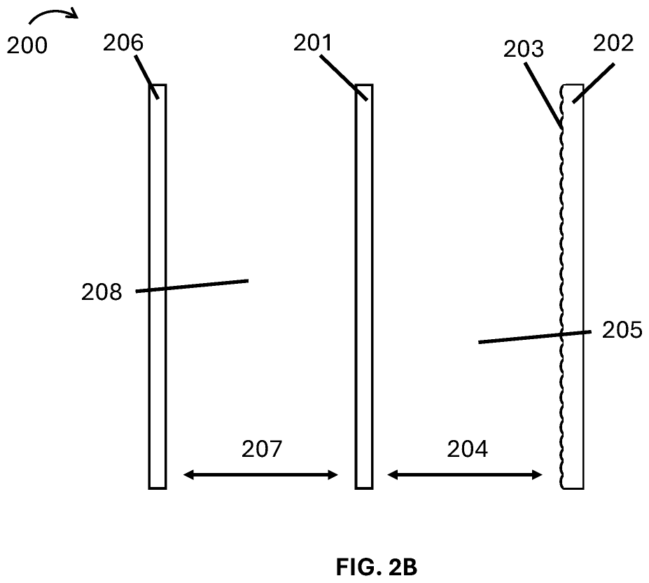

FIGS. 2A-2B show exemplary systems that can orthogonally manipulate the intensity, spectrum, direction and/or distribution of a beam of light (e.g., sunlight). In one embodiment, an exemplary system 200 is disclosed, shown in FIG. 2A, including a first layer 201 including a first transparent solid material; a second layer 202 including a second transparent solid material that includes a scattering surface 203; and a first gap 204 between the first layer 201 and the scattering surface 203 of the second layer 202 configured to allow a first fluid 205 to selectively flow into and out of the first gap 204. In this example, the presence of the first fluid 205 in the first gap 204 is configured to at least one of selectively absorb light between the first layer 201 and the second layer 202 or selectively control scattering of light between the first layer 201 and the second layer 202 by one or more of: the scattering surface 203 of the second layer 202; a refractive index difference between the first fluid 205 and the scattering surface 203 of the second layer 202, or suspended particles in the first fluid 205 configured to selectively scatter light. In some embodiments, the first fluid is selected and/or flowed into and out of the first gap to independently control direction of scattered light (e.g., forward or backward); the distribution/blurriness of transmitted light (e.g., how directly or diffusely light is distributed within a space); the broadband absorption of light; and the spectral selectivity of transmitted light (e.g., how much infrared light is transmitted vs. how much visible light is transmitted).

In some embodiments, shown in FIG. 2B, the system 200 described above includes a third layer 206 disposed on the opposite side of the first layer 201 from the second layer 202 and a second gap 207 between the third layer 206 and the first layer 201 configured to allow a second fluid 208 to selectively flow into and out of the second gap 207. In this example, the presence of the second fluid 208 in the second gap 207 is configured to at least one of selectively scatter, reflect, and absorb light between the third layer 206 and the first layer 201. In some embodiments, one or more of the first layer, the second layer, or the third layer can include a scattering surface. In some embodiments, the first fluids and second fluids are selected and/or flowed into and out of the respective gaps to independently control direction of scattered light (e.g., forward or backward); the distribution/blurriness of transmitted light (e.g., how directly or diffusely light is distributed within a space); the broadband absorption of light; and the spectral selectivity of transmitted light (e.g., how much infrared light is transmitted vs. how much visible light is transmitted). Although FIG. 2B shows a system where the third layer and the second gap on an opposite side of the first layer from the first gap, in some embodiments, the third layer and the second gap can instead be configured to be on the opposite side of the second layer from the first gap. In some embodiments, the layers described above and the resulting gaps between layers can be arranged in any configuration to meet a desired function. In some embodiments, more than one layer can include a scattering surface. In some embodiments, more than one gap can include a scattering surface. In some embodiments any two adjacent layers can each include a scattering surface, each layer configured so that the scattering surfaces face each other across the gap defined by the layers. In some embodiments, the system includes a gap that does not include a scattering surface disposed between two gaps that each include a scattering surface. In some embodiments, the system shown in FIG. 2B can include additional layers and gaps.

Within a system for controlling light, for example, the system of FIGS. 2A-2B, there can be different “fluidic control knobs”, i.e., types of control that can be exerted, to change the passage of light through the system based on strategically flowing distinct fluids in and out of the gaps between the layers of a multilayered device. For example, fluids can be pumped into a device that selectively controls the direction of scattered light (e.g., forward or backward); the distribution/blurriness of transmitted light (e.g., how directly or diffusely light is distributed within a space); the broadband absorption of light; and the spectral selectivity of transmitted light (e.g., how much infrared light is transmitted vs. how much visible light is transmitted).

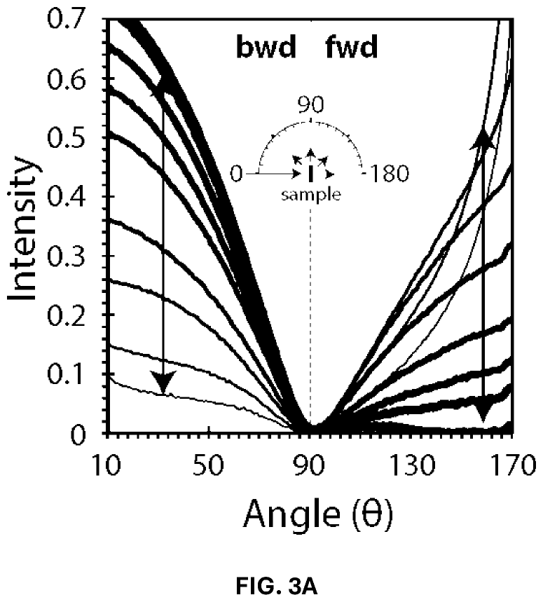

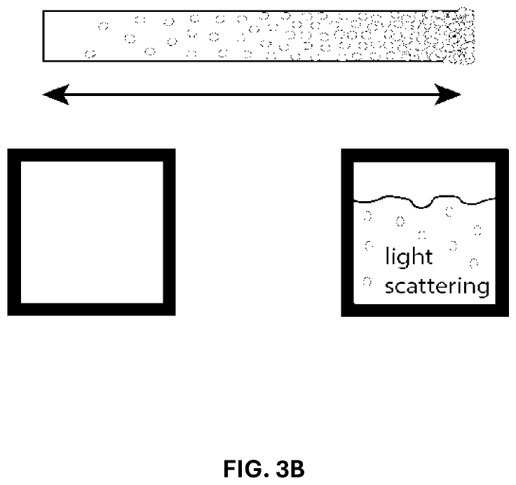

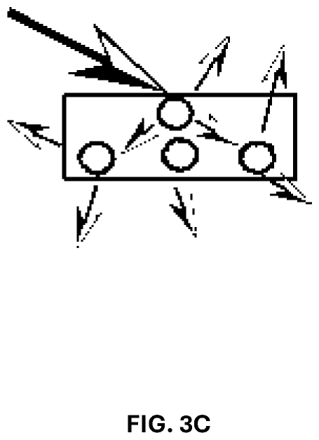

FIGS. 3A-3C show exemplary plots and illustrations of how light can be selectively scattered using a fluid. FIG. 3A shows how the intensity of light distributed at different angles changes as a function of the concentration of suspended particles of P25 titanium dioxide in water in a 1 mm thick fluid. In FIG. 3A, the increasing thickness of the lines represents increasing concentration of particles from 0 mg/mL to 64 mg/mL (0 mg/mL, 0.25 mg/mL, 0.5 mg/mL, 1 mg/mL, 2 mg/mL, 4 mg/mL, 8 mg/mL, 16 mg/mL, 32 mg/mL, 64 mg/mL, 64 mg/mL at double thickness (2 mm), 64 mg/mL at triple thickness (3 mm). The intensity data in FIG. 3A is factored by 100 for better visualization to show the relative distribution between forward-and backward-scattered light. As shown in FIG. 3A, as the concentration of suspended particles increases, the intensity of forward-scattered light decreases, i.e., light with an angle of >90 θ, while the intensity of light that is back-scattered increases, i.e., light with an angle of <90 θ. FIG. 3B shows an illustration of increasing concentration of suspended particles in a fluid within an exemplary system according to the present disclosure. The left box in FIG. 3B represents the system when there are no particles in the fluid and light is transmitted through the system with no back scattering (left end of top box). The right box in FIG. 3B represents the system when there is a large concentration of particles in the fluid and light is only back-scattered by the system (right end of top box). FIG. 3C shows an exemplary illustration of how light (arrows) is scattered off of suspended particles. As shown in FIG. 3C, incident light (large arrow) can be scattered in multiple directions off of a suspended particle. The light scattered off of the suspended particle can be reflected away from the system, reflected off of other suspended particles within the fluid, or reflected through the system. In this way, each suspended particle can be viewed as a scatterer in the fluid bulk such that, as the concentration of suspended particles is increased, there is a greater number of scatterers present, resulting in less light being transmitted forward, uninhibited, through the system. In some embodiments, the particles include different materials which are described below in the “Fluid Compositions and System Materials” section.

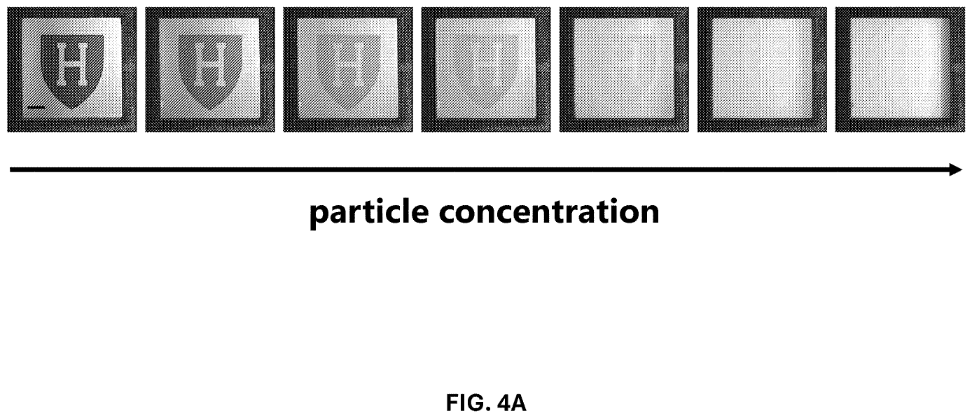

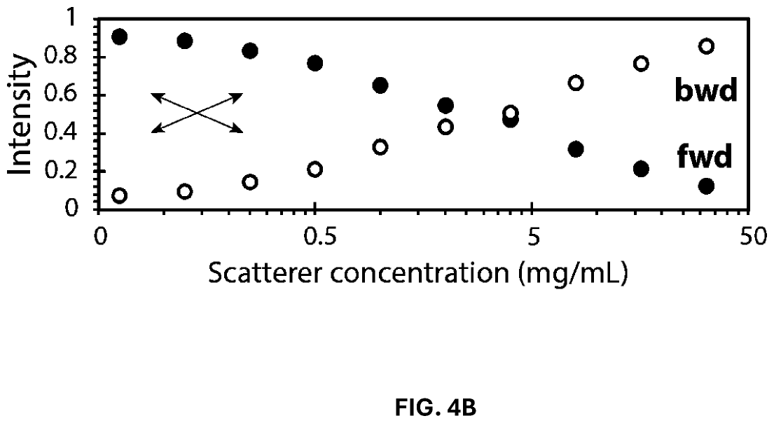

FIGS. 4A-4B show exemplary images and a plot demonstrating how changing the concentration of suspended particles in a fluid can change the distribution of light scattered at different angles through the fluid within an exemplary system according to some embodiments of the present disclosure. FIG. 4A shows images of the system over a shield symbol as particle concentration is increased (from left to right), illustrating how an increasing amount of light is reflected (back-scattered) as the concentration of suspended particles is increased, resulting in increased opacity going from left to right. FIG. 4B shows a plot of intensity of light scattered in the forward (fwd, black circles) and backward (bwd, white circles) directions depending on the concentration of suspended particles (scatterer) in a fluid, according to some embodiments. As shown in FIG. 4B, as the concentration of scatterers in the fluid increases, the intensity of light scattered forward (fwd, black circles) decreases while the intensity of light scattered backward (bwd, white circles) increases. This illustrates that one knob controlling how light is scattered is the number of interfaces, i.e., the concentration of particles, within the fluid. For example, as concentration increases, light will increasingly interact with particles and scatter in directions other than the forward direction as the concentration of suspended particles increases.

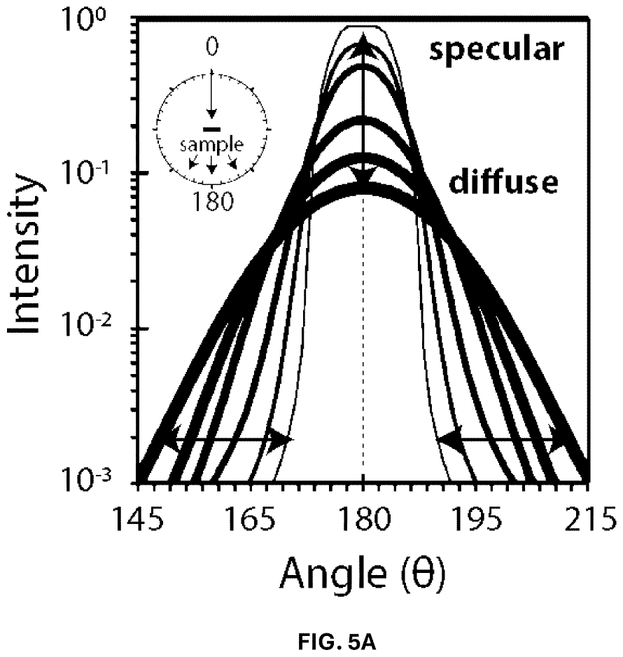

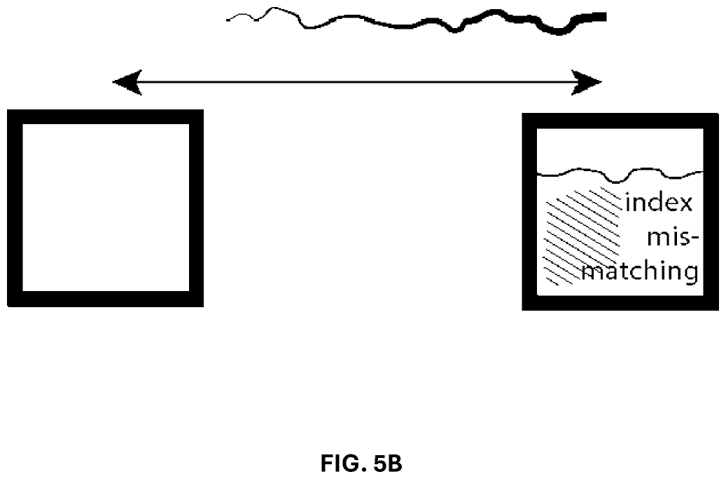

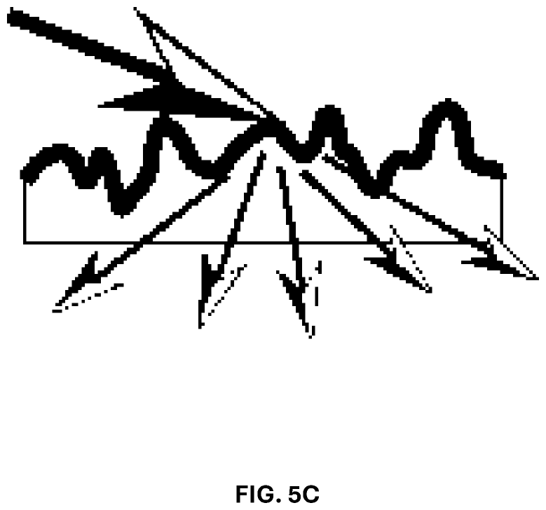

FIGS. 5A-5C show exemplary plots and illustrations of how light can be selectively scattered forward diffusely or directly by changing the refractive index mismatch between a scattering surface and a fluid that wets the scattering surface according to some embodiments of the present disclosure. FIG. 5A is a plot showing how the intensity of light distributed forward changes as a function of the refractive index mismatch between a scattering surface and a fluid that wets the scattering surface. In FIG. 5A, the increasing thickness of the lines represents an increasing refractive index mismatch (for a trilayer structure with a RMS of 2.34 μm and mean roughness of 1.83 μm with sequences going from thinnest to thickest of IPA (isopropyl alcohol)-IPA-IPA, IPA-IPA-oil, oil-oil-oil, IPA-oil-air, IPA-air-air, air-air-air). This shows that as the refractive index difference increases, there is a broader distribution of angles for forward scattered light, which will result in diffuse/blurred light transmission. FIG. 5B shows an illustration of the change in blurriness of the system that results from selectively changing the distribution of light that is scattered forward by a scattering surface as a result of increasing the index mismatch between the surface and a fluid that wets the surface. The left box in FIG. 5B represents the system when there is a low refractive index difference and light is transmitted forward through the system. The right box in FIG. 5B represents the system when there is a large refractive index difference and light is diffusely transmitted (blurred) through the system. FIG. 5C provides an illustration of how incident light (large arrow) is scattered in different forward directions (small arrows) by a scattering surface.

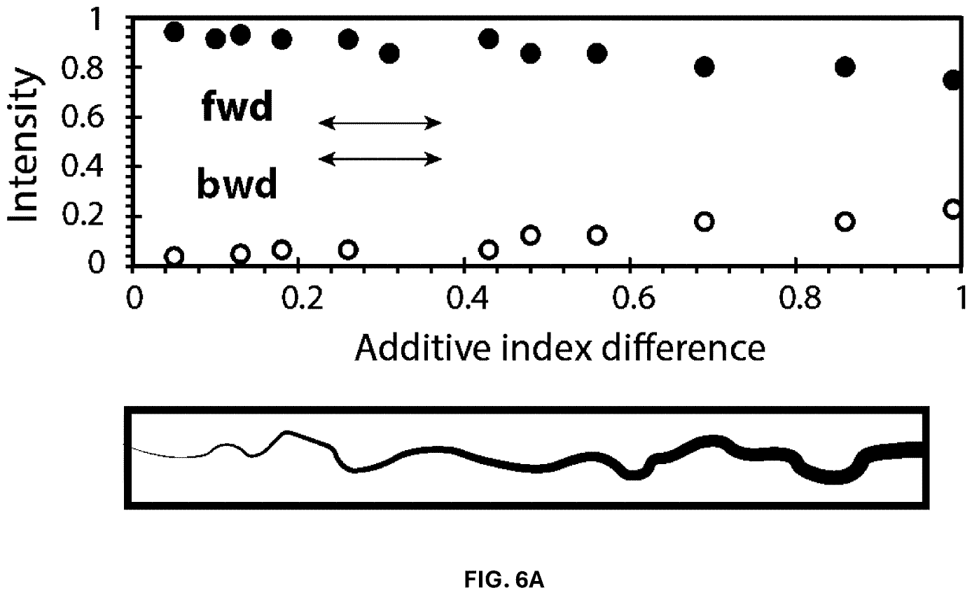

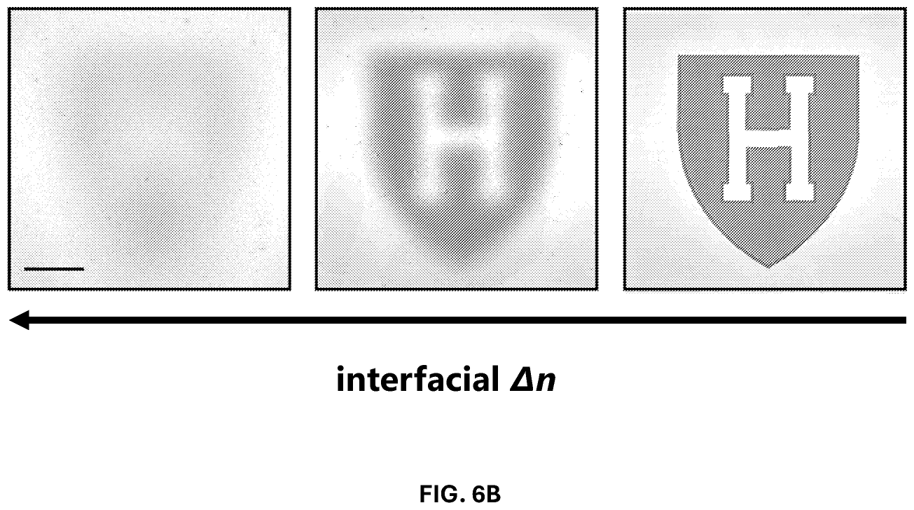

FIGS. 6A-6B show exemplary images and plots representing how changing the refractive index mismatch between a scattering surface and a fluid that wets the scattering surface selectively changes the distribution of light that is scattered forward by the scattering solid. FIG. 6A shows a plot and illustration of the intensity of light scattered in the forward (large, dark-filled circles) and backward (small, white-filled circles) directions related to the refractive index between the scattering surface and the fluid that wets it. As shown in FIG. 6A, increasing the refractive index mismatch between the scattering surface and the fluid results in a decreased intensity of forward scattered light and a greater intensity of backward scattered light, i.e., more diffuse/blurry light scattered in a broader range of angles. The increasing refractive index mismatch is shown by the illustration in FIG. 6A (bottom) where, moving from left to right, the increasing refractive index difference results in a less sharp contrast between the refractive properties of the fluid and the scattering surface and increased blurriness. FIG. 6B shows exemplary images which illustrate the relationship between the distribution or blurriness of light scattered forward through the system and the decreasing refractive index mismatch (An) (from left to right) between the scattering surface and the fluid. Moving from left to right in the panels of FIG. 6B, it can be seen that at a higher An (first panel) the light scattered through the system by the scattering surface is blurred, while decreasing the Δn (second panel) yields less blurred light scattering, and finally sharp light scattering is achieved with in the third panel representing the lowest Δn value.

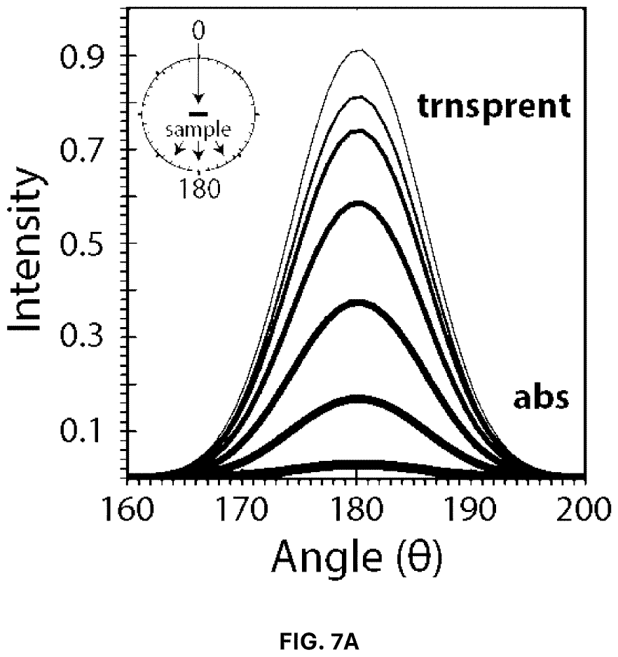

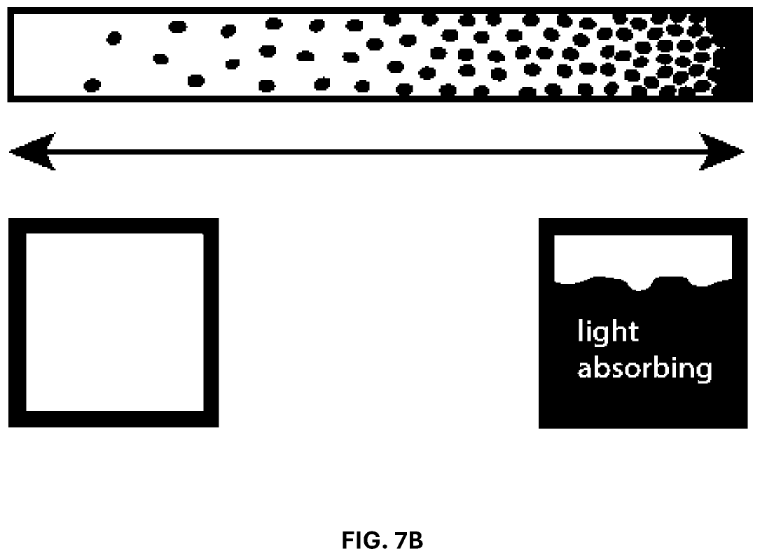

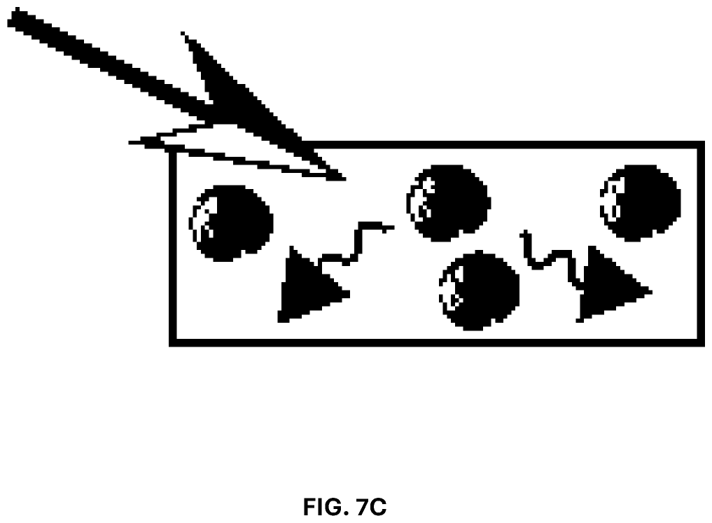

FIGS. 7A-7C show exemplary plots and illustrations of how the intensity of light transmitted through a system can be controlled using a fluid which includes a pigment according to some embodiments of the present disclosure. In some embodiments, the pigment can be a dye or particle that has high broadband (e.g., all wavelengths of solar light) absorbance, or visible-selective absorbance. FIG. 7A is a plot which illustrates how the intensity of light transmitted through a system changes based on the increasing concentration of a carbon black pigment in water from 0 mg/mL to 0.25 mg/mL for a 1-mm thick fluid within the system. In FIG. 7A the thickness of the lines in the plot increase with the increasing concentration of carbon black in water (0, 0.015625, 0.03125, 0.0625, 0.125, 0.25 mg/mL). FIG. 7B shows an exemplary illustration of the darkening of the light transmitted through the system that results from the increasing number of absorbers (i.e., the increasing pigment concentration) that controls the absorbance/transmission of light within a fluid. FIG. 7C shows an exemplary illustration of how incident light (large arrow) is selectively absorbed by a pigment (black-filled circles) resulting in transmission of wavelengths of light that are not selectively absorbed by the pigment (small squiggly arrows). FIG. 7C demonstrates how light transmitted through the system can be darkened, shaded, or colored due to selective absorption of all wavelengths of light (darkening and shading), or some wavelengths of light (color selection and shading).

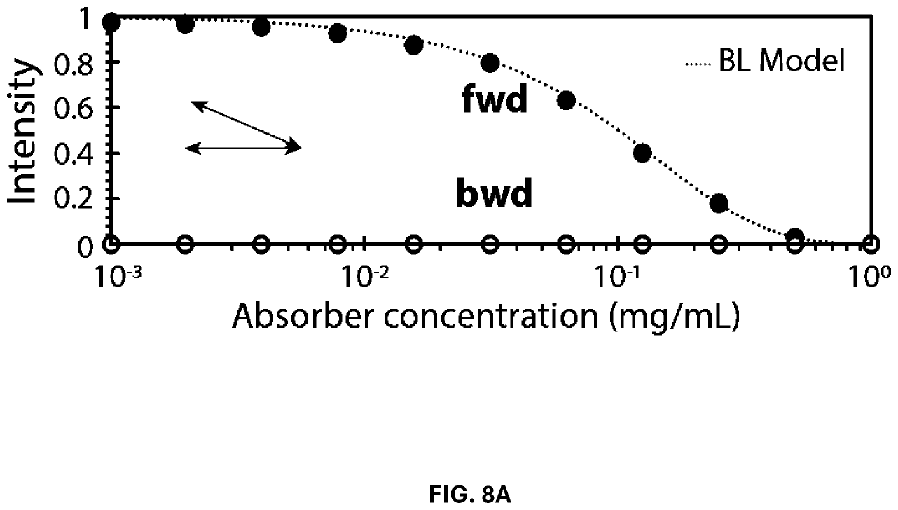

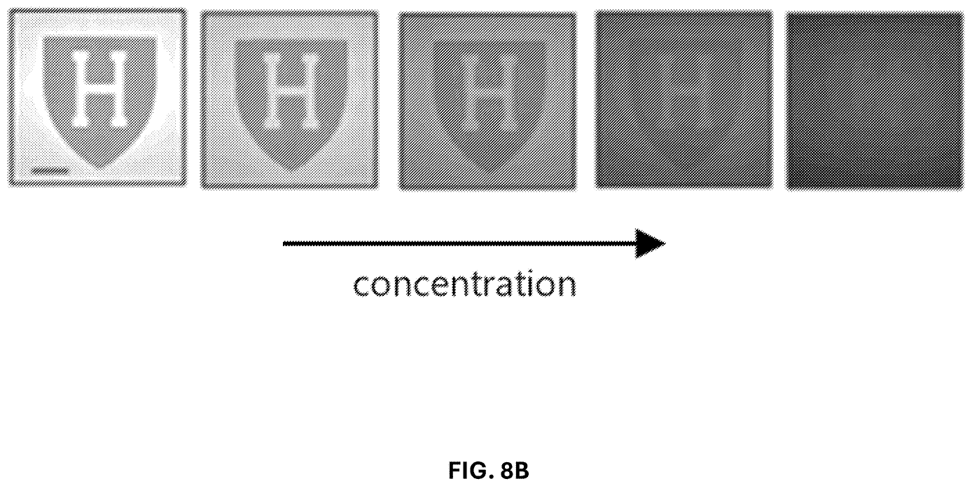

FIGS. 8A-8B show an exemplary plot and images representing how changing the concentration of a pigment in a fluid changes the intensity of light transmitted through a system that includes the fluid according to some embodiments of the present disclosure. FIG. 8A provides an exemplary plot illustrating the decrease in intensity of forward transmitted light (fwd, black-filled circles) as a function of increasing pigment (Absorber) concentration. In the non-limiting example illustrated by FIG. 8A, there is no backward light transmission (bwd, white-filled circles) because the pigment either absorbs the incident light or allows it to be transmitted forward through the system if the light is a wavelength band of light that is not absorbed by the pigment. FIG. 8B shows images taken looking through an exemplary system that includes a fluid with a suspended carbon black pigment. As shown in FIG. 8B, as the concentration of pigment increases (left to right) in the fluid, the light transmitted through the system is increasingly absorbed by the pigment, resulting in darkened light transmission through the system.

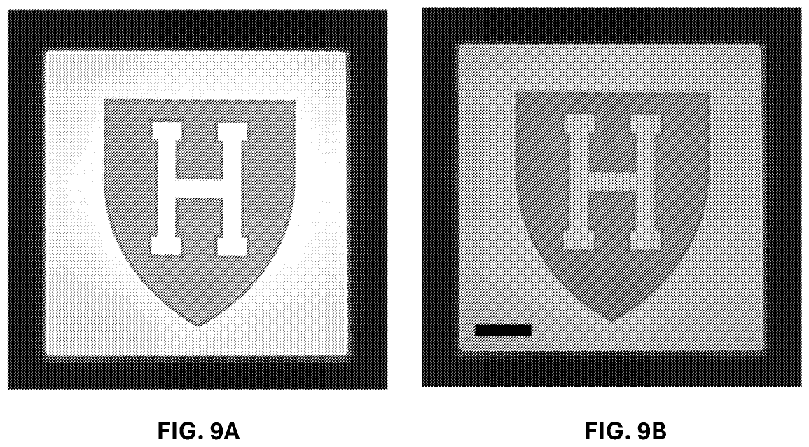

In some embodiments, as described above, by using a fluid which includes pigments that selectively absorb specific wavelength bands of light, the color of light transmitted through a system can be controlled according to some embodiments of the present disclosure. FIGS. 9A-9B show images of an exemplary system where a pigment is not included, resulting in visible light of all wavelengths being transmitted through the system (FIG. 9A), and where a pigment is included in a fluid, resulting in blue light being transmitted through the system (FIG. 9B). Other exemplary pigments which can be used to control the color of light transmitted through a system according to some embodiments are described below in the “Fluid Compositions and System Materials” section.

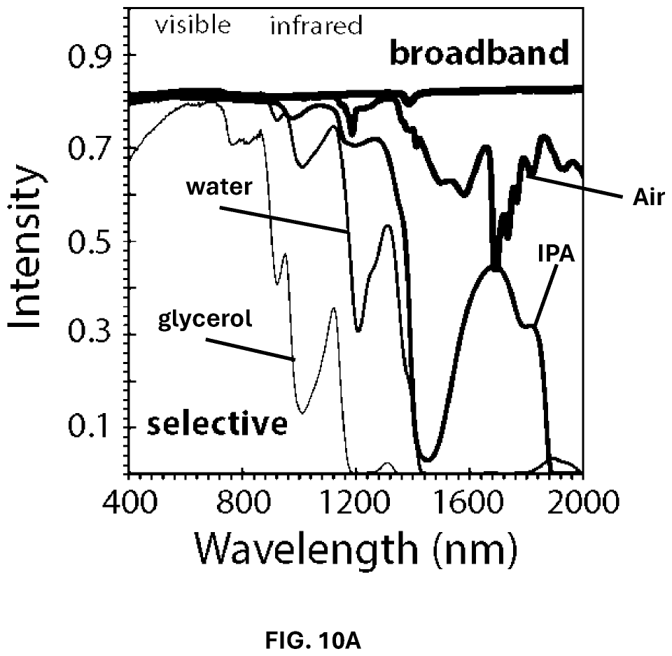

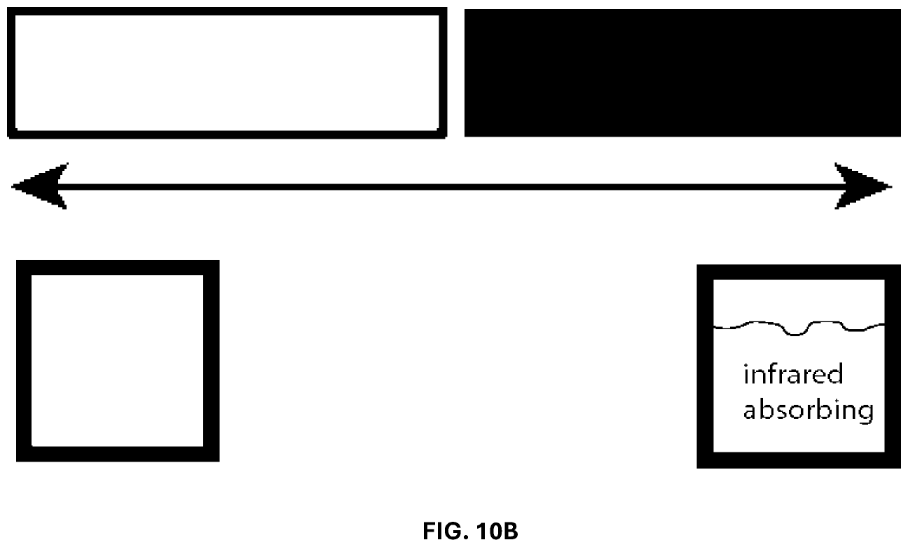

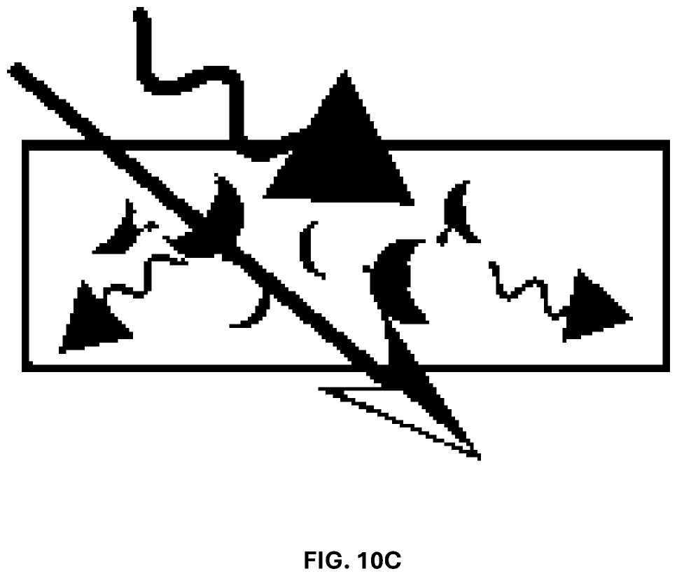

In some embodiments of the present disclosure, fluids can also be incorporated into a system which selectively absorb at different wavelengths. For example, fluids can also be incorporated into a system which are transparent to visible light but selectively absorb near-infrared light (near-IR or NIR, 700 nm to 2500 nm). FIGS. 10A-10C show exemplary plots and illustrations of how fluids within a system can selectively absorb near-IR according to some embodiments. FIG. 10A shows plots of the transmission of light through exemplary fluids in a system according to some embodiments. The plots represented in FIG. 10A shows transmission of light through a system that includes a 1-mm layer of air, isopropyl alcohol (IPA), or water (second line from the left), or a 5 mm layer of glycerol (left line). As shown in FIG. 10A, each represented fluid transmits visible light, but each has varying degrees of absorbance in the near-IR wavelength band. In some embodiments, by using one or more of these or other fluids within a multilayer system, the absorbance of specific near-IR wavelength bands can be selectively controlled. FIG. 10B shows an exemplary illustration of two different states of near-IR absorbance in a system where the white-unfilled box on the left represents a system with a visible and near-IR transparent fluid and the “infrared absorbing” box on the right represents a system with a visibly transparent and near-IR absorbing fluid. FIG. 10C shows an exemplary illustration representing the transmission of visible light (large, straight arrow) and the selective absorbance of near-IR light (large, squiggly arrow) through a system that includes a near-IR absorbing fluid. The smaller squiggly arrows in FIG. 10C represent wavelengths within the near-IR band which are not fully absorbed by the fluid, dependent on the selective absorbance characteristics of the fluid.

As described above and illustrated in FIGS. 2A-2B, according to certain embodiments, a system can be designed which includes different layers and fluids, allowing for combination of different types of control over light that is incident to the system. In some embodiments, through exchange of fluids, the combinations can be dynamically changed as surrounding environmental conditions change. In some embodiments, the system can be configured to present the combination of functions within the system that are best suited to promote efficient energy usage to control indoor climate relative to the surrounding environmental conditions.

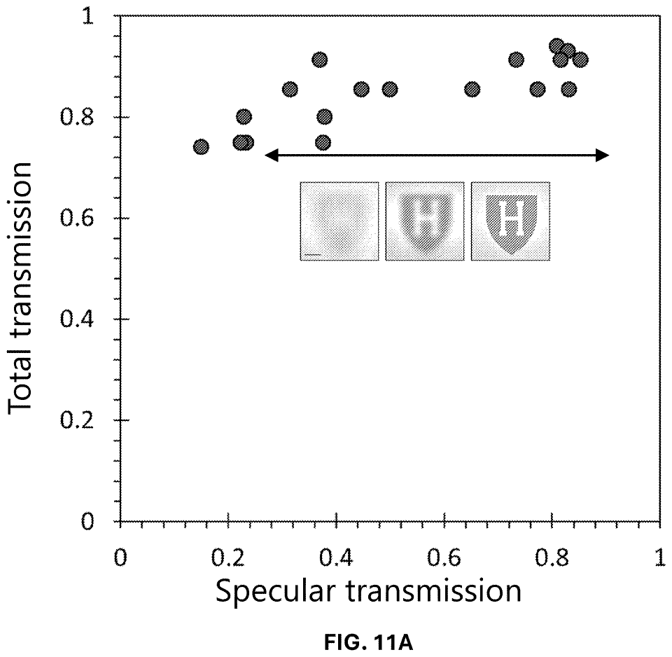

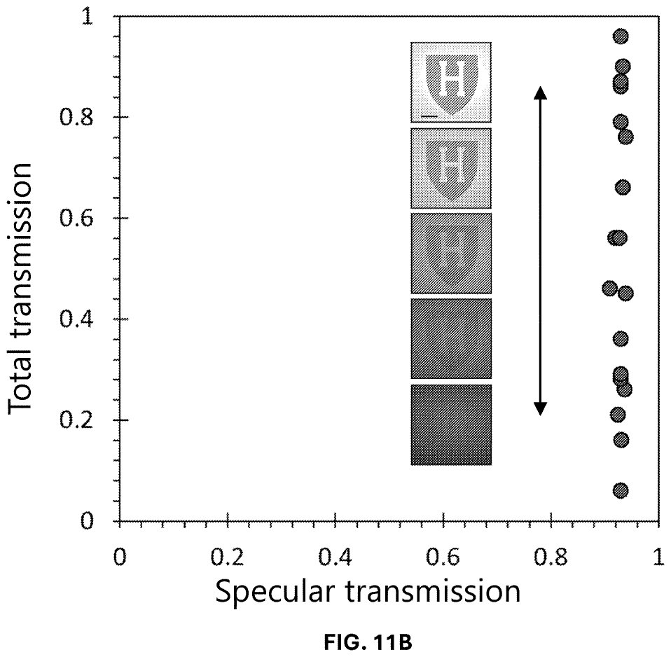

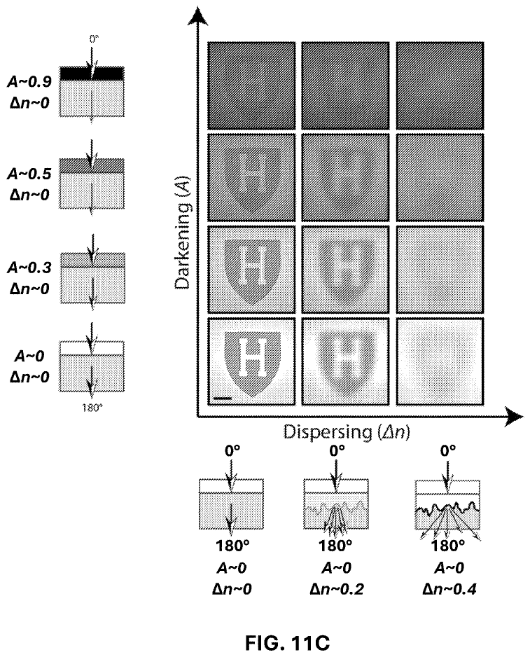

In some embodiments of the system shown in FIGS. 2A-2B, the second fluid includes a pigment (e.g., carbon black) such that presence of the second fluid 208 in the first gap 207 is configured to selectively absorb broadband solar radiation (e.g., 700 nm to 2500 nm) between and the presence of the first fluid 205 in the second gap 204 is configured to selectively scatter light forward by a refractive index difference between the second fluid and the scattering surface of the second layer 202. FIGS. 11A-C show exemplary plots and images demonstrating the simultaneous and independent control of dispersion (scattering) and absorption of light within the system. FIG. 11A shows a plot of total transmission vs. specular transmission illustrating the independent control of scattering within the system by varying the refractive index difference between the first fluid 205 and the scattering surface of the second layer 202. In FIG. 11A, total transmission shows small changes, however specular transmission varies significantly illustrating control over the forward scattering of light. The increase in specular transmission shown in FIG. 11A corresponds to an decreasing refractive index difference. This is further demonstrated by the images inset in FIG. 11A which are images taken looking through the system showing that light transmission becomes less blurred (greater proportion of forward light scattering) as the refractive index difference decreases. FIG. 11B shows a plot of total transmission vs. specular transmission illustrating the independent control of absorption within the system by changing the concentration of the carbon black in the first fluid. In FIG. 11B, total transmission changes significantly while specular transmission does not change, which illustrates independent control over only the absorption of light. This is further demonstrated by the images inset in FIG. 11B which are images taken looking through the system showing that light transmission is not blurred (no change in specular transmission) but becomes darkened (decreasing total transmission) as the concentration of carbon black increases. FIG. 11C shows an illustrative plot of distribution of forward scattering (controlled by Δn) vs. darkening (controlled by absorption, A) with images and illustrations showing the independent control of both distribution of forward scattering and absorption within the same system. As shown in FIG. 11C, both absorption and distribution of forward scattering can be independently changed allowing access to any state within the two-dimensional space, illustrated by the plot, based on different absorption values (A=~0.9, 0.5, 0.3, 0 from top to bottom) combined with changing refractive index difference values (Δn=~0, 0.2, 0.4 from left to right).

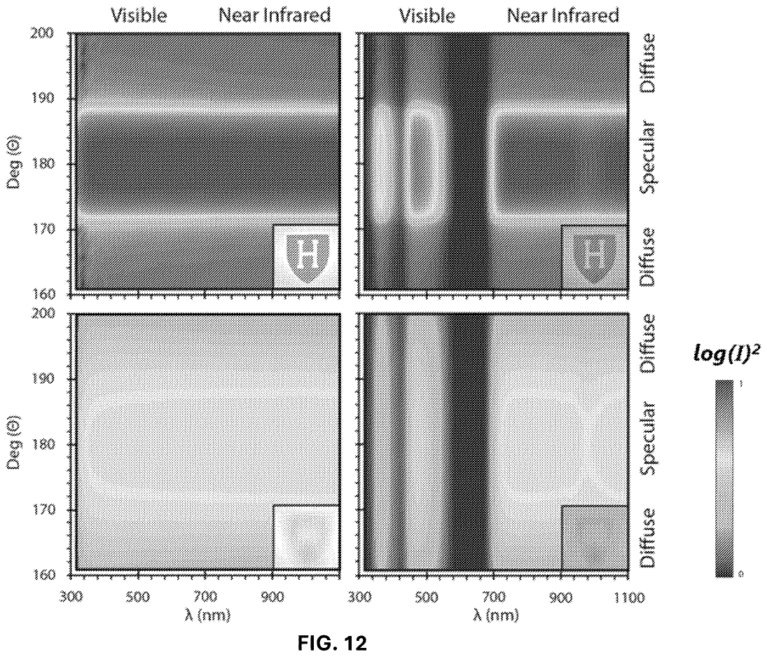

In a non-limiting example, according to some embodiments of the system shown in FIGS. 2A-2B, the first fluid includes a spectrally selective pigment, Blue 1 food coloring, such that presence of the second fluid 208 in the second gap 207 is configured to selectively absorb solar radiation in some wavelengths and transmit light in other wavelengths, and the presence of the first fluid 205 in the first gap 204 is configured to selectively scatter light forward between the first layer 201 and the second layer 201 by a refractive index difference between the second fluid 205 and the scattering surface of the third layer 201. For example, a spectrally selective pigment (e.g., the Blue 1 pigment) can selectively absorb solar radiation (700 nm to 2500 nm) and transmit blue light. FIG. 12 shows exemplary plots of the angle of transmitted light vs. the wavelength of transmitted light which illustrate the combination of dispersion control (forward scattering) with control of the transmitted color of light. The bottom left panel shows the system when the second fluid 207 does not include the Blue 1 pigment and the first fluid 207 has a high refractive index difference which can be seen by the equal distribution of light at all angles and wavelengths shown. The bottom right panel shows the system when the second fluid 208 includes the Blue 1 pigment, resulting in the transmission of blue light through the system, and the first fluid 204 has a high refractive index difference. This results in absorbance at specific wavelengths of light, indicated by the dark bands while transmitted light (lighter bands) has an equal distribution at all angles shown. The top left panel shows the system when the second fluid 208 does not include the Blue 1 pigment and the first fluid 204 has a low refractive index difference. This results in equal absorbance at all wavelengths shown and a narrow distribution of angles (~170-190 θ) at which light is scattered. The top right panel shows the system when the second fluid 208 includes the Blue 1 pigment, resulting in the transmission of blue light through the system, and the first fluid 204 has alow refractive index difference. This results in absorbance at specific wavelengths of light indicated by dark vertical bands, while the transmitted light (horizontal bands) has a narrowed distribution of angles (~170-190 θ). The inset in each plot is an image of light transmitted through the system showing how the system transmits blurred light (bottom left), blurred blue light (bottom right), clear light (top left), or clear blue light (top right) depending on the combination of fluids in the system.

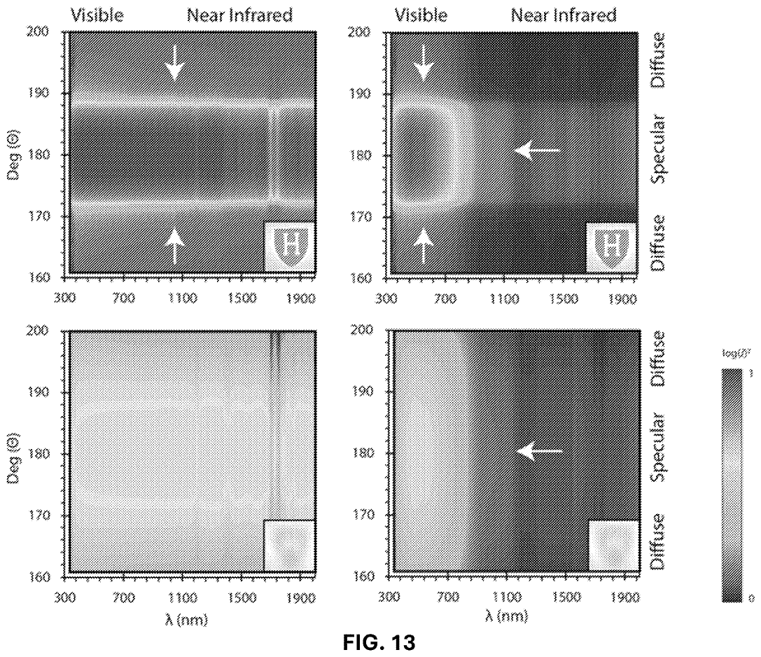

In a non-limiting example, according to some embodiments of the system shown in FIGS. 2A-2B, presence of the second fluid 208 in the second gap 207 is configured to selectively absorb light between the third layer 206 and the first layer 201; and presence of the first fluid 205 in the first gap 204 is configured to selectively scatter light forward between the first layer 201 and the second layer 202 by a refractive index difference between the first fluid 205 and the scattering surface 203 of the second layer 202. For example, the second fluid can selectively absorb light at near-IR and mid-IR wavelengths and transmit light at visible wavelengths. FIG. 13 shows exemplary plots of the angle of transmitted light vs. the wavelength of transmitted light which illustrate the combination of control of distribution of the forward scattering of light with control of the absorbance of near-IR light. The bottom left panel shows the system when the second fluid 208 does not absorb light in the visible or near-IR wavelength bands, and the first fluid 205 has a high refractive index difference. This results in equal absorbance at all visible and near-IR wavelengths and angles of light shown. The bottom right panel shows the system when the second fluid 208 absorbs light in the near-IR wavelength band and the first fluid 205 has a high refractive index difference. This results in transmittance of visible light, indicated by the lighter vertical band, and absorbance of near-IR light, indicated by the dark region of the plot, with an equal distribution of light at all angles shown. The top left panel shows the system when the second fluid 208 does not absorb light in the visible or near-IR wavelength bands and the first fluid 205 has a low refractive index difference. This results in transmittance of light at all wavelengths shown while the transmitted light has a narrow distribution of angles (~170-190 θ) indicated by the dark horizontal bands. The top right panel shows the system when the second fluid 208 absorbs near-IR light and the first fluid 205 has a low refractive index difference. This results in absorbance of near-IR light, indicated by the wide dark region from ~800-2000 nm, and a narrow distribution of angles (~170-190 θ) indicated by the dark regions from 160-170 θ and 190-200 θ. The insert in each plot is an image of light transmitted through the system showing how the system transmits blurred visible light (bottom row), and clear visible light (top row).

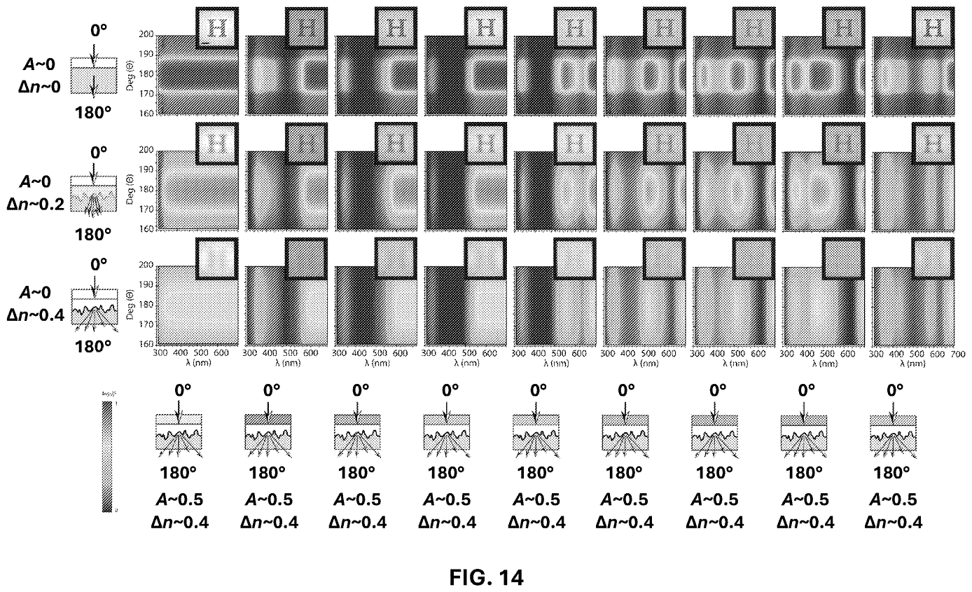

In a non-limiting example, according to some embodiments of the system shown in FIGS. 2A-2B, the second fluid includes a pigment and presence of the second fluid 208 in the second gap 207 is configured to selectively absorb light between the third layer 206 and the first layer 201; and presence of the first fluid 205 in the first gap 204 is configured to selectively scatter light forward between the first layer 201 and the second layer 202 by a refractive index difference between the first fluid 205 and the scattering surface 203 of the second layer 202. FIG. 14 shows exemplary plots and images demonstrating the combination of spectral selectivity (absorption) of light using different pigments in the second fluid and angular selectivity (control of forward scattering) based on the refractive index difference between the first fluid and the scattering surface. Each column in FIG. 14 shows plots obtained when the second fluid includes a different pigment that selectively absorbs specific wavelength bands of light, resulting in the dark vertical regions relative to the wavelength scale of each plot in FIG. 14. Each pigment allows transmission of light in the remaining wavelength bands as shown in the lighter regions of each plot relative to the wavelength scale. In order, from the left column to the right column, the color of light transmitted through the system is white/colorless, red, orange, yellow, light green, dark green, teal, blue, and pink. Each row shows plots obtained as the refractive index difference between the first fluid 208 and the scattering surface of the second layer 205 is changed. In the top row there is a low refractive index difference (Δn~0) leading to narrow distribution of forward scattered light indicated by the dark horizontal bands which show that no light is transmitted at angles between ~160-170 θ and ~190-200 θ. In the middle row, there is a moderate refractive index difference (Δn~0.2) leading to some distribution of forward scattered light indicated by a broader central band showing that light is transmitted at angles between ~170-190 θ. In the bottom row, there is a high refractive index difference (Δn~0.4) resulting in broad distribution of forward scattered light indicated by equal transmission of light at all angles shown. The inset in each plot is an image of light transmitted through the system showing the color of light and distribution of light transmitted through the system.

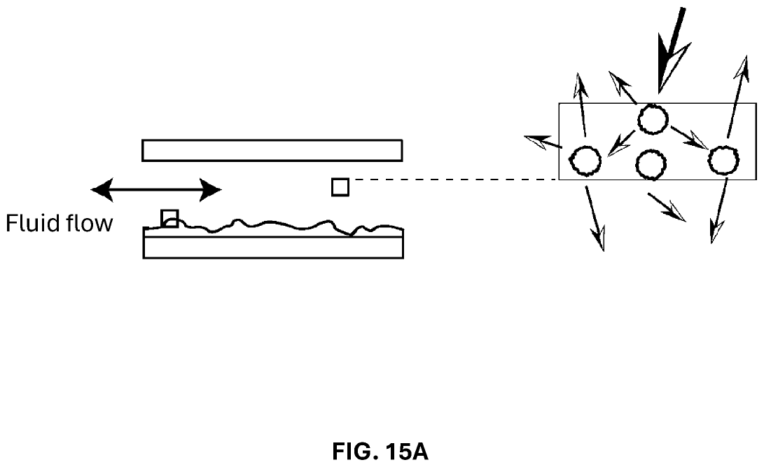

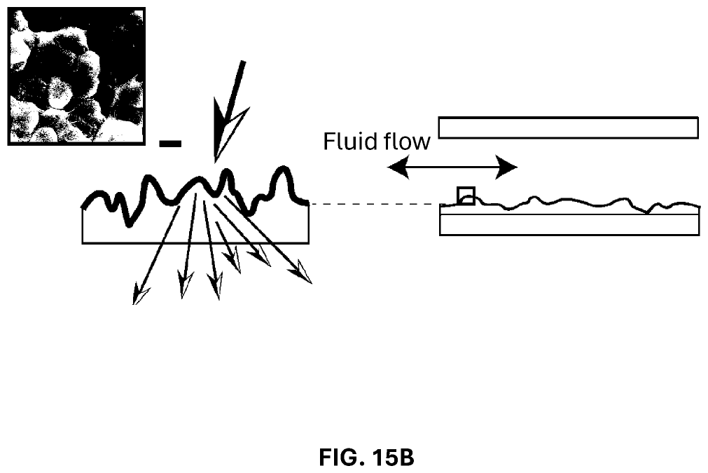

FIGS. 15A-15D show exemplary illustrations demonstrating the independent tuning of two distinct hierarchical scales of scattering that collectively enable complementary directional and blurring behaviors. FIG. 15A shows an exemplary illustration of how light (arrows) is scattered off of suspended particles which have a size in the nm scale. As shown in FIG. 15A, incident light (large arrow) can be scattered in multiple directions off of a suspended particle. The light scattered off of the suspended particle can be reflected away from the system, reflected off of other suspended particles within the fluid, or reflected through the system. FIG. 15B shows an exemplary illustration of how incident light (large arrow) is scattered in different forward directions by a scattering surface that is structured on the μm scale (the scale bar for the SEM image in the top left in is 20 μm). As shown in FIG. 15B, incident light (large arrow) can be scattered at multiple forward angles off of a scattering surface. Thus, one scale of scattering (FIG. 15A), achieved through nanoscale interactions in the fluid bulk dependent on the number of scatterers (as defined in FIG. 3B and FIG. 4B), allows for the control of the direction of light (forward versus backward). The other scale of scattering (FIG. 15B), is achieved at the interface of the fluid bulk and rough solid backing structure, allows for the independent control of the blurriness or distribution of forward-scatter of transmitted light depending on the refractive index difference between the fluid and the scattering surface (as defined in FIGS. 5C and 6A). Accordingly, the coupling of these two distinct scales of scattering in one device allows for the independent control of how much light is admitted and how that admitted light is distributed.

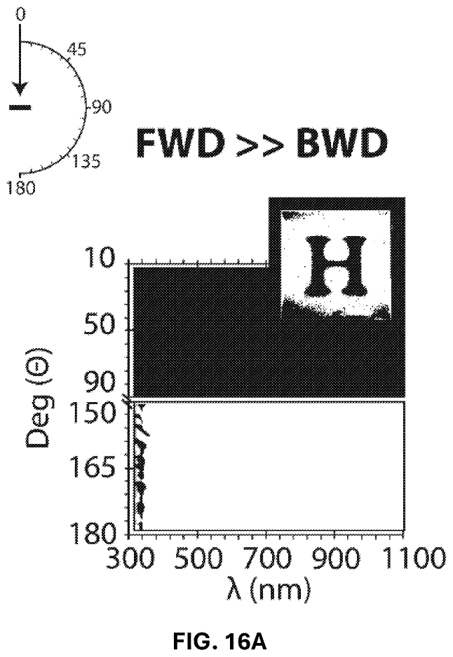

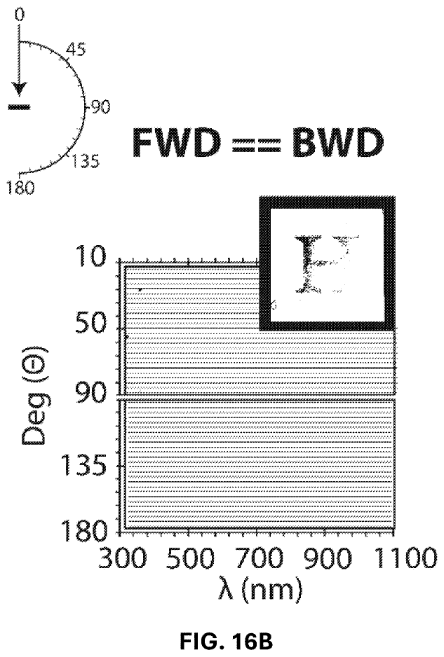

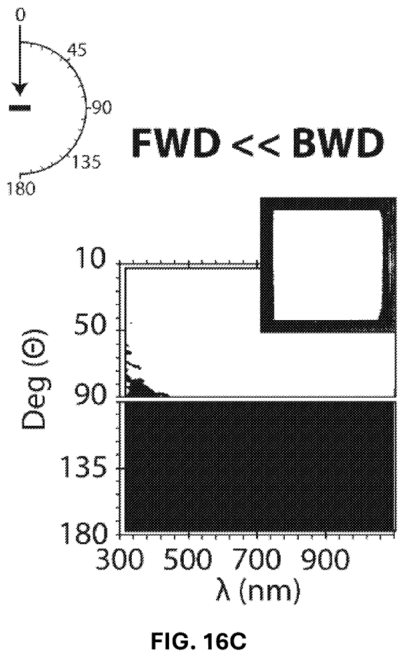

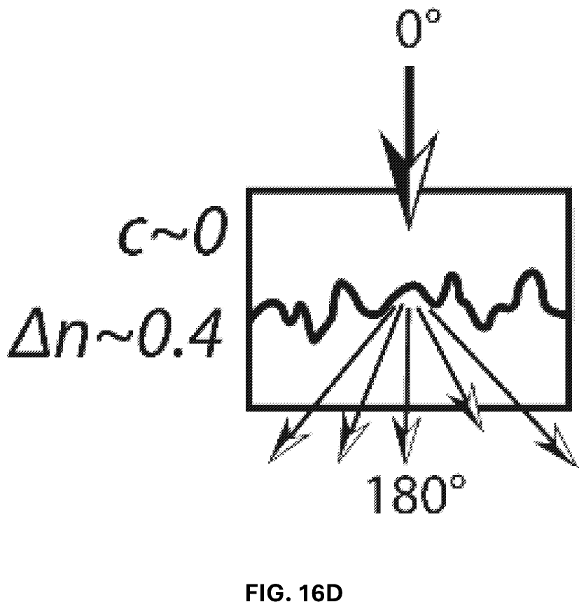

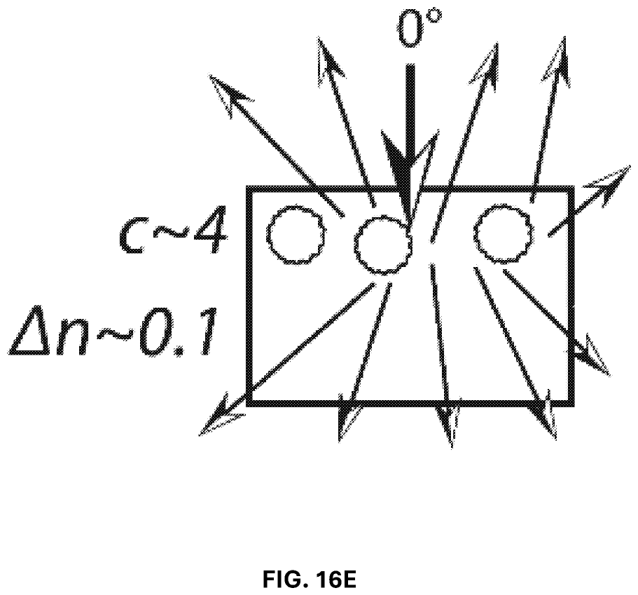

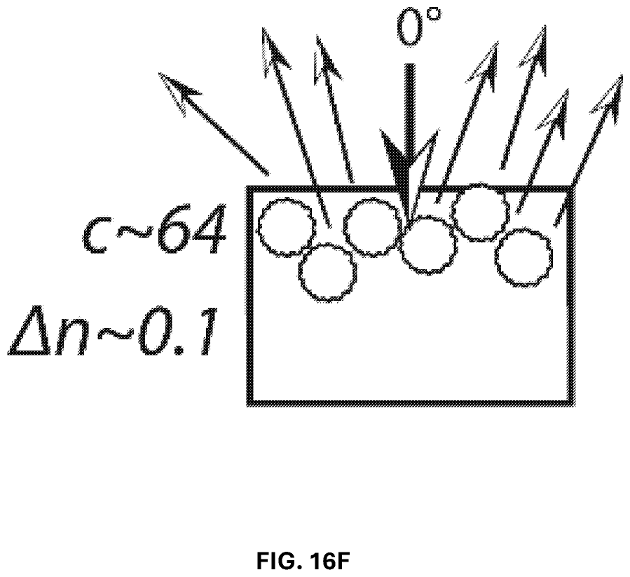

FIGS. 16A-16F show exemplary plots and illustrations showing the combined tuning of the direction of scattering using independent control of the refractive index difference at the interface of the fluid and the scattering surface and independent control of the concentration of suspended particles in the fluid. FIGS. 16A-16C show plots of backward scatter and forward scatter as a function of wavelength. In FIGS. 16A-16C, the left top inset shows the direction of incident light, while the top right inset shows an image of the system over a shield symbol. FIGS. 16D-16F each show a schematic of a system with a refractive index (Δn) and a suspended particle concentration (c). In FIGS. 16D-16F, the large arrow shows the incident light, while the smaller arrows show transmitted or scattered light. FIGS. 16D-16F show how the direction of scattered light changes as the concentration of suspended particles increases (c=~0, 4,64) while the refractive index difference at the interface of the fluid and the scattering surface is decreased (Δn=~0.4-0.1). FIGS. 16A and 16D show an example where forward scattering is much greater than backward scattering. In FIGS. 16A and 16D, the suspended particle concentration is zero, and the index mismatch is 0.4. As shown in FIG. 16A, there is no light transmitted in the backward direction as indicated by the darkened top panel while there is diffuse light transmitted in the forward direction as indicated by the bottom panel where the lack of shading shows an equal amount of light transmitted at all angles shown. The result is that light transmitted through the system is blurred as shown in the inset which is an image taken looking through the system. This effect is illustrated in FIG. 16D which shows incident light (large arrow) being scattered at many forward angles (small arrows) by the scattering surface. FIGS. 16B and 16E show an example where forward scattering is equal to backward scattering. In FIGS. 16B and 16E, the suspended particle concentration is ~4 mg/mL, and the index mismatch is 0.1. As shown in FIG. 16B, there is an equal amount of light transmitted in the backward and forward directions as indicated by the equal shading across all angles shown in both panels. The result is that light transmitted through the system is less blurred as shown in the inset which is an image taken looking through the system. This effect is illustrated in FIG. 16E which shows incident light (large arrow) being scattered at many angles (small arrows) by both the suspended particles (forward and backward scattering) and the scattering surface (forward scattering). FIGS. 16C and 16F show an example where there is no forward scattering, but the light is scattered backward (reflection) by the suspended particles. In FIGS. 16C and 16F, the suspended particle concentration is ~64 mg/mL and the index mismatch is ~0.1. As shown in FIG. 16C, there is no light transmitted in the forward direction as indicated by the darkened bottom panel, while there is diffuse light transmitted in the backward direction as indicated by the top panel where the lack of shading shows an equal amount of light transmitted at all angles shown. The result is that light transmitted through the system is reflected as shown by the inset which is an image taken looking through the system which appears opaque. This effect is illustrated in FIG. 16F which shows incident light (large arrow) being scattered at many backward angles by the high concentration of suspended particles.

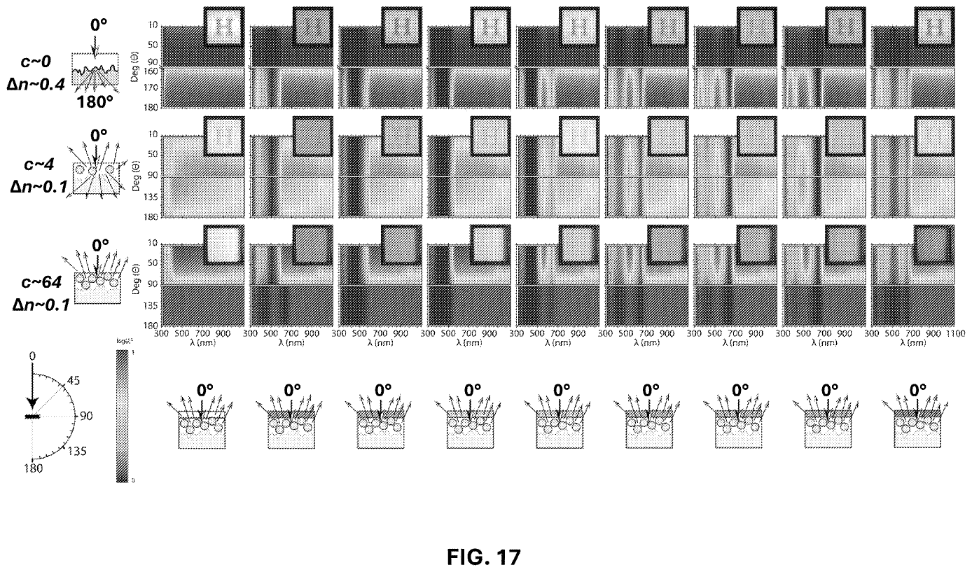

FIG. 17 shows plots and images of an exemplary system where the selective scattering of light and the color of light are independently controlled. In this example, the first fluid includes different pigments to selectively control the absorption of light which results in a range of colors of light transmitted through the system depending on the pigment in the first fluid. In this example, the selective scattering of light in the forward direction is controlled by both the refractive index difference at the interface of the second fluid and the scattering surface, while the selective scattering of light in the forward and backward directions is controlled by the concentration of particles in the second fluid. Each column shows plots obtained with a different pigment that selectively absorbs specific wavelength bands of light resulting in the dark vertical regions relative to the wavelength scale (x-axis) of each plot in FIG. 17. Each pigment allows transmission of light in the remaining wavelength bands as shown in the lighter regions of each plot relative to the wavelength scale. In order, from the left column to the right column, the color of light transmitted through the system is white/colorless, red, orange, yellow, light green, dark green, teal, blue, and pink. Each row shows how the direction of transmitted light (y-axis) in each plot changes as the concentration of suspended particles in the second fluid is changed along with the refractive index difference between the second fluid and the scattering surface. In the top row, there is a large refractive index difference (Δn~0.4) leading to a broad distribution of light scattered in the forward direction, indicated by the equal shading in the bottom panels relative to the y-axis and a blurred image. The top row also shows no suspended particles (c~0), leading to no backward scattering of light, indicated by the darkened top panels in each plot. In the middle row, there is a smaller refractive index difference (Δn~0.1) between the second fluid and the scattering surface and a moderate concentration of suspended particles (c~4 mg/mL) leading to equal distribution of light in the forward and backward directions indicated by the equal shading in both panels relative to the y-axis. In the bottom row, there is a smaller refractive index difference (Δn~0.1) between the second fluid and the scattering surface and a large concentration of suspended particles (c~64 mg/mL). This configuration leads to no transmission of light in the forward direction and broad distribution of light in the backward direction as indicated by the darkened lower panels in each plot (forward) and the equal shading in the top panels relative to the y-axis in each plot. The inset for each panel shows an image taken through the system showing the combination of change in color, from left to right, and increasing opacity, from top to bottom, for the light transmitted through the system.

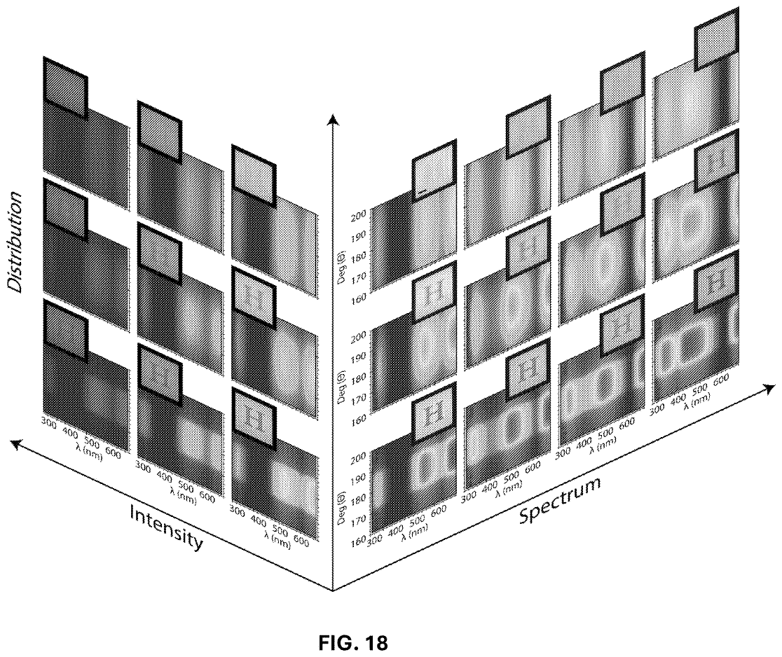

FIG. 18 shows how the transmission of light through a system can be controlled in three-dimensions (intensity, distribution, spectrum) according to some embodiments. Each panel is a plot of the angle of light transmitted in the forward direction (y-axis) and the wavelength of light transmitted in the visible wavelength band (x-axis). The inset in each plot shows an image taken through the system which shows the shading/darkening (intensity), blurriness (distribution of forward scattering), and color (spectrum) of light transmitted through the system. As shown in FIG. 18, light can be selectively absorbed and transmitted along the “spectrum” axis by including different pigments in a fluid within the system which leads to different colors of light transmitted. Each column from left to right along the spectrum axis shows the system when it transmits light green, dark green, teal, or blue light, respectively. Independent control of the intensity of light along the “intensity” axis can be exerted by including a broadband absorbing pigment (e.g. carbon black) to selectively darken or shade the light transmitted through the system. Each column from right to left along the intensity axis shows the system as the transmitted light through the system is progressively darker due to progressively increasing concentration of the broadband absorbing pigment. Independent control of the forward scattering (distribution) of light can be achieved along the “distribution” axis through changing the refractive index difference at the interface of an additional fluid with a scattering surface, leading to control of blurriness. Each row from top to bottom shows the system as the refractive index difference goes from a high refractive index difference to a low refractive index difference, resulting in decreased blurriness.

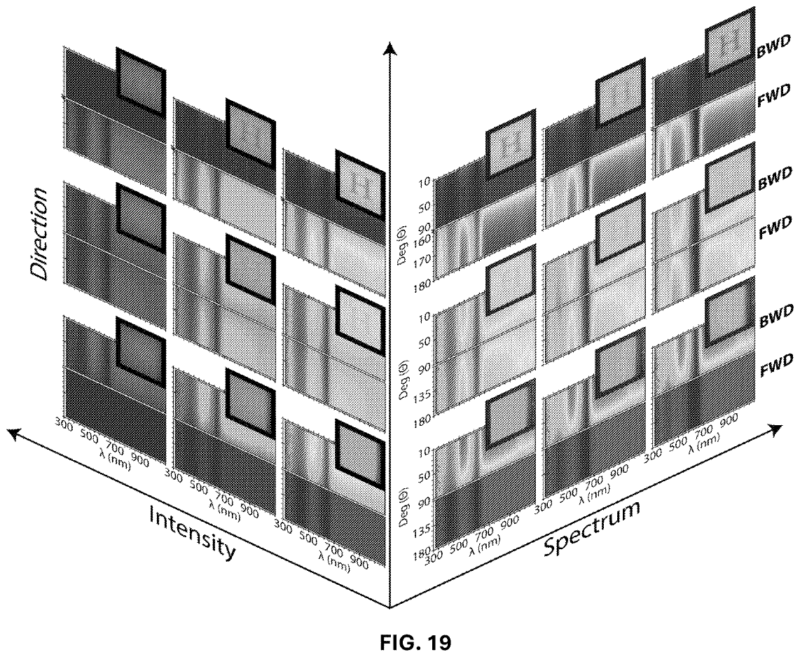

FIG. 19 shows how the transmission of light through a system can be controlled in three-dimensions (intensity, direction, spectrum) according to some embodiments. Each panel is a plot of the angle of light transmitted (y-axis) in the forward direction (top) and backward direction (bottom), and the wavelength of light transmitted (x-axis). The inset in each plot shows an image taken through the system which shows the shading/darkening (intensity), blurriness (distribution of forward and backward scattering), and color (spectrum) of light transmitted through the system. As shown in FIG. 19, light can be selectively absorbed and transmitted along the “spectrum” axis by including different pigments in a fluid within the system which leads to different colors of light transmitted. Each column from left to right along the spectrum axis shows the system transmitting green, teal, or blue light, respectively. Independent control of the intensity of light along the “intensity axis” can be exerted by including a broadband absorbing pigment (e.g. carbon black) to selectively darken or shade the light transmitted through the system. Each column from right to left along the intensity axis shows the system as the transmitted light through the system is progressively darker due to progressively increasing concentration of the broadband absorbing pigment.

Independent control of the direction of scattered light along the “direction” can be achieved both through changing concentration of suspended particles in the additional fluid, leading to control of opacity. Each row from top to bottom along the direction axis shows the system as the system becomes progressively more opaque due to progressively increasing the concentration of suspended particles in the fluid.

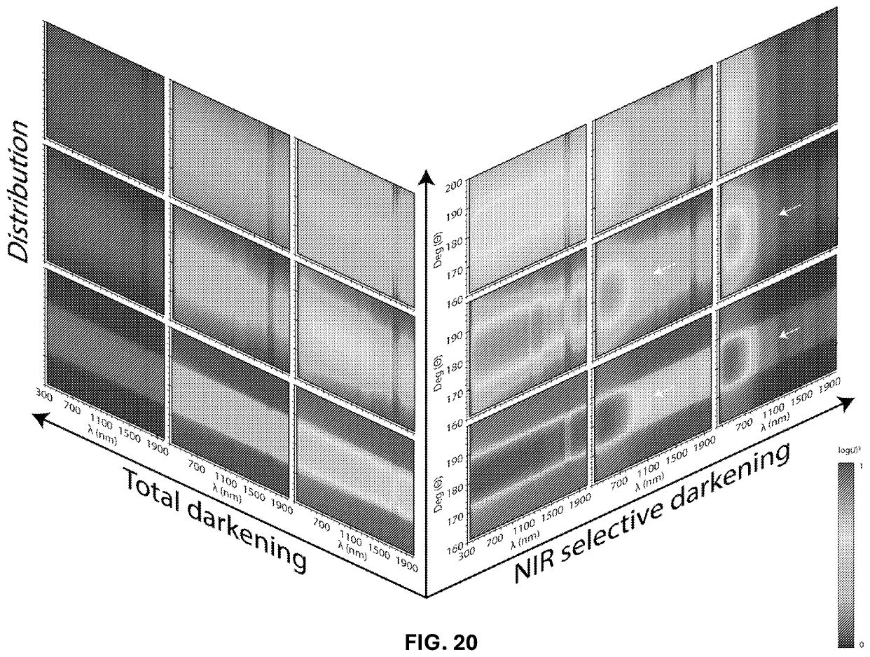

FIG. 20 shows how the transmission of light through a system can be controlled in three-dimensions (total darkening, distribution, and near-IR selective darkening) according to some embodiments. Each panel is a plot of the angle of light transmitted (y-axis) in the forward direction and the wavelength of light transmitted (x-axis). As shown in FIG. 20, light can be selectively absorbed and transmitted along the “NIR selective darkening” axis by tuning the fluid to selectively absorb near-IR light. Each column from left to right along the NIR selective darkening axis shows the system as the fluid is changed from a fluid that doesn't absorb near-IR light, to a fluid that moderately absorbs near-IR light, to a fluid that absorbs almost all near-IR light. Independent control of the intensity of light along the “total darkening” axis can be exerted by including a broadband absorbing pigment (e.g. carbon black) to selectively darken or shade the light transmitted through the system. Each column from right to left along the total darkening axis shows the system as the transmitted light through the system is progressively darker due to progressively increasing concentration of the broadband absorbing pigment. Independent control of the forward scattering of light along the “distribution” axis can be achieved through changing the refractive index difference at the interface of an additional fluid with a scattering surface. Each row from top to bottom along the distribution axis shows the system as the refractive index difference is decreased, resulting in progressively narrower distributions of transmitted light. The result of incorporating selective absorbance of near-IR light, within the system exemplified in FIG. 20, is that this system is capable of decreasing excess indoor heating that would normally result from transmission of near-IR light into a building.

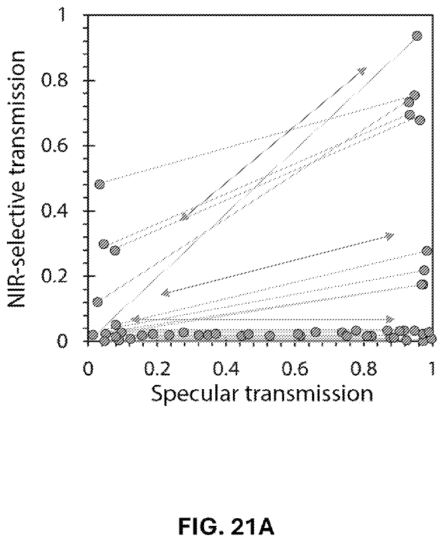

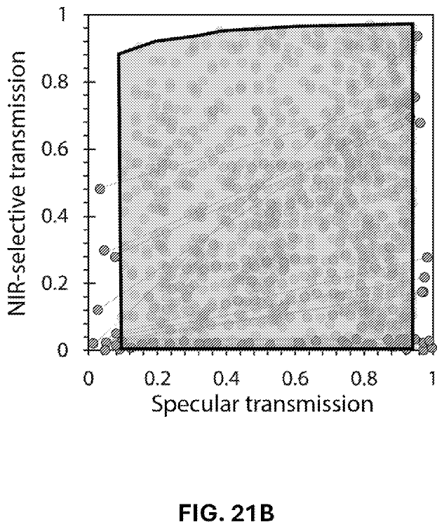

As shown in several non-limiting examples throughout FIGS. 11-20, fluidic systems for control of light are universally configurable. The utility of this approach is illustrated in FIGS. 21A-21B, where FIG. 21A shows how dependent systems can only move between states along straight lines resulting in limited configurability to simultaneously control, for example, specular transmission and NIR-selective transmission. In contrast, FIG. 21B shows that, for the same variables, an independent system yields universal configurability to tune each variable simultaneously and independently allowing for movement between states “within an area”, i.e., free movement in two-dimensions.

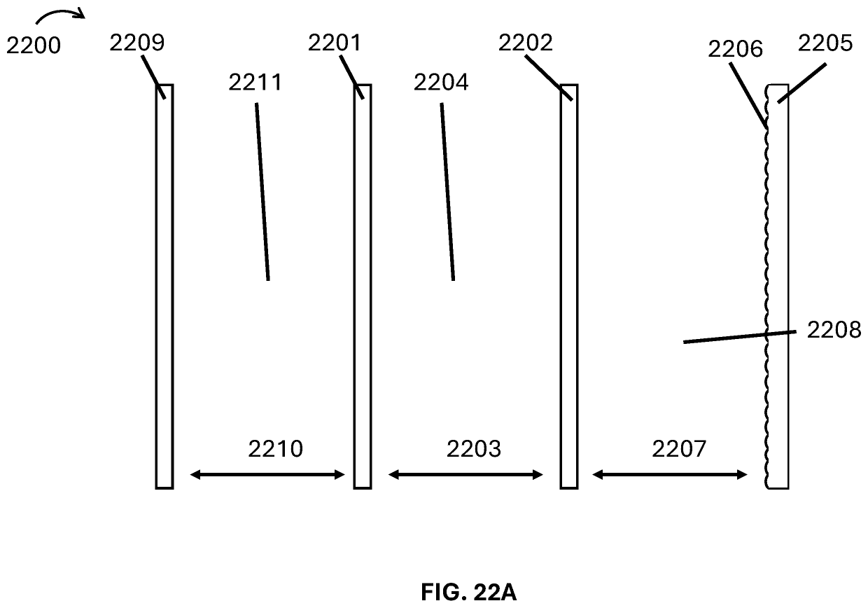

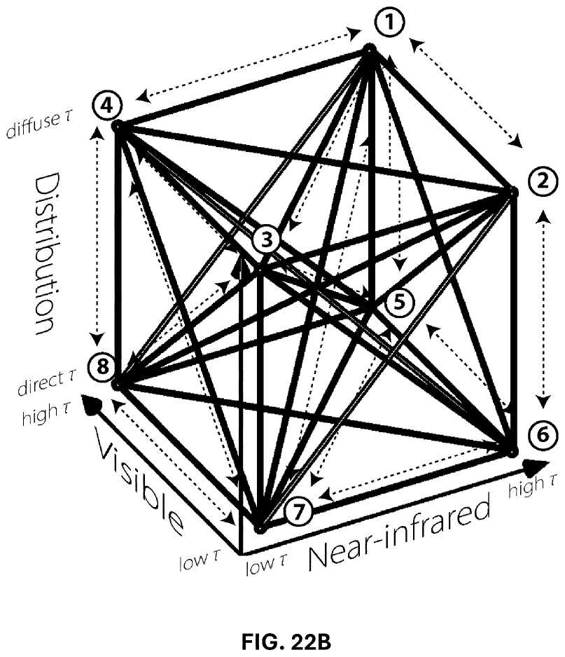

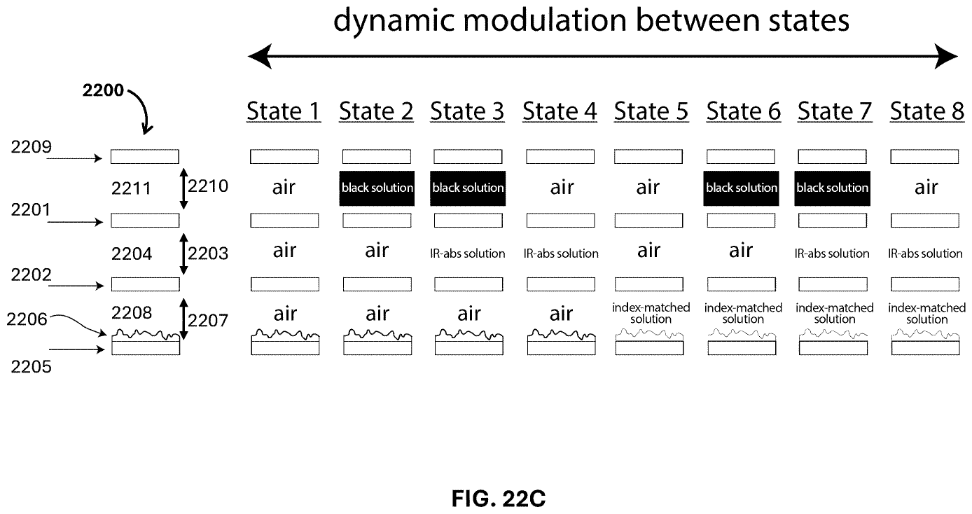

In some embodiments, a FLUIDS platform is a system 2200 capable of universally controlling transmitted light (e.g., orthogonally controlling intensity, spectrum, and distribution). FIGS. 22A-22C show an exemplary illustration of an embodiment of the FLUIDS platform related to the system shown in FIG. 2, that includes a fourth layer and a third gap such that the third gap is configured to allow a third fluid to be flowed into and out of the third gap. In some embodiments, a system is disclosed, shown in FIG. 22A, including a first layer 2201 including a first transparent solid material; a second layer 2202 including a second transparent solid material; a first gap 2203 between the first layer 2201 and the second layer 2202 configured to allow a first fluid 2204 to selectively flow into and out of the first gap 2203, presence of the first fluid 2204 in the first gap 2203 is configured to at least one of selectively scatter, reflect, and absorb light between the first layer 2201 and the second layer 2202. In this example, the system also includes a third layer 2205 including a third transparent solid material, the third transparent solid material including a scattering surface 2206; and a second gap 2207 between the second layer 2202 and the scattering surface 2206 of the third layer 2205 configured to allow a second fluid 2208 to selectively flow into and out of the second gap 2207, the second gap 2207 being on an opposite side of the second layer 2202 from the first gap 2203, presence of the second fluid 2208 in the second gap 2207 is configured to selectively control scattering of light between the second layer 2202 and the third layer 2205 by one or more of: the scattering surface 2206 of the third layer 2205; a refractive index difference between the second fluid 2208 and the scattering surface of the third layer 2206, or suspended particles in the second fluid 2208 configured to selectively scatter light. In this example, the system also includes a fourth layer 2209 including a fourth transparent solid material, the fourth layer 2209 disposed on the opposite side of the first layer 2201 as the second layer 2202; and a third gap 2210 between the first layer 2201 and the fourth layer 2209 configured to allow a third fluid 2211 to selectively flow into and out of the third gap 2210, presence of the third fluid 2211 in the third gap 2210 is configured to selectively reduce transmission of light between the fourth layer 2209 and the first layer 2201. In some embodiments, one or more of the first layer, the second layer, the third layer, or the fourth layer can include a scattering surface.

FIG. 22B illustrates the functionality, as represented by a cubic phase space, made accessible by the device design in FIG. 22A. Each of the accessible corners of the cubic phase space of FIG. 22B are shown in FIG. 22C, where different combinations of a fluid including a pigment to control absorption (e.g., black fluid), near-infrared-selectively-absorbing fluid, and refractive-index-matching fluid (all described above in FIG. 2) can be combined in respective fluid gaps to access different states (States 1-8) which represent each corner of the cubic phase space shown in FIG. 22B. The eight configurations shown in FIG. 22C are described herein. State 1 in FIG. 22C shows the system when each of the first fluid, second fluid, and third fluid are independently absent, i.e., there is air in each of the gaps.

State 2 in FIG. 22C shows the system when the first fluid is absent (air), the second fluid is absent (air), and the third fluid (black solution) includes a pigment (e.g., carbon black) to control absorption for total darkening. State 3 in FIG. 22C shows the system when the first fluid is a near-IR absorbing fluid (IR-abs solution) to near-IR darkening, the second fluid is absent (air), and the third fluid (black solution) includes a pigment (e.g., carbon black) to control absorption. State 4 in FIG. 22C shows the system when the first fluid is a near-IR absorbing fluid (IR-abs solution), the second fluid is absent (air), and the third fluid is absent (air). State 5 in FIG. 22C shows the system when the first fluid is absent (air), the second fluid is a refractive-index-matched fluid (index-matched solution), and the third fluid is absent (air). State 6 in FIG. 22C shows the system when the first fluid is absent (air), the second fluid is a refractive-index-matched fluid (index-matched solution) to increase blurriness, and the third fluid (black solution) includes a pigment (e.g., carbon black) to control absorption. State 7 in FIG. 22C shows the system when the first fluid is a near-IR absorbing fluid (IR-abs solution), the second fluid is a refractive-index-matched fluid (index-matched solution), and the third fluid (black solution) includes a pigment (e.g., carbon black) to control absorption. State 8 in FIG. 22C shows the system when the first fluid is a near-IR absorbing fluid (IR-abs solution), the second fluid is a refractive-index-matched fluid (index-matched solution), and the third fluid is absent (air).

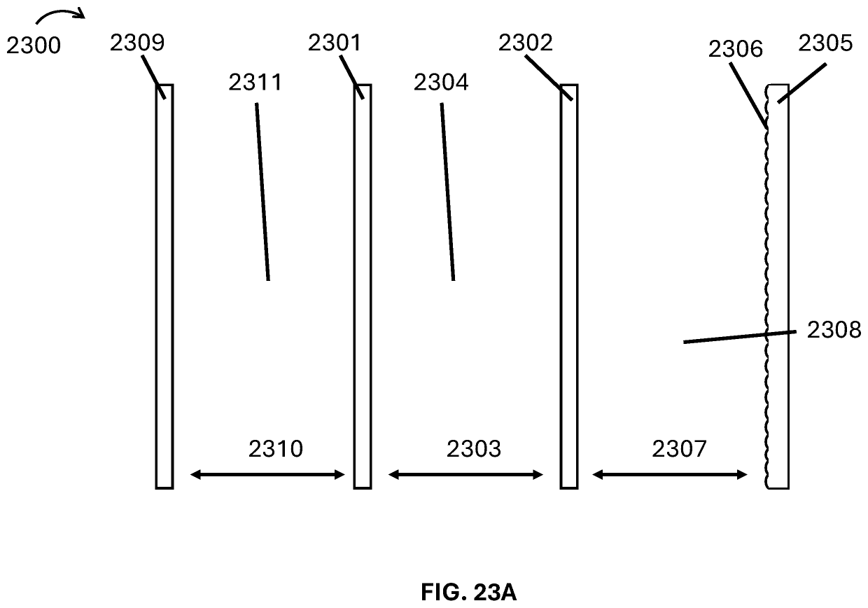

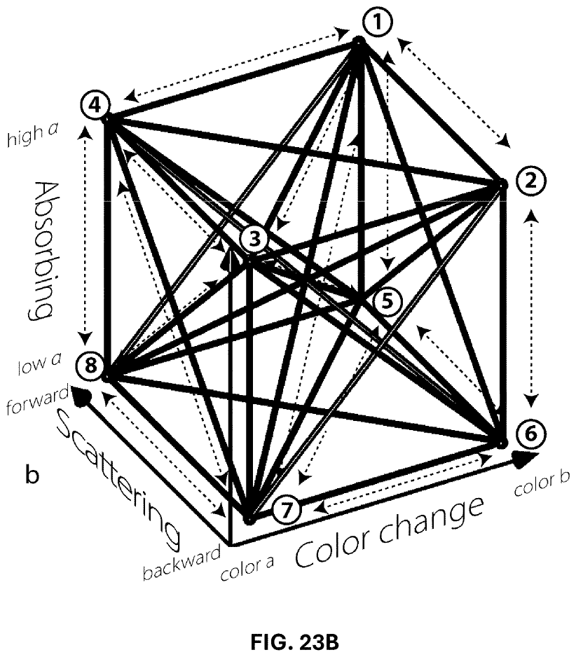

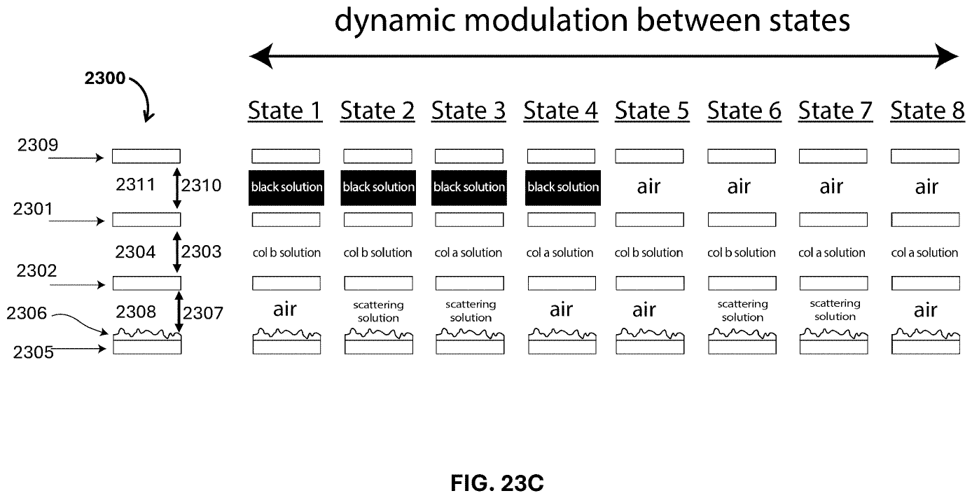

In some embodiments, the FLUIDS platform is capable of universally controlling non-transmitted light (e.g., orthogonally controlling absorption, color, and backscattering), as well as a functionality for opaque components. FIGS. 23A-23C show an exemplary illustration of an embodiment of the FLUIDS platform related to the system shown in FIG. 2, that includes a fourth layer and a third gap such that the third gap is configured to allow a third fluid to be flowed into and out of the third gap. In some embodiments, a system 2300 is disclosed, shown in FIG. 23A, including a first layer 2301 including a first transparent solid material; a second layer 2302 including a second transparent solid material; a first gap 2303 between the first layer 2301 and the second layer 2302 configured to allow a first fluid 2304 to selectively flow into and out of the first gap 2303, presence of the first fluid 2304 in the first gap 2303 is configured to at least one of selectively scatter, reflect, and absorb light between the first layer 2301 and the second layer 2302; a third layer 2305 including a third transparent solid material, the third transparent solid material including a scattering surface 2306; and a second gap 2307 between the second layer 2302 and the scattering surface 2306 of the third layer 2305 configured to allow a second fluid 2308 to selectively flow into and out of the second gap 2307, the second gap 2307 being on an opposite side of the second layer 2302 from the first gap 2303, presence of the second fluid 2308 in the second gap 2307 is configured to selectively control scattering of light between the second layer 2302 and the third layer 2305 by one or more of: the scattering surface 2306 of the third layer 2305; a refractive index difference between the second fluid 2307 and the scattering surface 2306 of the third layer 2305, or suspended particles in the second fluid 2308 configured to selectively scatter light; a fourth layer 2309 including a fourth transparent solid material, the fourth layer 2309 disposed on the opposite side of the first layer 2301 as the second layer 2302; and a third gap 2310 between the first layer 2301 and the fourth layer 2309 configured to allow a third fluid 2311 to selectively flow into and out of the third gap 2310, the presence of the third fluid 2311 in the third gap is configured to selectively reduce transmission of light between the fourth layer 2309 and the first layer 2301.

FIG. 23B illustrates the functionality, as represented by a cubic phase space, made accessible by the device design in 23A. Each of the accessible corners of the cubic phase space are represented by the states shown in FIG. 23C, where different combinations of fluid including a pigment to control absorption (e.g., black fluid), selectively-absorbing fluid (e.g., a colored dye or particle suspended in a transparent fluid like water, isopropyl alcohol, or mineral oil), and fluid including suspended particles (e.g., scattering solution, as described in FIGS. 3, 4) can be combined in respective fluid gaps to access each corner of the cubic phase space shown in FIG. 23B. The eight configurations shown in FIG. 23C are described herein. State 1 in FIG. 23C shows the system when the first fluid includes a pigment (col b solution), the second fluid is absent (air), and the third fluid (black solution) includes a first pigment (e.g., carbon black) to control absorption. State 2 in FIG. 23C shows the system when the first fluid includes a pigment (col b solution), the second fluid includes suspended particles to control back scattering (scattering solution), and the third fluid (black solution) includes a pigment (e.g., carbon black) to control absorption. State 3 in FIG. 23C shows the system when the first fluid includes a second pigment (col a solution), the second fluid includes suspended particles to control back scattering (scattering solution), and the third fluid (black solution) includes a pigment (e.g., carbon black) to control absorption. State 4 in FIG. 23C shows the system when the first fluid includes a second pigment (col a solution), the second fluid is absent (air), and the third fluid (black solution) includes a pigment (e.g., carbon black) to control absorption. State 5 in FIG. 23C shows the system when the first fluid includes a first pigment (col b solution), the second fluid is absent (air), and the third fluid is absent (air). State 6 in FIG. 23C shows the system when the first fluid includes a first pigment (col b solution), the second fluid includes suspended particles to control back scattering (scattering solution), and the third fluid is absent (air). State 7 in FIG. 23C shows the system when the first fluid includes a second pigment (col a solution), the second fluid includes suspended particles to control back scattering (scattering solution), and the third fluid is absent (air). State 8 in FIG. 23C shows the system when the first fluid includes a second pigment (col a solution), the second fluid is absent (air), and the third fluid is absent (air).

In some embodiments, the intensity, spectrum, direction and/or distribution of a beam of light can be controlled by selectively flowing one or more fluids into and out of gaps of a system disclosed herein. Certain embodiments of the present disclosure describe a method of using a system described herein, including selectively flowing the first fluid into and out of the first gap to selectively control selectively control scattering of light between the first layer and the second layer by one or more of: the scattering surface of the second layer; a refractive index difference between the first fluid and the scattering surface of the second layer, or suspended particles in the first fluid configured to selectively scatter light.

In some embodiments, the direction of scattered light can be controlled by selectively flowing a fluid comprising suspended particles into and out of a gap or by changing the concentration of suspended particles in a fluid. In some embodiments, the distribution of light (blurriness) can be controlled by selectively changing the refractive index mismatch between the surface and the fluid, for example by selectively flowing fluids of different refractive indices into and out of a gap. In some embodiments, the intensity of light can be controlled by selectively flowing a fluid comprising pigment into or out of a gap or by changing the concentration of a pigment in a fluid. In some embodiments, the spectrum of light transmitted can be controlled by selectively flowing a fluid comprising a spectrally selective fluid into and out of a gap.

In some embodiments, one or more of the layers of a system disclosed herein can include a scattering surface as described below in the “Fluid Compositions and System Materials” section. In some embodiments, one or more of the layers of a system disclosed herein can include a transparent coating as described below in the “Fluid Compositions and System Materials” section. In some embodiments, one or more of the layers of a system disclosed herein can take one or more form factors as described below in the “Fluid Compositions and System Materials” section. In some embodiments, a system disclosed herein can include a heat transfer layer as described below in the “Fluid Compositions and System Materials” section.

### 2. FLUIDS-H: Flowable Universal Interface for Directing Sunlight and Heat

Certain embodiments of the present disclosure describe a system including a first layer including a first transparent solid material; a second layer including at least one second transparent solid material; at least a first gap between the first layer and the second layer configured to allow at least a first fluid to selectively flow into and out of the first gap, presence of the first fluid in the first gap is configured to at least one of selectively scatter light, reflect light, or absorb light between the first layer and the second layer; a third layer including a third transparent solid material; and a second gap defining a distance of 5-50 mm between the second layer and the third layer and configured to allow a second fluid to selectively flow into and out of the second gap, the second gap being on an opposite side of the second layer from the first gap, and presence of the second fluid in the second gap is configured to transfer heat energy through the second gap based on convection and conduction of heat in the second fluid.

In one embodiment, a system is disclosed which is the Flowable Universal Interface for Directing Sunlight and Heat (FLUIDS-H). However, the FLUIDS-H systems disclosed herein are not limited to sunlight and can be applied to directing any type of light.

The modulation of light intensity and heat flux represent two important control knobs for energy management in buildings. Windows capable of tuning either light intensity or heat flux are each tailored to improve performance for a separate set of distinct seasonal, solar, or diurnal conditions. A window capable of modulating light intensity and heat flux simultaneously can therefore greatly increase the number of scenarios in which an energetically-optimal configuration is available, improving building efficiency substantially. However, incompatibilities in the approaches for strictly-optically-or-thermally-adaptive systems have prohibited their integration synergistically. Disclosed herein is a conceptually-different approach-by combining fluid-based biological strategies-a window capable of tuning optical transmission and thermal conduction orthogonally is developed. Moreover, the FLUIDS-H platform's combinatorial versatility can unlock functionalities that no window platform can access previously—for example to behave as a rechargeable solar-thermal battery.

In some embodiments, the modulation of light transmission and heat flux represent two important control knobs for energy management in buildings. Transparent windows without fluids are designed as optical transmitters (e.g., to promote light transmission) and thermal insulators (e.g., to restrict heat flux)—a configuration that is energetically favorable only a small fraction of the year. The modulation of the default optical and thermal configurations can provide access to states that are energetically favorable across a greater fraction of the year.

Window materials capable of modulating light intensity, without modulating heat flux, on the one hand, can solve challenges like A and B (A: daylight/glare control to shade midday, B: solar heat control to avoid overheating on a sunny summer day), but not challenges like C and D (C: thermal exhaust control to discharge unwanted heat on a cool summer night, D: thermal ingress control to utilize heat from the hot building surface on a sunny winter day).

Window materials capable of modulating heat flux, without modulating light intensity, on the other hand, can solve challenges like C and D (C: thermal exhaust control to discharge unwanted heat on a cool summer night, D: thermal ingress control to utilize heat from the hot building surface on a sunny winter day), but not challenges like A and B (A: daylight/glare control to shade midday, B: solar heat control to avoid overheating on a sunny summer day).

Systems disclosed herein that can simultaneously and independently control light intensity and heat flux are capable of solving both classes of challenges (A/B and C/D) at once, substantially increasing the total number of energetic challenges a single platform is able to solve across the year, greatly improving energy efficiency compared to a system that can only solve A/B or only C/D.

Window technologies that solve challenges A/B or that solve challenges C/D use entirely different materials and mechanisms, and their fundamental incompatibilities have prohibited the untapped energy savings available with their integration into one system synergistically.

Disclosed herein, using a conceptually different approach to the technologies that solve challenges A/B or that solve challenges C/D, an under-explored class of material—fluid—is leveraged to develop a combined optically-thermally-adaptive system that can, at once, solve challenges A/B, C/D.

Moreover, because such a versatile system can achieve combinations of optical-thermal functionality unavailable to strictly-optically-adaptive platforms (that solve A/B) and strictly-thermally-adaptive platforms (that solve C/D), a combined system can unlock the ability to solve challenges like E and F (E: heating w/o overlighting during a warm and sunny spring/autumn day, F: using the window as a solar-thermal battery to store heat during the hot day and discharge it indoors during the cool night) that no type of window system has ever been able to access previously.

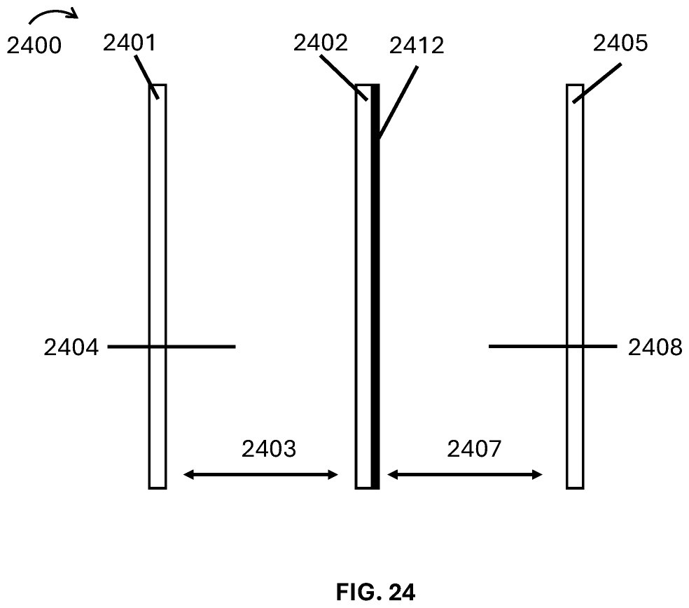

In one embodiment, a system is disclosed, shown in FIG. 24, includes a first gap 2403 used to dynamically control light (e.g., an optical gap) and a second gap 2407 used to dynamically control heat flux (e.g., a thermal gap). As shown in FIG. 24, the system includes a first layer 2401 including a first transparent solid material; a second layer 2402 including at least one second transparent solid material; at least a first gap 2403 between the first layer 2401 and the second layer 2402 configured to allow at least a first fluid 2404 to selectively flow into and out of the first gap 2403. In this example, the presence of the first fluid 2404 in the first gap 2403 is configured to at least one of selectively scatter light, reflect light, and absorb light between the first layer 2401 and the second layer 2402. In this example, a third layer 2405 comprising a third transparent solid material; and a second gap 2407 defining a distance of 5-50 mm between the second layer 2403 and the third layer 2405 and configured to allow a second fluid 2408 to selectively flow into and out of the second gap 2407, the second gap 2407 being on an opposite side of the second layer 2402 from the first gap 2403. In this example, the presence of the second fluid 2408 in the second gap 2407 is configured to transfer heat energy through the second gap 2407 based on convection and conduction of heat in the second fluid 2408. The second fluid 2408 can be any transparent fluid with high thermal conductivity. In some embodiments, the second layer 2402 optionally includes a transparent coating 2412.

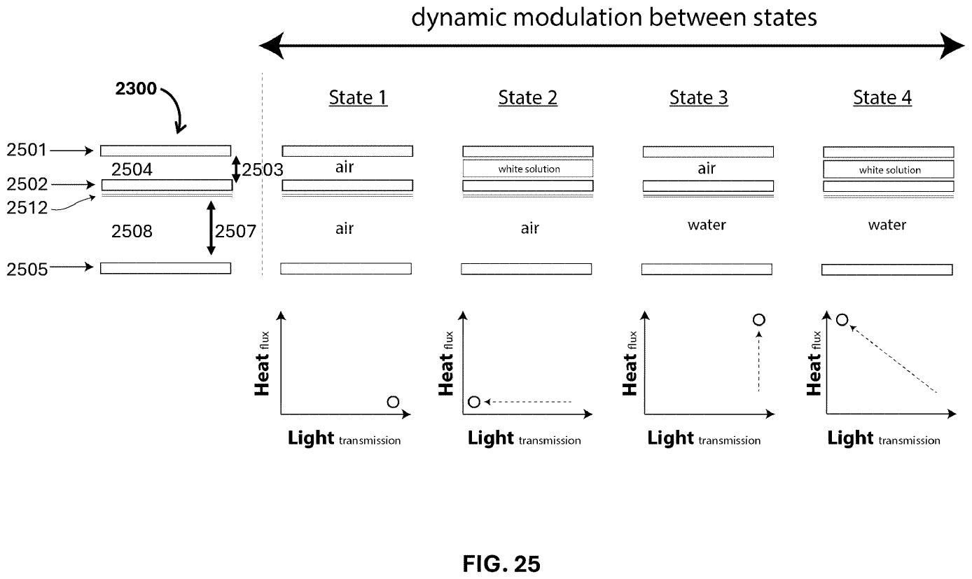

FIG. 25 provides an illustration of the FLUIDS-H system and non-limiting exemplary states the system can exist in to configure heat transfer and light transmission, according to some embodiments of the present disclosure. As shown in FIG. 25, the system includes a first gap 2503 disposed between a first layer 2501 and a second layer 2502 that includes a transparent coating 2512, and a second gap 2507 disposed between the second layer 2502 and the third layer 2505. In some embodiments, optical properties of the system can be controlled by selectively flowing one or more fluids 2504 into and out of the first gap 2504, and while thermal properties of the system can be controlled selectively flowing one or more fluids 2508 into and out of the second gap 2507. In some embodiments, the system includes a transparent coating. In these embodiments, the transparent coating limits radiative heat transfer in the absence of the second fluid in the second gap, such that the dominant difference in heat transfer, between states where the second fluid is absent and states where the second fluid is present, arises from convection and conduction (which changes drastically when switching between air and water). In some embodiments the transparent coating has low emissivity. In some embodiments, the transparent coating has high emissivity. In some embodiments, the transparent coating selectively reflects light in a specific wavelength band. In some embodiments, the transparent coating includes a metal oxide or a metal-oxide/metal/metal-oxide sandwich. In some embodiments, the transparent coating includes 200 nm thick indium tin oxide or 25 nm/10 nm/25 nm TiO₂/Ag/TiO₂. As shown in FIG. 25, the second gap can be filled with any transparent fluid with high thermal conductivity. Non-limiting examples of transparent fluids with high thermal conductivity include various mineral oils, isopropyl alcohol, water, and a combination thereof. The first fluid gap can be filled with any combination of selectively absorbing, or selectively-scattering fluids, as described below in the “Fluid Compositions and System Materials” section.

As shown in FIG. 25, in State 1, each of the first fluid and the second fluid are absent (air). In State 1, light is transmitted through the system (absence of the first fluid), and the system insulates the indoor climate from the outdoor due to the absence of the second fluid. As shown in FIG. 25, in State 2, the system can exist in a state where the first fluid includes particles to scatter light (white solution) and is present in the first gap while the second fluid is absent (air). Thus, presence of the first fluid results in scattering or reflection of light by the system, while the absence of the second fluid results in thermal insulation by the system. As shown in FIG. 25, in State 3, the first fluid is absent (air), which allows for transmission of light through the system, while the presence of water as the second fluid in the second gap results in heat absorption from the surrounding environment which is transferred by the second fluid to the indoor climate through conductive and convective heat exchange. As shown in FIG. 25, in State 4, the system can exist in a state where the first fluid includes particles to scatter light (white solution) such that presence of the first fluid results in scattering or reflection of light by the system, while water is present as the second fluid in the second gap which results in heat absorption from the surrounding environment and transfer of the heat to the indoor climate through conductive and convective heat exchange.

The exemplary embodiment shown in FIG. 25 includes a first fluid in the first gap (e.g., optical gap) that includes suspended particles that scatter light. However, a FLUIDS-H system can combine a thermal gap with one or more optical gaps as described in the context of the FLUIDS system above to independently control intensity, direction, distribution and/or color of light. In some embodiments, the direction of scattered light can be controlled by selectively flowing a fluid comprising suspended particles into and out of an optical gap or by changing the concentration of suspended particles in a fluid. In some embodiments, the distribution of light (blurriness) can be controlled by selectively changing the refractive index mismatch between the surface and the fluid, for example by selectively flowing fluids of different refractive indices into and out of an optical gap. In some embodiments, the intensity of light can be controlled by selectively flowing a fluid comprising pigment into or out of an optical gap or by changing the concentration of a pigment in a fluid. In some embodiments, the spectrum of light transmitted can be controlled by selectively flowing a fluid comprising a spectrally selective fluid into and out of an optical gap.

In some embodiments, the second gap in the FLUIDS-H platform (thermal gap), as shown in FIG. 24, being configured to transfer heat energy, can be included as an add-on component to any of the systems described in the present disclosure by adding an additional layer defining a gap of 5-50 mm, the gap configured to allow a fluid to selectively flow into and out of the gap, and where the presence of the fluid in the gap is configured to transfer heat energy through the gap based on convection and conduction of heat in the fluid. In these embodiments, there is synergy between the optical gap(s) and the thermal layer, i.e., the additional layer and gap. In some embodiments, the gap distance in the optical gap(s) can be on the 1-mm length-scale, but, to access a large change in heat flux the thermal gap, i.e., the second gap in FIG. 24, thicknesses between 5 mm to 50 mm can be used. In some embodiments, the gap distance of the second gap is 5 mm and 50 mm, between 5 mm and 20 mm, between 5 mm and 12 mm, between 5 mm and 8 mm, between 8 mm and 50 mm, between 8 mm and 20 mm, or between 20 mm and 50 mm, or any distance bounded by any two values disclosed herein. In some embodiments, a small gap distance (e.g., a gap distance of less than 5 mm) does not allow enough space for convection to occur. In some embodiments, a small gap distance (e.g., a gap distance of less than 5 mm) does not allow insulation in the absence of a thermally conductive fluid. In some embodiments, a thermal gap of a FLUDS-H system is disposed on an innermost surface of a system (e.g., such that incident light is transmitted through one or more optical gaps before being transmitted through the thermal gap. However, the second gap of a FLUIDS-H position can be located at any position within a system.

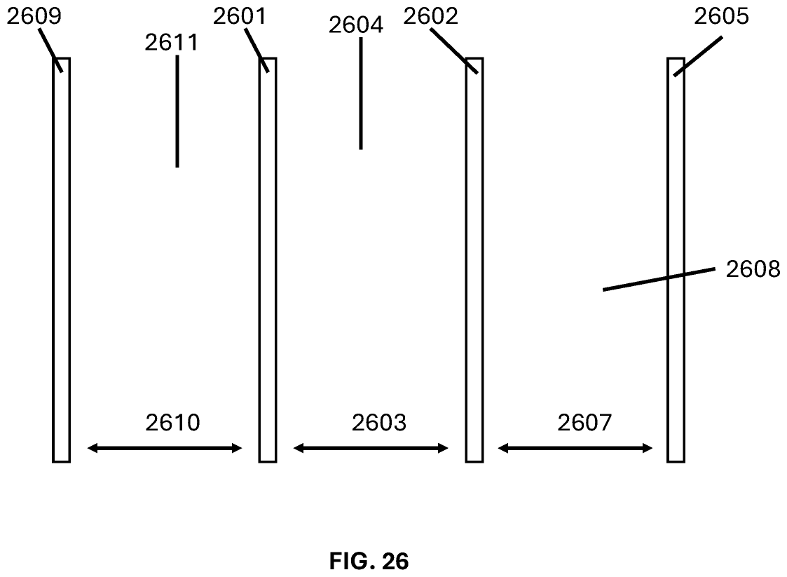

In one embodiment of the present disclosure, a system is disclosed, as shown in FIG. 26 and based on the system illustrated in FIG. 24, including a first layer 2601 including a first transparent solid material; a second layer 2602 including at least one second transparent solid material; at least a first gap 2603 between the first layer 2601 and the second layer 2602 configured to allow at least a first fluid 2604 to selectively flow into and out of the first gap 2603. In this example, the presence of the first fluid 2604 in the first gap 2603 is configured to at least one of selectively scatter light, reflect light, and absorb light between the first layer 2601 and the second layer 2602. In this example, the system also includes a third layer 2605 comprising a third transparent solid material; a second gap 2607 defining a distance of 5-50 mm between the second layer 2603 and the third layer 2605 and configured to allow a second fluid 2608 to selectively flow into and out of the second gap 2607, the second gap 2607 being on an opposite side of the second layer 2602 from the first gap 2603. In this example, the presence of the second fluid 2608 in the second gap 2607 is configured to transfer heat energy through the second gap 2607 based on convection and conduction of heat in the second fluid 2608. In this example, the system also includes a fourth layer 2609 including a fourth transparent solid material, the fourth layer 2609 disposed on the opposite side of the first layer 2601 from the second layer 2602; and a third gap 2610 between the first layer 2601 and the fourth layer 1609 configured to allow a third fluid 2611 to selectively flow into and out of the third gap 2610. In this example, the presence of third fluid 2611 in the third gap 2610 is configured to at least one of selectively scatter light, reflect light, or absorb light between the first layer and the second layer, or transfer heat energy based on one or more of convection and conduction of heat in the third fluid 2611. In some embodiments, the first gap 2603 defines a distance of between 5 mm and 50 mm between the first layer 2601 and the second layer 2602; the second gap 2603 defines a distance of between 5 mm and 50 mm between the second layer 2602 and the third layer 2605; the third gap 2610 defines a distance of between 5 mm and 50 mm between the first layer 2601 and the fourth layer 2609. In some embodiments, the presence of the first fluid 2604 in the first gap 2603 is configured to transfer heat energy to one or both of the first layer 2601 and the second layer 2602 based on convection and conduction of heat in the first fluid 2604. In some embodiments, the presence of the second fluid 2608 in the second gap 2607 is configured to transfer heat energy to one or both of the second layer 2602 or the third layer 2605 based on convection and conduction of heat in the second fluid 2608, and presence of the third fluid 2611 in the third gap 2610 is configured to transfer heat energy to one of or both the first layer 2601 or the fourth layer 2609 based on convection and conduction of heat in the third fluid 2610.

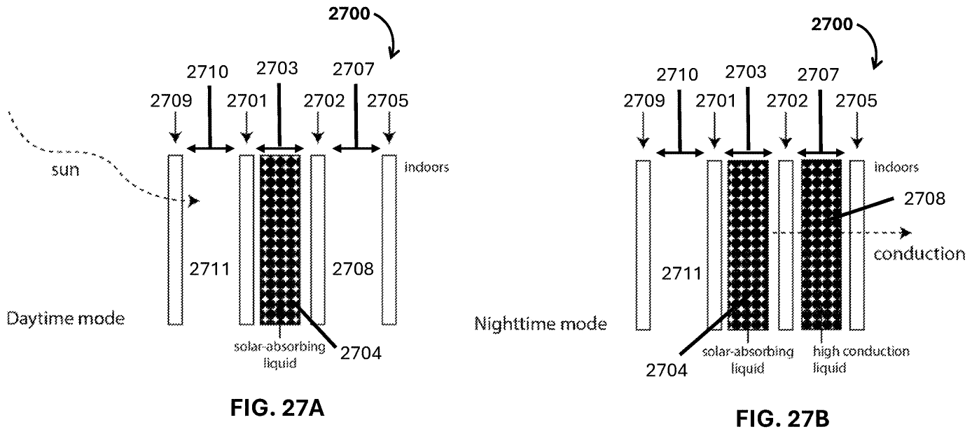

In some embodiments, a system according to FIG. 26 can function as a thermal battery. In some embodiments, a thermal battery is an optimized device design that includes four layers 2701, 2702, 2705, 2709 and three thick liquid gaps 2703, 2707, 2710 as shown in FIG. 27A. In this embodiment, as shown in FIG. 27A, during the day, energy can be stored. In these embodiments, during the day, only the middle gap 2703 is full of a solar absorbing fluid 2704 (e.g., water) to absorb incident light, and the outer gaps 2707, 2710 (one on each side) serve as thermal insulators to trap the heat in the middle layer. In these embodiments, during the day the outer gaps 2707, 2710 are filled with air 2711, 2708. In some embodiments, as shown in FIG. 27B, at night, a thermally conductive fluid 2708 (e.g., water) is injected into the inner gap 2707 to open a thermal bridge to the inside environment along which the stored heat from the central gap can flow. At night, the outer gap 2710 will remain empty (e.g., filled with air 2711) as to deter heat from escaping outward. Various embodiments of this device can exist that include low-emissivity coatings (25 nm/10 nm/25 nm TiO₂/Ag/TiO₂ or 200 nm ITO) on various window surfaces for optimal operation in distinct climates, and liquids of various absorbing particle concentrations in the central or inner gaps to provide control of the relative amount of solar energy that is immediately passed versus stored for later. The solar-absorbing liquid is not limited to water. In some embodiments, the solar-absorbing liquid includes particles suspended to enhance absorption. The high-conduction liquid is not limited to water.

In some embodiments, the intensity, spectrum, direction and/or distribution of a beam of light can be controlled independently while also independently controlling heat transfer by selectively flowing one or more fluids into and out of gaps of a system disclosed herein. Certain embodiments of the present disclosure describe a method of using a system described herein, including selectively flowing the first fluid into and out of the first gap, to at least one of selectively scatter light, reflect light, or absorb light between the first layer and the second layer when the first fluid is present in the first gap; and selectively flowing the second fluid into and out of the second gap to transfer heat energy through the second gap based on convection and conduction of heat in the second fluid when the second fluid is present in the second gap.

In some embodiments, one or more layers of a system disclosed herein can include a scattering surface as described below in the “Fluid Compositions and System Materials” section. In some embodiments, one or more layers of a system disclosed herein can include a transparent coating as described below in the “Fluid Compositions and System Materials” section. In some embodiments, one or more of the layers of a system disclosed herein can take one or more form factors as described below in the “Fluid Compositions and System Materials” section. In some embodiments, a system disclosed herein can include a heat transfer layer as described below in the “Fluid Compositions and System Materials” section.

### 3. Flares: Flowable Adaptive Radiative Energy System

Certain embodiments of the present disclosure describe a system including a first layer including a first transparent solid material; a second layer including a second transparent solid material and a transparent coating, the transparent coating configured to transmit light having a wavelength between 300 nm and 2500 nm and reflect light having wavelength between 2500 nm and 30000 nm; a first gap between the first layer and the second layer configured to allow a first fluid to selectively flow into and out of the first gap, the presence of the first fluid in the first gap configured to be heat emissive and absorb heat energy having a wavelength between 2500 nm and 30000 nm such that the first fluid in the system absorbs heat energy from an environment outside the first layer or emits heat energy from the first fluid into the environment outside the first layer, and absence of the first fluid reduces absorption or emission of heat energy through the first gap due to the transparent coating of the second layer; a third layer comprising a third transparent solid material; and a second gap between the second layer and the third layer configured to allow a second fluid to selectively flow into and out of the second gap, the second gap being on an opposite side of the second layer from the first gap, and the presence of the second fluid in the second gap configured to one or more of selectively scatter, reflect, or absorb light between the second layer and the third layer, or transfer heat energy based on conduction of heat through the second fluid.

In one embodiment, a system is disclosed which is the FLowable Adaptive Radiative Energy System (FLARES). In some embodiments, FLARES represents a building platform capable of independently and simultaneously controlling visible (e.g., 0.2-0.8 μm) and thermal (3-30 μm) radiation. In some embodiments FLARES represents a building platform capable of independently and simultaneously controlling visible (e.g., 300 nm to 700 nm), near-infrared (e.g., 700 nm to 2500 nm), and mid-infrared (also referred to as thermal) (e.g., 3-30 μm) radiation.

In some embodiments, the FLARES system is configured to enable indoor climate control by simultaneous control of visible and thermal radiation or visible, thermal, and near IR radiation. Thermal radiation occurs between an object, for example a building, and “the view” which refers to the nearby surroundings, for example other buildings, a sidewalk, or a body of water. In some embodiments, by incorporating fluids which are heat emissive in a multilayer fluidic window system, for example as in the above disclosed FLUIDS and FLUIDS-H systems, the optical transmission, reflection, and absorption of light can be controlled while also controlling absorption and reflection of thermal radiation from the view.

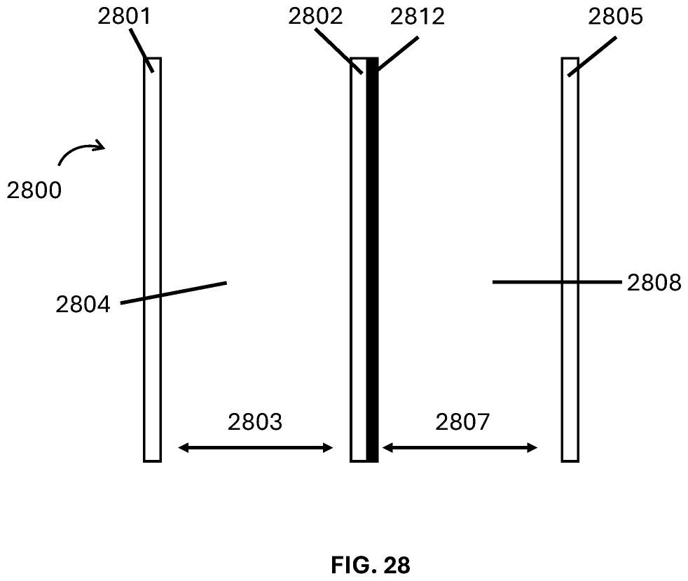

In one embodiment, a system is disclosed, shown in FIG. 28, that includes a first gap 2803 used to dynamically control thermal radiation (e.g., an thermal gap) and a second gap 2807 used to dynamically control transmission of light (e.g., an optical gap). As shown in FIG. 28, the system includes a first layer 2801 including a first transparent solid material; a second layer 2802 including a second transparent solid material and a transparent coating 2812, the transparent coating 2812 configured to transmit light having a wavelength between 300 nm and 700 nm and reflect light having wavelength between 700 nm and 30000 nm. As shown in FIG. 28, in this example, the system includes a first gap 2803 between the first layer 2801 and the second layer 2802 configured to allow a first fluid 2803 to selectively flow into and out of the first gap 2803. In this example, the presence of the first fluid 2803 in the first gap 2803 is configured to be heat emissive and absorb heat energy having a wavelength between 2500 nm and 30000 nm such that the first fluid 2803 in the system absorbs heat energy from an environment outside the first layer 2801, and absence of the first fluid 2803 reduces absorption of heat energy from outside the first layer 2801 due to the transparent coating 2812. In this example, the system also includes a third layer 2805 comprising a third transparent solid material; and a second gap 2807 between the second layer 2802 and the third layer 2805 configured to allow a second fluid 2808 to selectively flow into and out of the second gap 2807, the second gap 2807 being on an opposite side of the second layer 2802 from the first gap 2801, and presence of the second fluid 2808 in the second gap 2807 is configured to one or more of selectively scatter, reflect, or absorb light between the second layer 2802 and the third layer 2805, or transfer heat energy based on conduction of heat through the second fluid 2808.

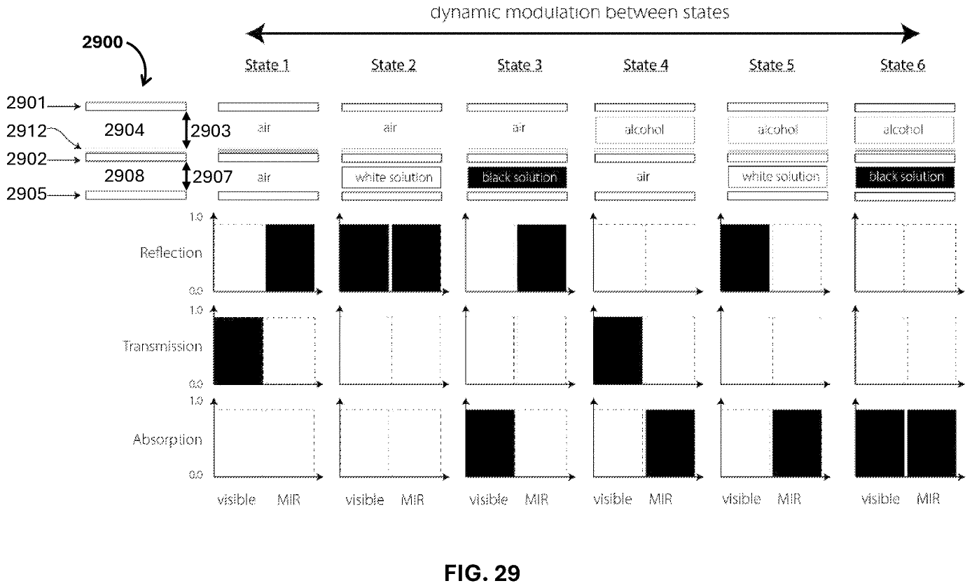

The functionality achieved by an embodiment of FLARES, as described in FIG. 28, is illustrated in FIG. 29 which shows non-limiting exemplary states in which the FLARES system can exist. For example, switching between a heat emissive fluid (e.g., alcohol) (States 4-6) and air (States 1-3) as the first fluid in the first gap enables modulation between thermal absorption/emission and reflection, respectively. Air in the first gap corresponds to absence of the first fluid in the first gap and functions to expose a visibly-transparent but NIR/thermally-reflective transparent coating. Switching between a fluid including a pigment (e.g., black solution, State 3 and State 6), a fluid including suspended particles (e. g, white solution, State 2 and State 5), and air (State 1 and State 4) as the second fluid in the second gap enables modulation between visible absorption/emission, reflection, and transmission, respectively. Importantly, such thermal and visible control knobs can be moved independently, giving rise to combinations of visible and thermal radiation that other devices/materials cannot adaptively access.

FIG. 29 shows a FLARES system that allows at least six configurations. As shown in FIG. 29, the system includes a first gap 2903 disposed between a first layer 2901 and a second layer 2902 that includes a transparent coating 2912, and a second gap 2907 disposed between the second layer 2902 and the third layer 2905. In some embodiments, six different configurations can be accessed by selectively flowing one or more fluids 2904 into and out of the first gap 2904 and selectively flowing one or more fluids 2908 into and out of the second gap 2907.

In some embodiments, referring to the states illustrated in FIG. 29, the FLARES system 2900 specifically allows at least six configurations (permutations): T/W (state 1), W/W (state 2), B/W (state 3), T/B (state 4), W/B (state 5), and B/B (state 6), where T is transparent, W is reflective (white solution), and B is absorptive/emissive (black solution or alcohol), and where the first and second initial refer to the device property in the visible and thermal band, respectively. In this example, the “white solution” indicates a fluid including suspended particles to scatter light, as described below in the “Fluid Compositions and System Materials” section. In this example, the “black solution” indicates a fluid including a carbon black pigment suspended in water, as described below in the “Fluid Compositions and System Materials” section. In some embodiments, the emissive fluid can be alcohol (e.g., IPA or ethanol). In some embodiments, the emissive fluid can be a mineral oil.

The six configurations shown in FIG. 29 are described herein. State 1 in FIG. 29 shows the system when the first fluid and the second fluid are each absent (air). resulting in the system being transparent (T) to visible light and reflective (W) to near-IR light and thermal radiation at the second layer due to the transparent coating. State 2 in FIG. 29 shows the system when the first fluid is absent (air) and the second fluid includes suspended particles to control back scattering (white solution) resulting in the system being reflective (W) to near-IR light and thermal radiation due to the transparent coating and reflective (W) to visible light due to the second fluid. State 3 in FIG. 29 shows the system when the first fluid is absent (air) and the second fluid includes a pigment to control absorption (black solution) resulting in the system being absorptive (B) to visible light due to the second fluid and reflective (W) to near-IR light and thermal radiation due to the transparent coating. State 4 in FIG. 29 shows the system when the first fluid is absorptive to thermal radiation and heat emissive (alcohol) and the second fluid is absent (air) resulting in the system being transparent (T) to visible light and absorptive (B) to thermal radiation due to the first fluid.

State 5 in FIG. 29 shows the system when the first fluid is absorptive to thermal radiation and heat emissive (alcohol) and the second fluid include suspended particles to control back scattering (white solution) resulting in the system being reflective (W) to visible light due to the second fluid and absorptive (B) to thermal radiation due to the first fluid. State 6 in FIG. 29 shows the system when the first fluid is absorptive to thermal radiation and heat emissive (alcohol) and the second fluid includes a pigment to control absorption (black solution) resulting in the system being absorptive (B) to visible light due to the second fluid and absorptive (B) to thermal radiation due to the first fluid.

Considering the states illustrated in FIG. 29, the FLARES system can be configured to match environmental conditions surrounding a building. The following are non-limiting examples of conditions under which a specific system configuration would be used. State 1 is desirable when the in-sight surroundings are hotter than the system, the system is in a cooling mode, and transmission of daylight is desired. State 1 is also desirable when the in-sight surroundings are cooler than the system, the system is in a heating mode, and transmission of daylight is desired. State 2 is desirable when the in-sight surroundings are hotter than the system, the system is in a cooling mode, and transmission of daylight is not desired. State 3 is desirable when the in-sight surroundings are cooler than the system, the system is in a heating mode, and transmission of daylight is not desired. State 4 is desirable when the in-sight surroundings are hotter than the system, the system is in a heating mode, and transmission of daylight is desired. State 4 is also desirable when the in-sight surroundings are cooler than the system, the system is in cooling mode, and transmission of daylight is desired. State 5 is desirable when the in-sight surroundings are cooler than the system, the system is in cooling mode, and transmission of daylight is not desired. State 6 is desirable when the in-sight surroundings are hotter than the system, the system is in a heating mode, and transmission of daylight is not desired.

The exemplary embodiment shown in FIG. 29 includes a second fluid in the second gap (e.g., optical gap) that includes suspended particles that scatter light or a pigment that absorbs light. However, a FLARES system can combine a thermal gap with one or more optical gaps as described in the context of the FLUIDS system to independently control intensity, direction, distribution and/or color of solar radiation. In some embodiments, the direction of scattered light can be controlled by selectively flowing a fluid comprising suspended particles into and out of an optical gap or by changing the concentration of suspended particles in a fluid. In some embodiments, the distribution of light (blurriness) can be controlled by selectively changing the refractive index mismatch between the surface and the fluid, for example by selectively flowing fluids of different refractive indices into and out of an optical gap. In some embodiments, the intensity of light can be controlled by selectively flowing a fluid comprising pigment into or out of an optical gap or by changing the concentration of a pigment in a fluid. In some embodiments, the spectrum of light transmitted can be controlled by selectively flowing a fluid comprising a spectrally selective fluid into and out of an optical gap.

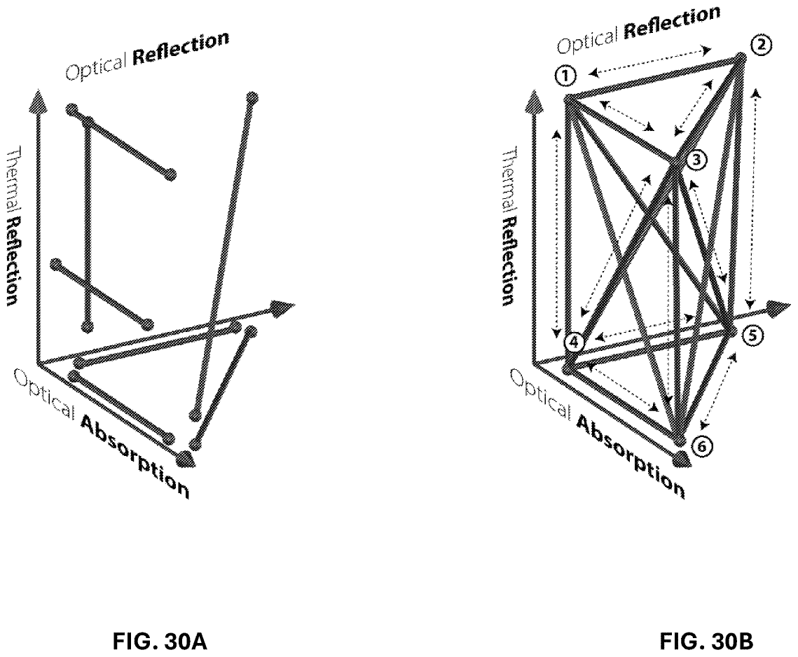

FIGS. 30A-30B shows the phase space of accessible configurations for control of optical and thermal properties in 2-state binary systems (FIG. 30A) as compared to the 6-state FLARES system (FIG. 30B) illustrated in FIGS. 28-29. Indeed, 2-state binary systems, for example, can dynamically switch between states 4-5, as illustrated in FIG. 29, or between states 5-6. However, because no existing technologies have the capacity to dynamically switch between all 6 states, let alone more than 2 of the 6 states, FLARES (FIG. 30B) can achieve enormous energy savings arising from the ability to access all the states that otherwise cannot be accessed when favorable.

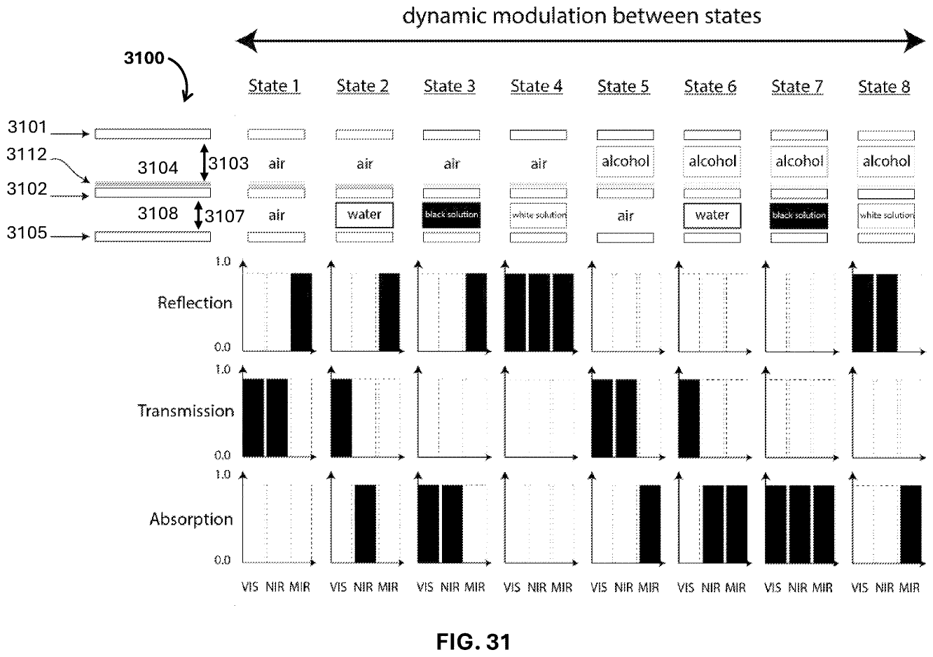

An additional functionality that can be achieved by an embodiment of FLARES, as described in FIG. 28, is illustrated in FIG. 31 which shows non-limiting exemplary states in which the FLARES system can exist. FIG. 31 shows a FLARES system that allows at least eight configurations. As shown in FIG. 31, the system includes a first gap 3103 disposed between a first layer 3101 and a second layer 3102 that includes a transparent coating 3112, and a second gap 3107 disposed between the second layer 3102 and the third layer 3105. In some embodiments, eight different configurations can be accessed by selectively flowing one or more fluids 3104 into and out of the first gap 3104 and selectively flowing one or more fluids 3108 into and out of the second gap 3107.

An embodiment of the FLARES platform, illustrated in FIG. 31, can be accessed through two modifications to the FLARES embodiment illustrated in FIGS. 28-29. By replacing the transparent coating used for the embodiment in FIGS. 28-29 (which is transparent only in the visible band and reflective in the near-infrared and thermal bands) with a transparent coating that is instead transparent across both the visible and near-infrared bands (while remaining reflective in the thermal band), a system can be achieved that enables independent and simultaneous control of visible, near-infrared, and thermal radiation. In this embodiment, a liquid that is transparent to visible light but absorbing to near-infrared light (e.g., pure water or glycerol) is added as an available material to be injected/withdrawn into/from the first gap. In some embodiments, the transparent coating can be made from stacks of dielectrics (ZrO₂/TiO₂) and metal (e.g., Ag) or ITO (200 nm).

Referring to the states illustrated in FIG. 31, the system specifically allows at least eight configurations (permutations): T/T/W (state 1), T/B/W (state 2), B/B/W (state 3), W/W/W (state 4), T/T/B (state 5), T/B/B (state 6), B/B/B (state 7), and W/W/B (state 8), where T is transparent, W is reflective (white solution), and B is absorptive/emissive (black solution), and where the first, second, and third initials refer to the device property in the visible, near-infrared, and long-wave-infrared (thermal) bands, respectively. In this example, the “white solvent” indicates a fluid including suspended particles to scatter light, as described above in the “Fluid Compositions and System Materials” section. In this example the “black solvent” indicates a fluid including a carbon black pigment suspended in water. In some embodiments, the emissive fluid can be alcohol (e.g., IPA or ethanol). In some embodiments, the emissive fluid can be a mineral oil. Various mineral oils may also be used. The coating can include materials such as a metal-oxide/metal stack like 25 nm/10 nm/25 nm TiO2/Ag/TiO2 or 200 nm of indium tin oxide.

The eight configurations shown in FIG. 31 are described herein. State 1 in FIG. 31 shows the system when the first fluid and the second fluid are each absent (air) resulting in the system being transparent (T) to visible light and near-IR light and reflective to thermal radiation due to the transparent coating. State 2 in FIG. 31 shows the system when the first fluid is absent (air) and the second fluid is absorptive to near-IR light (e.g., water) resulting in the system being transparent (T) to visible light, absorptive to near-IR light (B) due to the second fluid and reflective (W) to thermal radiation due to the transparent coating. State 3 in FIG. 31 shows the system when the first fluid is absent (air) and the second fluid includes a pigment to control absorption (e.g., black solution) resulting in the system being absorptive (B) to visible and near-IR light due to the second fluid and reflective (W) to thermal radiation due to the transparent coating. State 4 in FIG. 31 shows the system when the first fluid is absent (air) and the second fluid includes suspended particles (e.g., white solution) resulting in the system being reflective (W) to visible and near-IR light due to the second fluid and reflective (W) to thermal radiation due to the transparent coating. State 5 in FIG. 31 shows the system when the first fluid is absorptive to thermal radiation and heat emissive (e.g., alcohol) and the second fluid is absent (air) resulting in the system being transparent (T) to visible and near-IR light due to the absence of the second fluid and absorptive (B) to thermal radiation due to the first fluid. State 6 in FIG. 31 shows the system when the first fluid is absorptive to thermal radiation and heat emissive (e.g., alcohol) and the second fluid is absorptive to near-IR light (e.g., water) resulting in the system being transparent (T) to visible light, absorptive (B) to near-IR light due to the second fluid, and absorptive (B) to thermal radiation due to the first fluid. State 7 in FIG. 31 shows the system when the first fluid is absorptive to thermal radiation and heat emissive (e.g., alcohol) and the second fluid includes a pigment to control absorption of light (e.g., black solution) resulting in the system being absorptive (B) to visible and near-IR light due to the second fluid and absorptive (B) to thermal radiation due to the first fluid. State 8 in FIG. 31 shows the system when the first fluid is absorptive to thermal radiation and heat emissive (e.g., alcohol) and the second fluid includes suspended particles (e.g., white solution) resulting in the system being reflective (W) to visible and near-IR light due to the second fluid and absorptive (B) to thermal radiation due to the first fluid.

Considering the states illustrated in FIG. 31, the FLARES system can be configured to match specific environmental conditions surrounding a building. The following are non-limiting examples of conditions under which a specific system configuration can be used. State 1 is desirable when the in-sight surroundings are cooler than the system, the system is in heating mode, and transmission of daylight is desired. State 2 is desirable when the in-sight surroundings are hotter than the system, the system is in cooling mode, and transmission of daylight is desired. State 3 is desirable when the in-sight surroundings are cooler than the system, the system is in heating mode, and transmission of daylight is not desired. State 4 is desirable when the in-sight surroundings are hotter than the system, the system is in cooling mode, and transmission of daylight is not desired. State 5 is desirable when the in-sight surroundings are hotter than the system, the system is in heating mode, and transmission of daylight is desired. State 6 is desirable when the in-sight surroundings are cooler than the system, the system is in cooling mode, and transmission of daylight is desired. State 7 is desirable when the in-sight surroundings are hotter than the system, the system is in heating mode, and transmission of daylight is not desired. State 8 is desirable when the in-sight surroundings are cooler than the system, the system is in cooling mode, and transmission of daylight is not desired.

Importantly, the embodiment of FLARES described FIG. 31 enables a platform for independently and simultaneously controlling visible (e.g., 0.2-0.8 μm), near-infrared (e.g., 0.8-2.5 μm), and thermal (e.g., 3-30 μm) radiation. For example, the platform can move freely between reflecting, absorbing, and/or transmitting visible radiation; between absorbing and/or transmitting near-infrared radiation; and between reflecting and/or absorbing thermal radiation by selectively flowing one or more fluids into the gaps of the system. Simplifying the problem space slightly, the accessible functional space that the discosed platform can access along can be mapped three axes: from visible light transmission to extinction; from near-infrared light transmission to extinction; and from long-wave-infrared light reflection to emission.

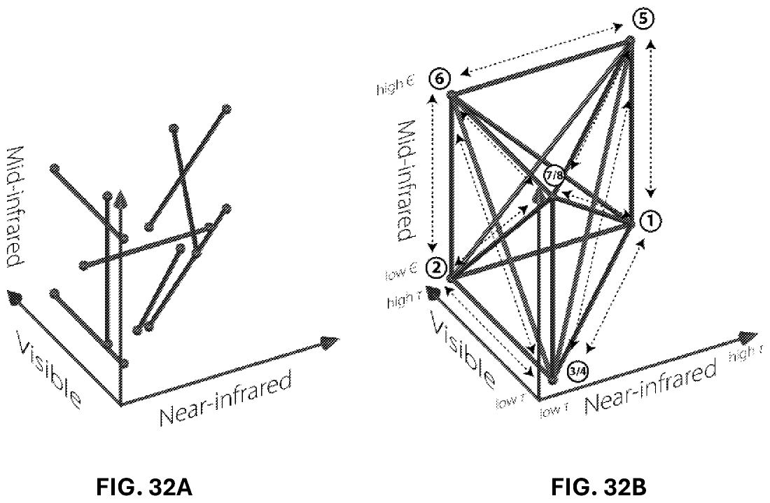

FIGS. 32A-32B provide illustration of the phase space of accessible configurations for control of optical and thermal properties in 2-state binary systems (FIG. 32A) as compared to the 8-state FLARES system illustrated in FIG. 31 (FIG. 32B). As before, 2-state binary systems, for example, can dynamically switch between states 4-7, or between states 5-7 (FIG. 32A). However, because no binary systems have the capacity to dynamically switch between all 8 states, let alone more than 2 of the 8 states, FLARES (FIG. 32B) can achieve enormous energy savings arising from the ability to access all the states that others cannot at times when they are favorable.

In some embodiments, the different near-infrared properties arising from the variance in transparent coating compositions between the first embodiment (FIG. 29) and the second embodiment (FIG. 31) can create variations in thermal performance that can be useful for various climates. In addition, the performance of various radiative states described in the above embodiments can be augmented by adaptively controlling the thermal conduction/convection through the system synergistically with radiation—a type of functionality disclosed in the FLUIDS-H system.

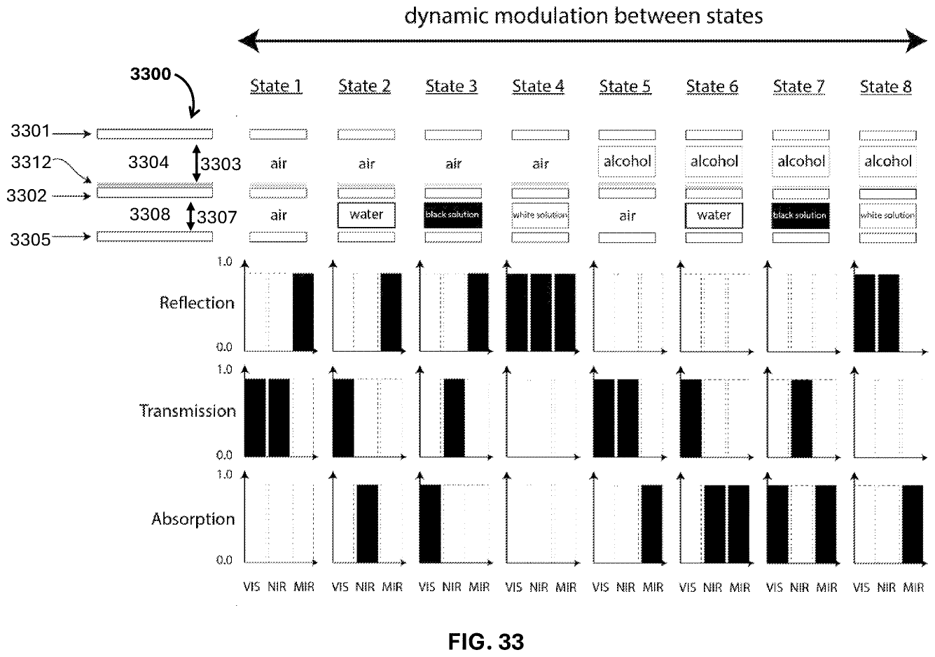

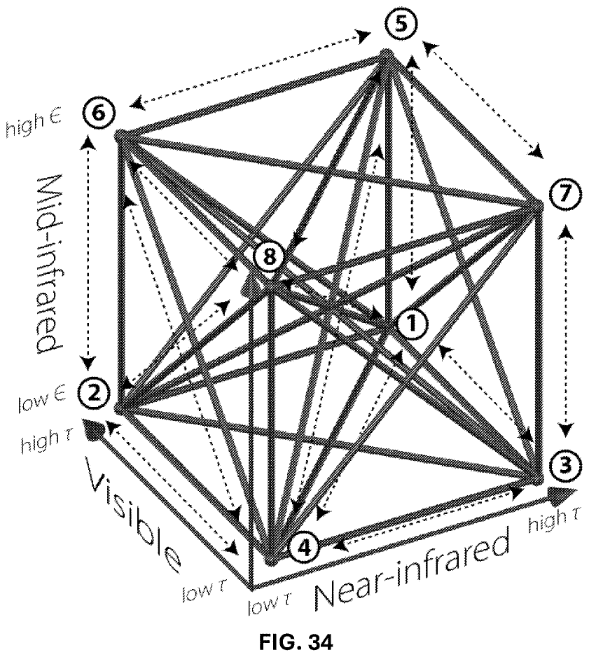

An additional functionality achieved by FLARES, as described in FIG. 28, is illustrated in FIG. 33 which shows non-limiting exemplary states in which the FLARES system can exist. A third embodiment of the FLARES platform, illustrated in FIG. 33, can be accessed through a modification to the FLARES embodiment illustrated in FIG. 31 consisting of using a selectively absorbing fluid that includes other pigments other than a black pigment (e.g., carbon black) in the “black solution” so as to selectively absorb light in the visible light wavelength band which would result in colored light being transmitted through the system.

FIG. 34 provides illustration of the phase space of accessible configurations for control of optical and thermal properties in the 8-state FLARES system illustrated in FIG. 32. By incorporating a fluid that is absorbing in the visible spectrum and is transparent in the NIR for states 3,7, the full phase space can be accessed to orthogonally control all three fundamental bands of radiation, i.e., visible, near-IR, and mid-IR.

In some embodiments, visible, near-IR, and thermal radiation can be independently controlled by selectively flowing one or more fluids into and out of gaps of a system disclosed herein. Certain embodiments of the present disclosure describe a method of using a system described herein, including selectively flowing the first fluid into and out of the first gap, such the first fluid in the system absorbs heat energy from an environment outside the first layer when the first fluid is present, and absorption of heat energy from outside the first layer is reduced when the first fluid is absent; and selectively flowing the second fluid into and out of the second gap to one or more of selectively scatter, reflect, or absorb light between the second layer and the third layer, or transfer heat energy based on conduction of heat through the second fluid when the second fluid is present.

In some embodiments, one or more of the layers of a system disclosed herein can include a scattering surface as described below in the “Fluid Compositions and System Materials” section. In some embodiments, one or more of the layers of a system disclosed herein can include a transparent coating as described below in the “Fluid Compositions and System Materials” section. In some embodiments, one or more of the layers of a system disclosed herein can take one or more form factors as described below in the “Fluid Compositions and System Materials” section. In some embodiments, a system disclosed herein can include a heat transfer layer as described below in the “Fluid Compositions and System Materials” section.

### 4. FLUIDH: Flowable Universal Interface for Directing Heat

Certain embodiments of the present disclosure describe a system including a first layer including a first transparent solid material emissive to light having a wavelength between 2500 nm and 30000 nm; a second layer comprising a second transparent solid material; and a first gap defining a distance of between 5 mm and 50 mm between the first layer and the second layer and configured to allow a first fluid to selectively flow into and out of the first gap, the presence of the first fluid in the first gap configured to transfer heat energy through the first gap based on convection and conduction of heat in the first fluid.

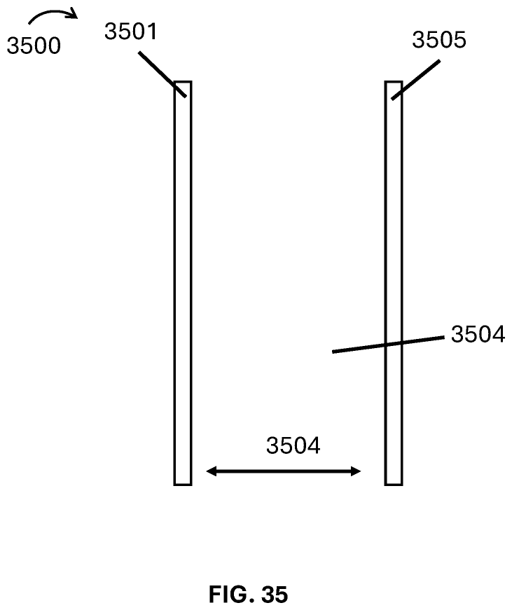

In one embodiment, a system can be constructed, based on the thermal gap of the FLUIDS-H embodiment shown in FIG. 24, that can dynamically control radiative, conductive, and convective heat exchange. In some embodiments, optical control is accomplished using a static layer that acts as a thermal radiator, while thermal control is accomplished dynamically using fluids in a fluid gap (a thermal gap). In some embodiments, such a system includes a transparent window capable of cooperatively toggling radiative, conductive, and convective heat transfer for efficient climate control at the building skin. In one embodiment, FIG. 35 shows a schematic of a system 3500 including a first layer 3501 including a first transparent solid material emissive to light having a wavelength between 2500 nm and 30000 nm; a second layer 3502 including a second transparent solid material; and a first gap 3504 defining a distance of between 5 mm and 50 mm between the first layer 3501 and the second layer 3502 configured to allow a first fluid 3505 to selectively flow into and out of the first gap 3504. In this example, the presence of the first fluid 3505 in the first gap 3504 is configured to transfer heat energy through the second gap based on convection and conduction of heat in the first fluid.

In some embodiments of the system shown in FIG. 35, the first layer is designed as a thermal radiator to ensure maximal energy exchange (emission/absorption) with the surrounding environment in the baseline configuration of the system. In some embodiments, the first gap acts as a “thermal bridge” between the first layer and the second layer and is configured to ensure a maximal difference between thermally insulative and conductive configurations of the system, to open and close access to the thermal radiator's function. In some embodiments, the system also includes an optional heat exchange layer that acts as a heat exchanger allowing for the movement of inward or outward heat between the “thermal bridge,” i.e., the first gap, and the indoor environment, by the selective flow of a heat transfer fluid into and out of a plurality of channels in the heat exchange layer. In this example, the presence of the heat transfer fluid is configured to transfer heat within the system in a direction within a plane of the heat transfer layer. In some embodiments, the second layer includes the heat exchange layer.

In some embodiments, the first layer includes a material which offers both high solar light transparency (e.g., visible and/or near-IR) and high mid-IR emissivity (e.g., a fused silica glass pane). In some embodiments, the first layer reflects solar light (e.g., visible and/or near-IR).

In some embodiments mid-IR emissivity of the first layer can be further enhanced via a structured surface (e.g., by etching repeating cavity micron-scale structures into a glass surface). In some embodiments, a structured surface smoothes the refractive index contrast at the interface with the structured surface to reduce mid-IR reflectivity without impacting interaction of solar light with the first layer. In some embodiments, the structured surface reduces mid-IR reflectivity without impacting visible transparency. In some embodiments, the structured surface reduces mid-IR reflectivity without impacting reflection of visible light. In some embodiment, the structured surface includes a roughened surface, a frosted surface, a patterned surface, a porous surface, an ordered surface, a grated surface, a lens-like surface, a photonic crystal surface, or any combination thereof. In some embodiments, the structured surface comprises structures having feature sizes of feature sizes of about 3 μm to about 1000 μm, about 3 μm to about 50 μm, about 3 μm to about 15 μm, about 8 μm to about 50 μm, or about 8 μm to about 20 μm.

In some embodiments, the first gap is gated by selectively infiltrating the first gap with the first fluid (e.g., water), greatly increasing convection and conduction to transfer heat across the first gap or using the absence of the first fluid to insulate the system by reducing heat transfer across the first gap.

In some embodiment, the first layer includes a transparent coating (e.g., ITO) to minimize radiative heat transfer in the absence of the first fluid and thereby maximize the change in heat transfer between the configurations where the first fluid is present or absent, respectively.

In some embodiments, a system disclosed herein can include a heat transfer layer as described below in the “Fluid Compositions and System Materials” section. In some embodiments, one or more of the layers of a system disclosed herein can include a transparent coating as described below in the “Fluid Compositions and System Materials” section.

In some embodiments of the present disclosure, a system is described. In some embodiments the system includes layers of transparent solid material which include gaps between the layers, the gaps being configured to allow various fluids to be flowed in and out of each respective gap.

In some embodiments of the present disclosure, systems are described which are configured to control light or thermal radiation. In some embodiments, the light controlled by a system can be broadband (all wavelengths), visible, near-infrared (near-IR), mid-infrared (mid-IR), or a combination thereof. Thermal radiation, as used herein, is defined as radiation emitted by the thermal motion of particles in matter, and having a wavelength of between about 2500 nm and 30000 nm. Visible light, as described herein, is defined as light having a wavelength of between about 300 nm and about 700 nm. Near infrared or near-IR light, as described herein is defined as light having a wavelength of between about 700 nm and about 2500 nm. Mid-infrared or mid-IR light, as described herein, is defined as light having a wavelength of between about 2500 nm and about 30000 nm. Sunlight, as described herein, is defined as light or solar radiation having a wavelength of between about 300 nm and about 2500 nm. In some embodiments, systems described herein are absorptive to ultraviolet light. Ultraviolet (UV) light, as described herein, is defined as light having a wavelength of between 10 nm and 300 nm.

In some embodiments, the layers all include the same transparent solid material. In some embodiments, each layer includes a different transparent solid material. Non-limiting examples of transparent solid materials include transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, and combinations thereof.

In some embodiments of the present disclosure, a layer includes a scattering surface which includes some structure configured to scatter light. Non-limiting examples of a scattering surface include roughened surface, a frosted surface, a patterned surface, a porous surface, an ordered surface, a grated surface, a lens-like surface, a photonic crystal surface, a Fresnel surface, and combinations thereof. In some embodiments, any layer in any of the systems described above can include a scattering surface.

In some embodiments, different layer materials can have different refractive indices. In some embodiments, the refractive index of a layer is related to the composition of the layer. In some embodiments, the refractive index of a layer is related to the surface structure of the layer. In some embodiments, the refractive index of a layer can be between 1.0 and 2.0, between 1.2 and 1.8, between 1.3 and 1.7, between 1.3 and 1.5, or between 1.5 and 1.7, or any refractive index bounded by any two values disclosed herein.

In some embodiments of the present disclosure, a layer including a scattering surface can have characteristic values which define the surface roughness of the scattering surface. In some embodiments, the surface roughness is described by the root-mean-squared surface roughness value and/or the mean roughness value. In some embodiments, the root-mean-squared surface roughness is between 0.5 μm and 5 μm, between 1.5 μm and 3.0 μm, between 1.0 μm and 1.5 μm, between 1.5 μm and 2.5 μm, or any root-mean-square surface roughness bounded by any two values disclosed herein. In some embodiments, the mean roughness is between 0.5 μm and 5 μm, between 1.5 μm and 3.0 μm, between 1.0 μm and 1.5 μm, between 1.5 μm and 2.5 μm, or any mean roughness bounded by any two values disclosed herein. In some embodiments, increasing the roughness of a scattering surface can broaden the distribution of light scattered forward by the surface resulting in more diffuse light (blurring) transmission through the system. In some embodiments the refractive index of a scattering surface is related to how the surface scatters light. In some embodiments the refractive index of a scattering surface can be between 1.0 and 2.0, between 1.2 and 1.8, between 1.3 and 1.7, between 1.3 and 1.5, or between 1.5 and 1.7, or any refractive index bounded by any two values disclosed herein.

In some embodiments of the present disclosure, the scattering of light due to a scattering surface, refractive index difference between a fluid and a scattering surface, or suspended particles in a fluid is defined by the proportion of light scattered in the forward direction or the backward direction. Forward scattered light, as described herein, is light scattered at an angle greater than 90 θ and between 90 θ and 270 θ. Backward scattered light, as described herein is light scattered at an angle less than 90 θ or greater than 270 θ, e.g., between 0 θ and 90 θ and between 270 θ and 360 θ. In some embodiments light scattered in the forward direction can be scattered directly leading to a clear or “sharp” transmission of light through the system. Direct forward scattering is characterized by a narrow distribution or dispersion of forward angles at which light is scattered, e.g., between 170 θ and 190 θ. In some embodiments, light scattered in the forward direction can be scattered diffusely leading to a blurred transmission of light through the system, e.g., a range broader than 170 θ to 190 θ. In some embodiments, light is forward scattered directly or diffusely by a system. In some embodiments, light is forward scattered and back scattered by a system. In some embodiments, light is back scattered by a system.

In some embodiments of the present disclosure, a layer includes a transparent coating. In some embodiments, the transparent coating is configured to reflect light in at least one wavelength band. In some embodiments the transparent coating is highly emissive. In some embodiments, the transparent coating has a low emissivity. In some embodiments the transparent coating has a high emissivity and is configured to reflect near-IR light. In some embodiments, the transparent coating includes a metal, a metal oxide, a metal-oxide/metal/metal-oxide sandwich, or a combination thereof. Non-limiting examples of transparent coatings include indium-doped tin oxide (ITO), aluminum-doped zinc oxide (AZO), 200 nm indium tin oxide, 25 nm/10 nm/25 nm TiO₂/Ag/TiO₂, TiO₂, ZrO₂, bismuth oxide, tin oxide, zinc oxide, titanium oxide, silicon oxide, silicon nitride, or combinations thereof. In some embodiments, any layer in any of the systems described above can include a transparent coating.

In some embodiments of the present disclosure, fluids are described which are used to control light within a system. In some embodiments, fluids are stacked in different gaps between layers of materials in a system. In some embodiments, the composition of each fluid is different to achieve a combined function through the system based on the individual characteristics of each fluid. In some embodiments, a fluid composition can include dissolved pigments or suspended particles configured to selectively absorb or scatter light, respectively. In some embodiments, a fluid composition can be selected based on the refractive index of the fluid such that wetting of a surface by the fluid produces an optical effect, for example, blurring due to diffuse forward scattering of light. In some embodiments, a fluid has a high emissivity. In some embodiments a fluid has low emissivity. Non-limiting exemplary fluids include water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, and combinations thereof.

In some embodiments of the present disclosure a fluid can be configured to at least one of selectively scatter, reflect, or absorb light, the light. In some embodiments a fluid is configured to at least one of selectively scatter, reflect, or absorb light having a wavelength of between 300 nm and 30000 nm, between 300 nm and 2500 nm, between 300 nm and 700 nm, between 300 and 400 nm, between 400 and 500 nm, between 500 and 600 nm, between 600 and 700 nm, between 700 nm and 30000 nm, between 700 nm and 2500 nm, and between 2500 nm and 30000 nm or any wavelength bounded by any two values disclosed herein. In a non-limiting example, a fluid can be transparent to visible light (300-700 nm light) but selectively absorb one or more of near-infrared light (near-IR, 700-2500 nm) or mid-infrared light (mid-IR, 2500-30000 nm). In some embodiments, a fluid can be absorptive to ultraviolet light (UV, 10-300 nm light).

In some embodiments of the present disclosure, a fluid can be configured to control the absorption and conduction of thermal radiation based on the emissivity of the fluid. In some embodiments, the fluid is highly emissive which results in absorption and conduction of thermal radiation or heat energy by and through the fluid. In some embodiments, the fluid has low emissivity which results in reflection of thermal radiation and poor conduction of thermal radiation or heat energy by and through the fluid. Non-limiting examples of fluids with high emissivity include water, glycerol, ethanol, isopropanol, ethylene glycol, mineral oil, silicone oil, vegetable oil and combinations thereof. Non-limiting examples of fluids with low emissivity include air, other gaseous fluids, and combinations thereof.

In some embodiments of the present disclosure, a fluid can be selected based on the refractive index difference between the fluid and a layer that is in contact or wetted by the fluid. In some embodiments, a layer includes a scattering surface which is in contact with a fluid. In some embodiments, the refractive index difference between the fluid and the scattering surface produces an optical effect at the scattering surface. In some embodiments, a large refractive index difference blurs light transmitted through the scattering surface by increasing the distribution of light or the range of angles at which the light is scattered through the scattering surface. In some embodiments, a small refractive index difference results in sharp or clear transmission of light through the scattering surface due to a narrow distribution of light or a narrow range of angles at which the light is scattered through the scattering surface. In some embodiments, the refractive index of the second fluid can be between 1 and 1.7, between 1.3 and 1.5, between 1 and 1.3, or between 1 and 1.5 or any value bounded by any two values disclosed herein. In some embodiments the refractive index difference can be between 0 and 0.6, between 0 and 0.5, between 0.2 and 0.5, or between 0.4 and 0.5, or any difference bounded by any two values disclosed herein. Non-limiting exemplary fluids used to control the refractive index difference include isopropanol, index-matching silicone oil, mineral oil, and combinations thereof.

In some embodiments of the present disclosure, a fluid includes a plurality of fluids. In some embodiments, the plurality of fluids is configured to selectively and independently fill any respective gap in a system. In some embodiments, at least one of the plurality of fluids is a cleansing fluid which is immiscible with at least one of the other plurality of fluids. In some embodiments, the cleansing fluid and at least one of the other plurality of fluids are configured to be dynamically exchanged with each other such in a gap in the system such that the cleansing fluid removes the at least one of the other plurality of fluids from the gap. In some embodiments, a hydrophobic cleansing fluid can be used to remove a hydrophilic fluid from the gap. In some embodiments, a hydrophilic cleansing fluid can be used to remove a hydrophobic fluid from the gap. Non-limiting examples of cleansing fluids include mineral oil, silicone oil, vegetable oil, and combinations thereof. A non-limiting example of exchanging fluids includes evacuating one of a plurality of fluids from a gap such that the gap is empty and filled with air and then flowing a second of a plurality of fluids into the gap. A non-limiting example of exchanging fluids includes replacing a first fluid of a plurality of fluids from a gap using a cleansing fluid and then replacing the cleansing fluid with a second fluid of the plurality of fluids.

In some embodiments of the present disclosure, a fluid includes suspended particles. In some embodiments, the suspended particles are configured to selectively scatter light. Non-limiting examples of suspended particles include TiO₂, MgO, BaSO₄, CaCO₃, CaHPO₄, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, and combinations thereof. In some embodiments, the suspended particles include ceramic particles. In some embodiments, the suspended particles include metal oxide particles.

In some embodiments of the present disclosure, the suspended particles have a size in the nm range. In some embodiments, the suspended particles have a size of between 5 nm and 2000 nm, between 5 nm and 1000 nm, between 5 nm and 100 nm, between 10 nm and 50 nm, between 10 nm and 100 nm, between 1000 nm and 2000 nm, between 100 and 500 nm or between 500 nm and 1000 nm, or any diameter bounded by any two values disclosed herein. In some embodiments, the suspended particles have a concentration in the fluid of between 0 mg/mL and 200 mg/mL, between 0 mg/mL and 100 mg/mL, between 0 mg/mL and 64 mg/mL, or between 0 mg/mL and 40 mg/mL, between 0 mg/ml and 4 mg/mL, or between 4 mg/mL and 64 mg/mL, or any concentration bounded by any two values disclosed herein. In some embodiments, one or both of the size and concentration of the suspended particles can be used to control the distribution of angles at which light is scattered by the fluid. In some embodiments a high concentration of particles results in backward scattering of light by the fluid such that the fluid does not transmit or scatter light in the forward direction. In some embodiments, a low concentration of particles results in forward scattering of light through the fluid. In some embodiments, a low concentration of particles results in diffuse forward scattering of light through the fluid. In some embodiments, intermediate concentrations of particles result in a distribution of light scattered in both the forward and backward directions. In some embodiments, suspended particles of a larger size and a lower concentration can result in diffuse forward scattering of light through the fluid. In some embodiments, suspended particles of a large size and a high concentration can result in backward scattering by the fluid. In some embodiments, a system can be configured to dynamically increase or decrease the concentration of suspended particles in a fluid by either adding more suspended particles to the second fluid to increase the concentration of the suspended particles in the fluid or by adding additional fluid that does not include the suspended particles to decrease the concentration of the suspended particles in the fluid.

In some embodiments of the present disclosure, a fluid includes a pigment. In some embodiments, a pigment selectively absorbs light. In some embodiments, a pigment selectively absorbs light having a wavelength in one or more of the wavelength bands described above, e.g., visible, near-IR, mid-IR, or a combination thereof. In some embodiments, a pigment has a concentration in a fluid of between 0 mg/mL and 200 mg/mL, between 0 mg/mL and 100 mg/mL, between 0 mg/mL and 10 mg/mL, between 0 mg/mL and 2 mg/mL, between 100 mg/mL and 200 mg/mL, between 50 mg/mL and 100 mg/mL, between 10 mg/mL and 50 mg/mL, between 2 mg/mL and 10 mg/mL, between 0.5 mg/mL and 10 mg/mL, 0 mg/mL and 0.5 mg/mL, between 0 mg/mL and 0.25 mg/mL, between 0.25mg/mL and 0.5 mg/mL, between 0 mg/mL and 0.125 mg/mL, between 0.125 mg/mL and 0.25 mg/mL, or between 0.125 mg/mL and 0.5 mg/mL, or any concentration bounded by any two values disclosed herein. In some embodiments, increasing the concentration of a pigment decreases the intensity of light which is transmitted through the system in the wavelength band absorbed by the pigment. In some embodiments, decreasing the concentration of a pigment increases the intensity of light which is transmitted through the system in the wavelength band absorbed by the pigment. In some embodiments, the energy in the form of light absorbed by the pigment is transferred through the fluid as heat energy.

In some embodiments, the fluid in which the pigment is suspended or dissolved includes water, isopropanol, ethanol, silicone oil, mineral oil, or combinations thereof. Non-limiting examples of a pigment include carbon black, sudan blue, brilliant blue FCF, unisol blue, indigo carmine, sudan yellow, yellow 5, hansa yellow, titanium dioxide white, zinc oxide white, paliogen black, and chromium iron oxide black, barium, apatite, beryl, bismuth, calcite, cement, chalk, coal, clay, coke, glass, plastic, stone, mineral, rubber, organic compounds or polymers, or combinations thereof.

In some embodiments of the present disclosure, a gap between any two layers can be configured to define a distance between the two layers. In some embodiments, a distance defined by a gap between two layers can be between 0.1 mm and 50 mm, between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm, between 1 mm and 50 mm, between 1 mm and 20 mm, between 1 mm and 5 mm, between 5 mm and 50 mm, between 5 mm and 20 mm, between 20 mm and 50 mm, between 5 mm and 12 mm, between 5 mm and 8 mm, between 8 mm and 50 mm, between 8 mm and 20 mm, or any distance bounded by any two values disclosed herein. In some embodiments, the distance defined by the gap can aid the function of the fluid flowing into and out of the gap. In some embodiments, the distance defined by the gap can control what type of heat exchange can occur. In some embodiments, a gap distance of less than 5 mm does not allow enough space for convection to occur. In some embodiments, a gap distance of less than 5 mm does not allow insulation in the absence of a thermally conductive fluid. In some embodiments, a gap distance of greater than at least 5 mm provides a distance sufficient to facilitate convective heat exchange when a thermally conductive fluid is present. In some embodiments, a gap distance of greater than at least 5 mm is sufficient to insulate the system, e.g., reduce conductive or convective heat exchange, in the absence of a thermally conductive fluid. In some some embodiments, a gap distance of greater than at least 8 mm provides a distance sufficient to facilitate convective heat exchange when a thermally conductive fluid is present. In some embodiments, a gap distance of greater than at least 8 mm is sufficient to insulate the system, e.g., reduce conductive or convective heat exchange, in the absence of a thermally conductive fluid.

In some embodiments of the present disclosure, a system includes a plurality of reservoirs, each independently containing one or more fluids. In some embodiments, each reservoir is independently connected to one or more of the gaps present in a system, and each reservoir is configured to dynamically flow fluid into and out of any gap to which it is connected.

In any embodiments of the present disclosure, a system can take one or more form factors. In some embodiments, a system can be a flexible device that can be rolled down like a blind on the interior or exterior of an existing window. In some embodiments, a system can be a rigid or flexible shade that can be deployed periodically on the interior or exterior of an existing window. In some embodiments, a system can be a light-shelf on the exterior of a window or building. In some embodiments, a system can be a pull-down blind to cover a window. In some embodiments, a system can be a sunroof.

In some embodiments of the present disclosure, any system described herein can include a heat exchange layer configured to transfer heat from the system to the indoor environment. In some embodiments, the heat exchange layer can include a plurality of channels configured to selectively flow a heat transfer fluid into and out of the channels, wherein presence of the heat transfer fluid is configured to transfer heat within the system in a direction within a plane of the heat exchange layer. In some embodiments, the plurality of channels can have dimensions of between 3 μm and 1 cm in width, and between 3 μm and 5 mm in depth or any width bounded by any two values disclosed herein. In some embodiments, the heat exchange layer can comprise epoxy, glass, fused silica, polydimethylsiloxane, and combinations thereof.

In some embodiments of the present disclosure, any component (e.g., layer, gap, fluid, scattering surface, transparent coating, etc . . . ) of a system described above can be adapted to any other system described above. In some embodiments, any two layers, and the gap defined between those two layers, of a system described above can be adapted as a stand-alone system that does not include any additional layers, gaps, or fluids. In some embodiments, the layers, scattering surfaces, fluids, transparent coatings, and transparent solid materials of any system described herein can be disposed in other orders or positions within the system to meet a certain light-control function. In some embodiments, any system described herein can have additional layers added to it such that the additional layers define additional gaps configured to allow additional fluids to be flowed in and out of the additional gaps.

### EXAMPLES

Certain embodiments will now be described in the following non-limiting examples.

### Example 1

A system was constructed according to some embodiments illustrated in FIG. 22A. In the experimental system, each of the first, second, and fourth layers are comprising glass, while the third layer including the scattering surface was frosted polydimethylsiloxane. The first fluid in the first gap was glycerol, the second fluid in the second gap is isopropanol, and the third fluid in the third gap was 0.25 mg/mL carbon black in water. The refractive index difference between isopropanol and the frosted PDMS surface was ~0.05.

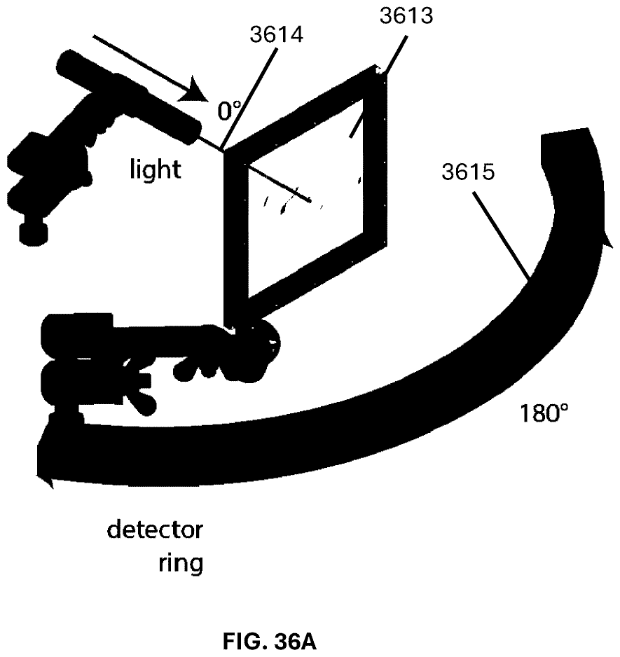

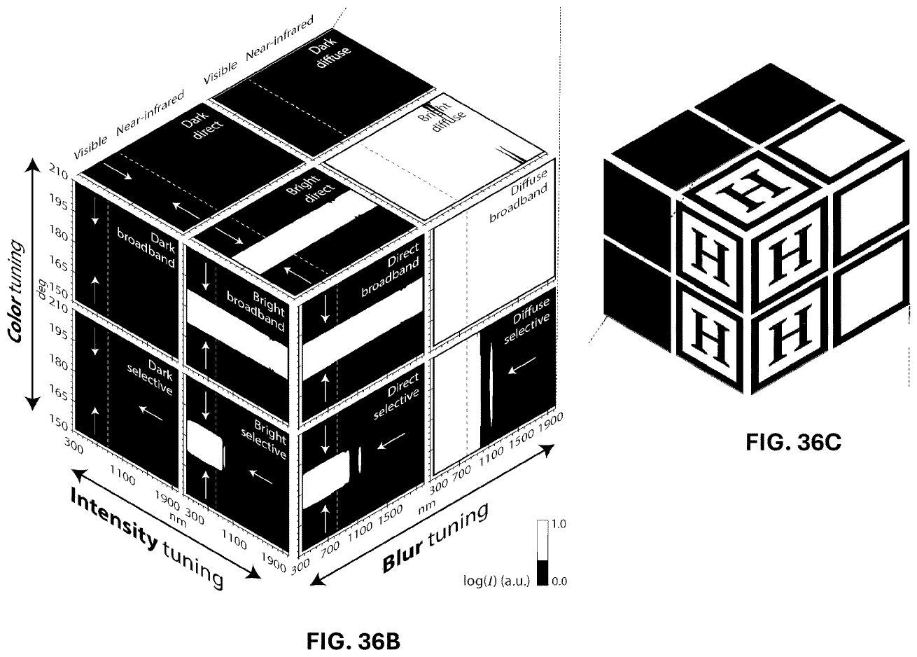

FIGS. 36A-36C show images of the experimental setup and plots collected from the above-described system. FIG. 36A shows an experimental setup for data collection using the system. Visible/NIR light spectrophotometry was performed using a Cary 7000 and Universal Measurement Accessory (UMA). The window (3613) was oriented normally to an incident beam of light 3614, calibrated against air. Transmitted and reflected light intensity was measured across various angles for each wavelength in the visible and NIR spectrum (200-2500 nm) by the detector ring 3615. FIG. 36B shows a three-dimensional representation of plots of the angle of light distributed through the system (y-axis) across visible and near-IR wavelength bands (x-axis) FIG. 36C shows images of the system corresponding to the plots in the three-dimensional representation in FIG. 36B, left.

Each panel in FIG. 36B is a plot of the angle (y-axis, 150-210 θ) and wavelength (x-axis, 300-2000 nm). Darkened regions of each plot show where there is no or reduced transmittance through the system and light regions of each plot show where light is transmitted through the system. The top row along the “Color tuning” axis shows plots collected when the first fluid is not present in the first gap and the gap is filled with air resulting in broadband transmission of light through the system indicated by equal shading of the plots at all wavelengths shown. The bottom row along the “Color tuning” axis shows plots collected when the first fluid is present in the first gap resulting in absorbance of near-IR light from ~900-200 nm and transmission of visible and near-IR light from ~300-900 nm indicated by the darkened and lighter regions, respectively, along the x-axis of each plot. The left column along the “Blur tuning” axis shows plots collected when isopropanol is present in the second gap resulting in a narrow distribution (170-190 θ) of light transmitted through the system indicated by the narrowed lighter horizontal band. The right column along the “Blur tuning” axis shows plots collected when the second fluid is not present in the second gap and the gap is filled with air resulting in diffuse forward scattering of light by the frosted PDMS surface as indicated by equal shading of the plots at all forward scattering angles shown. The right column along the “Intensity tuning” axis shows the system when the third fluid is not present in the third gap and the third gap is filled with air resulting in transmission of all wavelengths of light not influenced by other fluids (e.g., the bottom right panel does not show broadband transmission because presence of the first fluid in the system absorbs near-IR light). The left column along the “Intensity tuning” axis shows the system when the third fluid is present in the third gap resulting in broadband absorbance of all wavelengths of light shown indicated by a dark plot. Taken together, these plots demonstrate the capability of the system to control light transmission independently in three dimensions: near-IR absorption (color), distribution of forward scattering (blur), and broadband absorption/shading (intensity). FIG. 36C shows images, corresponding to the analogous panel in FIG. 36B, taken through the system showing the light transmitted through the system in each configuration.

### Example 2

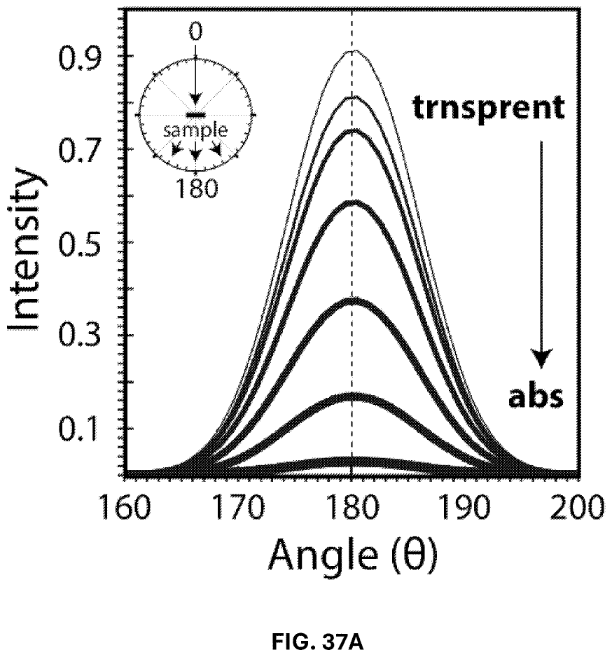

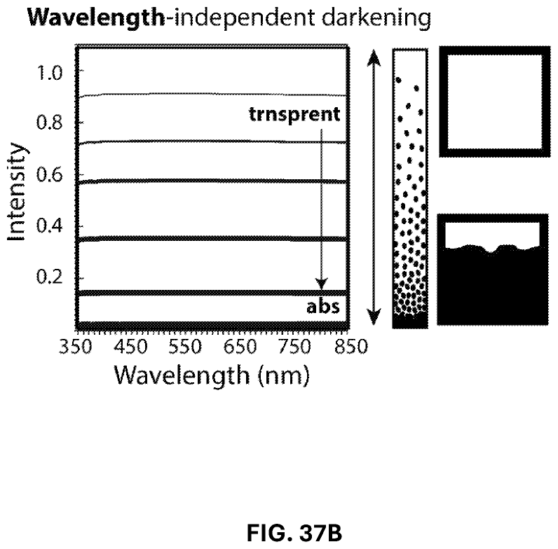

FIGS. 37A-37B illustrate an exemplary system including a first layer and a second layer comprising glass to demonstrate intensity tuning independent of scattering angle FIG. 37A and visible wavelength FIG. 37B. In this example, a fluid comprising carbon black suspended in water was used to fill the 1 mm gap between the first layer and the second layer. The concentrations of carbon black in water used were 0 mg/mL, 0.015625 mg/mL, 0.03125 mg/mL, 0.0625 mg/mL, 0.125 mg/mL, 0.25 mg/mL, and 0.5 mg/mL. FIG. 37A illustrates the angle of transmitted light through the system which does not change with increasing concentration as represented by lines of increasing thickness (concentrations correspond to those listed above from 0 mg/mL to 0.25 mg/mL). FIG. 37B illustrates the wavelength independence of the absorbance of transmitted light through the system and shows that light is absorbed equally across all wavelengths with increasing concentration as represented by lines of increasing thickness (concentrations correspond to those listed above from 0 mg/mL to 0.5 mg/mL). This example demonstrates that a fluid that includes a pigment can be used to independently tune the intensity or shading of light without affecting the scattering angle of light transmitted through a system.

### Example 3

Two experimental systems were constructed according to some embodiments illustrated in FIG. 22A. In each experimental system, each of the first, second, and fourth layers was glass, while the third layer including the scattering surface was frosted polydimethylsiloxane of differing roughness. Light intensity was measured through the system with different configurations of isopropyl alcohol or mineral oil independently present or absent in each gap.

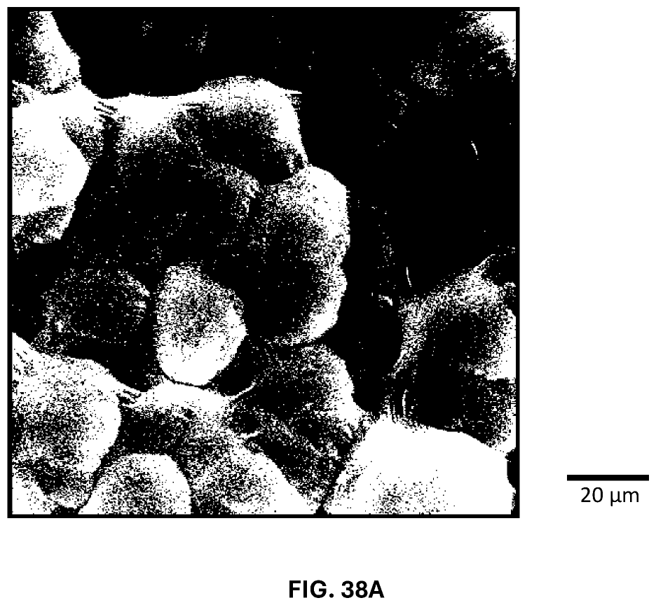

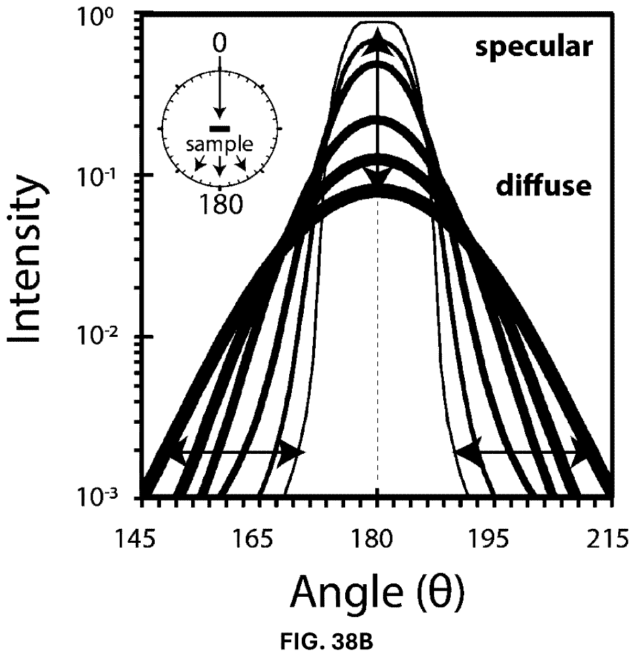

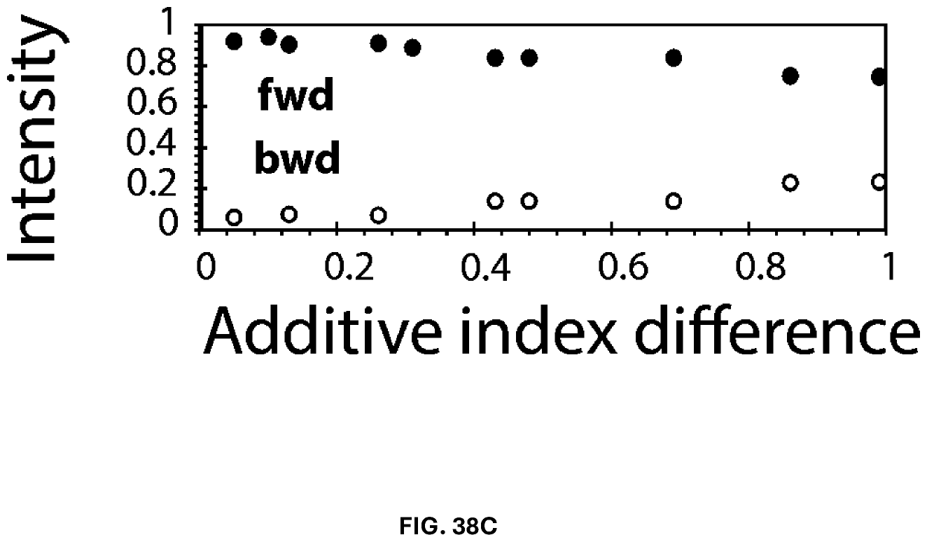

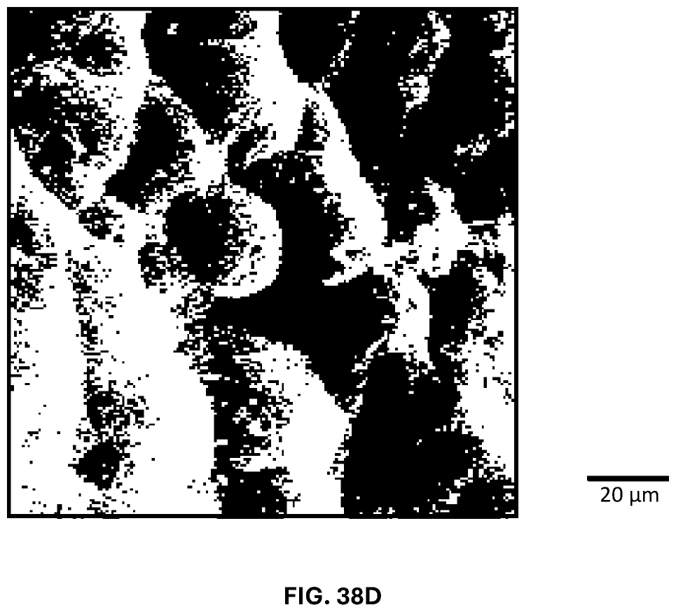

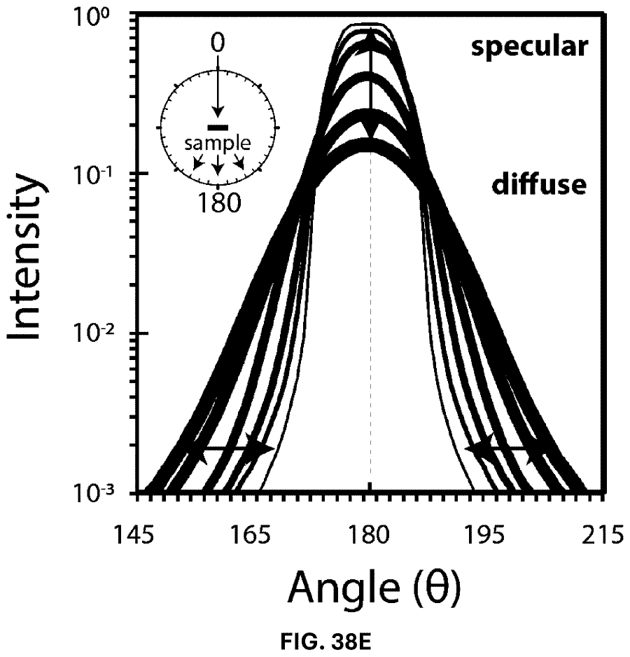

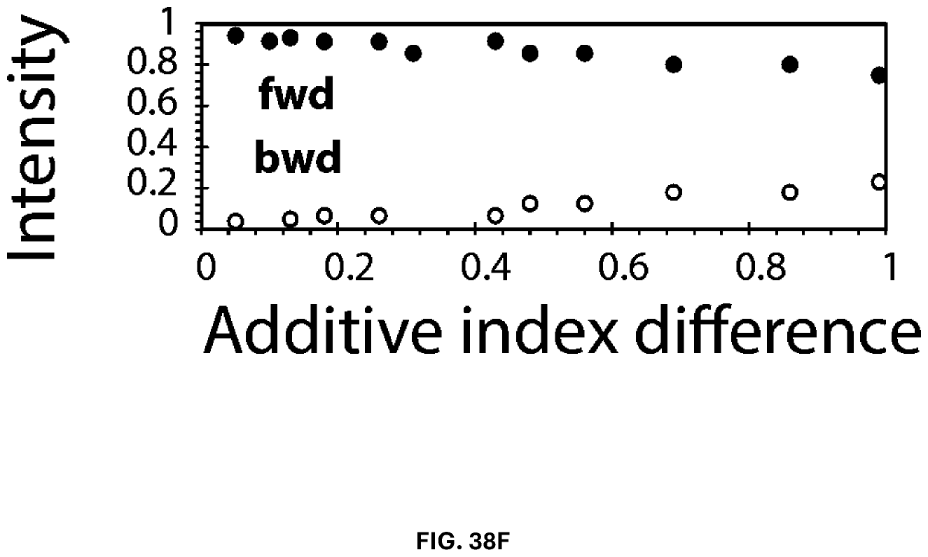

FIGS. 38A-38F provide images and plots illustrating the experimental data from two exemplary systems constructed as described above with each system comprising a scattering surface with a different surface roughness. FIGS. 38A-38C show the first system. FIG. 38A shows a scanning electron microscope (SEM) image (the scale bar is 20 μm) of the frosted PDMS surface which has a root-mean-squared roughness value of 2.34 μm and a mean roughness value of 1.83 μm. FIG. 38B shows a plot of the intensity of light transmitted through the system as it relates to the angle of light distributed by the system for the following combinations of fluids corresponding to lines of increasing thickness: (1) all three fluids are isopropyl alcohol; (2) the first fluid and third fluids are isopropyl alcohol and the second fluid is mineral oil; (3) all three fluids are mineral oil; (4) the first fluid is mineral oil, the second fluid is absent (air), and the third fluid is isopropyl alcohol; (5) the first and second fluids are absent (air) and the third fluid is isopropyl alcohol; and (6) all three fluids are absent (air). FIG. 38C shows a plot of the intensity of light transmitted in the forward (fwd) or backward (bwd) directions as a function of the additive index difference of the refractive indices of each fluid and the scattering surface for the combinations of fluid listed for FIG. 38B in addition to other combinations of air, isopropyl alcohol, and mineral oil within the first gap, second gap, and third gap, including, 1) where the first fluid and second fluid are both mineral oil and the third fluid is absent (air); 2) the first fluid and the third fluid are absent (air) and the third fluid is mineral oil; 3) the first fluid and the third fluid are absent (air) and the third fluid is isopropyl alcohol; 4) the first fluid and the second fluid are isopropyl alcohol and the third fluid is absent (air); and 5) the first fluid and the third fluid are mineral oil and the second fluid is isopropyl alcohol. FIGS. 38D-F show the second system. FIG. 38D shows a scanning electron microscope (SEM) image (the scale bar is 20 μm) of the frosted PDMS surface which has a root-mean-squared roughness value of 1.36 μm and a mean roughness value of 1.07 μm. FIG. 38E shows a plot of the intensity of light transmitted through the system as it relates to the angle of light distributed by the system for the following combinations of fluids corresponding to lines of increasing thickness: all three fluids are isopropyl alcohol; the first fluid and third fluids are isopropyl alcohol and the second fluid is mineral oil; all three fluids are mineral oil, the first fluid is mineral oil, the second fluid is absent (air), and the third fluid is isopropyl alcohol; the first and second fluids are absent (air) and the third fluid is isopropyl alcohol; and all three fluids are absent (air). FIG. 38F shows a plot of the intensity of light transmitted in the forward (fwd) or backward (bwd) directions as a function of the additive index difference of the refractive indices of each fluid and the scattering surface for the combinations of fluid listed for FIG. 38E. The examples shown in FIGS. 38A-38F demonstrate that the refractive index difference between a fluid and a scattering surface can be used to independently tune the distribution of forward scattered light that is transmitted through a system without significantly affecting the intensity. The examples shown in FIGS. 38A-38F also show that increasing roughness of a surface can increase diffuseness of lighted transmitted through the system.

### Example 4

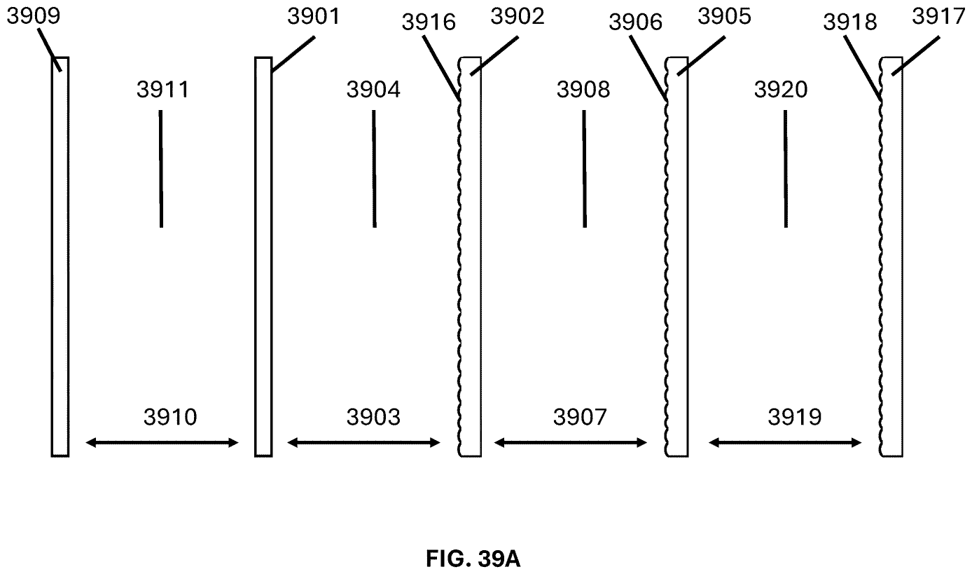

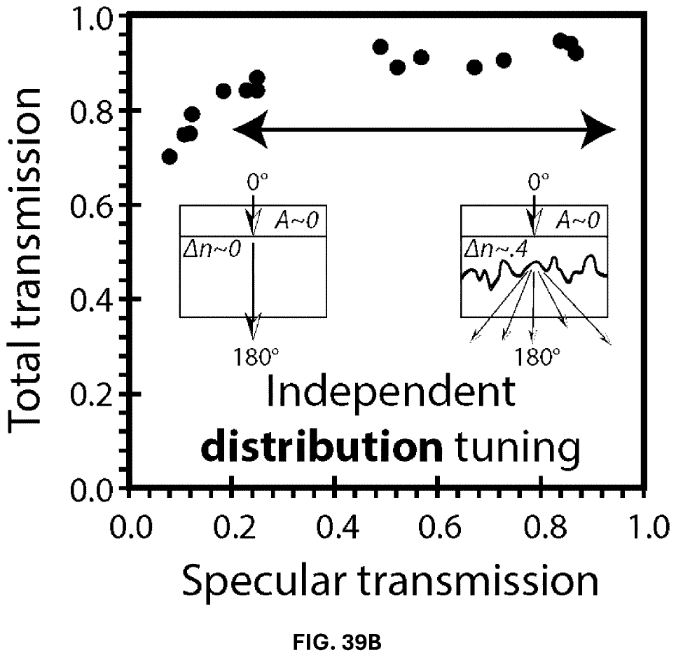

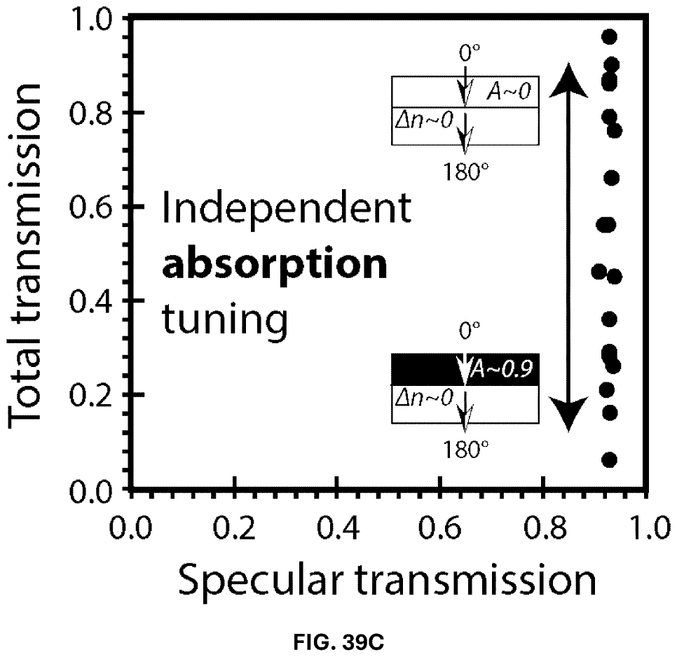

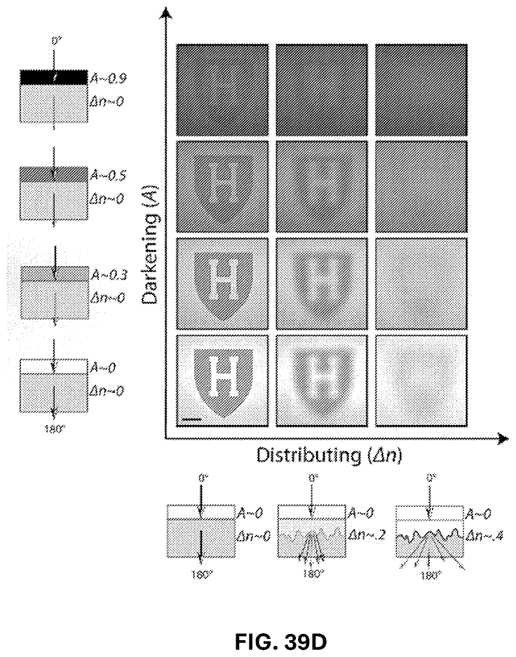

A system was constructed as shown in FIG. 39A including five layers (3901, 3902, 3905, 3909, 3917) with the last three layers including a scattering surface of frosted PDMS (3906, 3916, 3918), and four gaps (3903, 3907, 3910, 3919) where the third gap (3910) was configured such that a third fluid 3911 can be selectively flowed into and out of the gap. The third fluid as used in the system was carbon black pigment in water at a concentration of between 0 mg/mL (pure water) and 0.5 mg/mL. The first, second, and fourth fluids (3904, 3908, 3920) were each independently absent (air), mineral oil, or isopropyl alcohol.

FIGS. 39B-39C show plots of total transmission through the system related to specular transmission through the system. FIG. 39B shows a plot of the total transmission as a function of specular transmission the system when the first fluid was water and the remaining fluids were each independently absent (air), mineral oil, or isopropyl alcohol in different combinations, for example, the second fluid is mineral oil, the third fluid is isopropyl alcohol, and the fourth fluid is isopropyl alcohol. Each fluid results in a different refractive index mismatch with the scattering surface. As shown by FIG. 39B, the specular transmission can be changed independent of changes in the total transmission of light through the system by changing the refractive index mismatch. FIG. 39C shows a plot of the total transmission as a function of specular transmission from the system when the first fluid was carbon black in water at a concentration between 0 mg/mL and 0.5 mg/mL and the remaining fluids were each isopropyl alcohol. As shown by FIG. 39C, the total transmission can be changed independent of changes in the specular transmission of light through the system by changing the concentration of the pigment. FIG. 39D shows images and illustrations of simultaneously and independently tuning the darkening of light transmitted through the system (by changing the concentration of pigment) and the distribution of light through the system (by changing the refractive index mismatch). This example demonstrates that different fluids within different gaps in a multilayer system can independently control different aspects (darkening, distribution) of light through the system to achieve different combined states of light transmission through the system.

### Example 5

A system was constructed according to the system illustrated in FIG. 23A. In the experimental system, each of the first, second, and fourth layers were glass, while the third layer including the scattering surface comprises frosted polydimethylsiloxane. The first fluid in the first gap is carbon black in water at a concentration of between 0.0625 mg/mL and 0.5 mg/mL, the second fluid in the second gap is a scattering fluid with P25 titanium dioxide particles in water at concentrations between 4 mg/mL and 64 mg/mL, and the third fluid is a red, green, or blue pigment in water. The fluids are configured in the system in different states to achieve different functions.

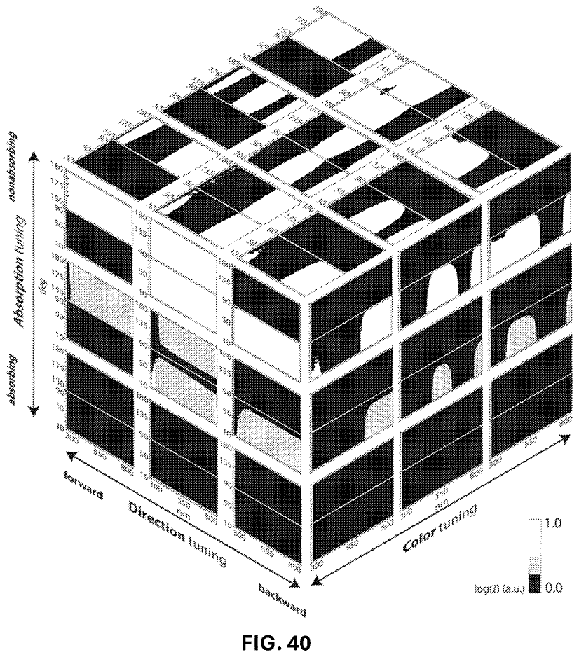

FIG. 40 shows plots collected from the above-described system. FIG. 36A shows the experimental setup for data collection using the system. Visible/NIR light spectrophotometry was performed using a Cary 7000 and Universal Measurement Accessory (UMA). The window (3613) was oriented normally to an incident beam of light (3614), calibrated against air. Transmitted and reflected light intensity was measured across various angles for each wavelength in the visible and NIR spectrum (200-2500 nm) by the detector ring (3615). FIG. 40 provides a three-dimensional representation of plots of the angle of light distributed through the system (y-axis of each panel) across visible and near-IR wavelength bands (x-axis of each panel) to demonstrate the control of shading (Absorption), color, and direction of light. All plots in the left column on the color axis show the system when the third fluid is a red pigment in water, all plots in the center column on the color axis show the system when the third fluid is a green pigment in water, and all plots in the right column on the color axis show the system when the third fluid is a blue pigment in water. The changing patterns of wavelengths absorbed by each pigment can be seen in the regions of the plot which are darkened, corresponding to absorbance, and those which are lighter, corresponding to light transmitted through the system. All plots in the right column on the direction axis show the system when the second fluid is absent, i.e., the second gap is filled with air, all plots in the center column on the direction axis show the system when the second fluid is 4 mg/mL of P25 titanium dioxide particles in water, and all plots in the left column on the direction axis show the system when the second fluid is 64 mg/mL titanium dioxide particles in water. The direction control of light transmitted through the system can be seen as the scattering distribution of light changes from all forward (left column, lighter top panel), to equal distribution in both directions (center column, both panels with equal shading), to all backward scattering (right column, lighter bottom panel). All plots on the top row of the absorption axis show the system when the first fluid is absent, i.e., the first fluid gap is filled with air, all plots in the center row of the absorption axis show the system when the first fluid is 0.0625 mg/mL of carbon black in water, all plots in the bottom row of the absorption axis show the system when the first fluid is 0.5 mg/mL of carbon black in water. The broadband absorption/shading control of light transmitted through the system can be seen as the darkening of light changes through the system from no absorption (top row, light panels across all wavelengths), to shaded (center row, shaded panels across all wavelengths), to total absorption (bottom row, all panels darkened). This example demonstrates the simultaneous, independent control of light transmitted through a single system in three dimensions, e.g., color, scattering direction, and darkening shading, using different fluids flowed selectively into and out of separate gaps within the system.

### Example 6

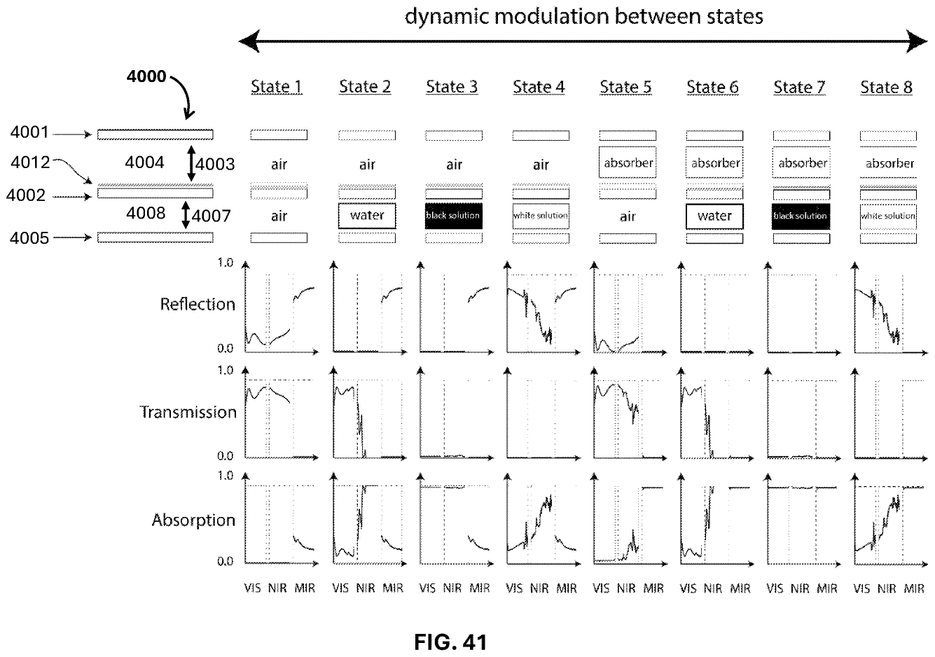

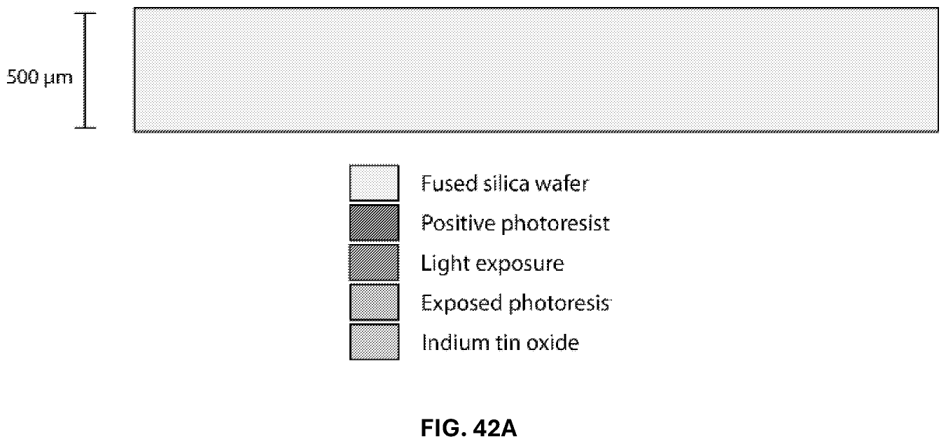

A system was constructed according to the FLARES embodiment illustrated in FIG. 31. As shown in FIG. 41, the first layer 4101, was transparent polyethylene, the second layer 4102 and third layer 4105 were each glass, and the transparent coating was 200 nm ITO. The first fluid 4104 in the first gap 4103 was isopropyl alcohol and the second fluid 4108 in the second gap 4107 was either water, 0.5 mg/mL carbon black in water, or 64 mg/mL P25 titanium dioxide in isopropyl alcohol.

Measurements in the visible and NIR spectrum were taken with a universal measurement accessory and integrating sphere on a UV-VIS-NIR spectrophotometer.

Measurements in the MIR spectrum were taken with a reflection accessory and integrating sphere on a FTIR spectrophotometer. The spectra shown under each state in FIG. 41 correspond to the absorption (bottom), transmission (middle), and reflection (top) spectra measured through the system for each state across the wavelength bands described.

As shown in FIG. 41, at least eight states of light control can be achieved with the system 4100.

State 1 in FIG. 41 shows the system when the first fluid and the second fluid are each absent (air) resulting in the system being transparent to visible light and near-IR light and reflective to mid-IR thermal radiation due to the transparent coating. For State 1 the reflection spectrum shows minimal reflection in the visible and near-IR regions, and strong reflection in the MIR region; while the transmission spectrum shows strong transmission in the visible and near IR regions, and no transmission in the mid IR region; and the absorption spectrum shows no absorption in the visible and near-IR regions, and minimal absorption in the mid-IR region.

State 2 in FIG. 41 shows the system when the first fluid is absent (air) and the second fluid is water which is absorptive to near-IR light resulting in the system being transparent to visible light, absorptive to near-IR light and reflective to mid-IR thermal radiation due to the transparent coating. For State 2 the reflection spectrum shows no reflection in the visible and near-IR regions, and strong reflection in the MIR region; while the transmission spectrum shows strong transmission in the visible region, minimal transmission in the near-IR region, and no transmission in the mid IR region; and the absorption spectrum shows minimal absorption in the visible region, strong absorption in the near-IR region, and minimal absorption in the mid-IR region.

State 3 in FIG. 41 shows the system when the first fluid is absent (air) and the second fluid is 0.5 mg/mL carbon black in water to control absorption (i.e., black solution) resulting in the system being absorptive to visible and near-IR light and reflective to mid-IR thermal radiation due to the transparent coating. For State 3 the reflection spectrum shows no reflection in the visible and near-IR regions, and strong reflection in the MIR region; while the transmission spectrum shows no transmission in any region; and the absorption spectrum shows strong absorption in the visible and near-IR regions, and minimal absorption in the mid-IR region.

State 4 in FIG. 41 shows the system when the first fluid is absent (air) and the second fluid is 64 mg/mL P25 titanium dioxide in isopropyl alcohol (e.g., white solution) resulting in the system being reflective (backward scattering) to visible and near-IR light due to the second fluid and reflective to mid-IR thermal radiation due to the transparent coating. For State 4 the reflection spectrum shows strong reflection in the visible region, moderate reflection in the near-IR region, and strong reflection in the MIR region; while the transmission spectrum shows no transmission in any region; and the absorption spectrum shows minimal absorption in the visible region, moderate absorption in the near-IR region, and minimal absorption in the mid-IR region.

State 5 in FIG. 41 shows the system when the first fluid is isopropyl alcohol (i.e., absorber in FIG. 41) which is absorptive to thermal radiation and heat emissive and the second fluid is absent (air) resulting in the system being transparent to visible and near-IR light due to the absence of the second fluid and absorptive to thermal radiation due to the first fluid. For State 5 the reflection spectrum shows minimal reflection in the visible and near-IR regions, and no reflection in the MIR region; while the transmission spectrum shows strong transmission in the visible and near-IR regions, and no transmission in the mid-IR region; and the absorption spectrum shows no absorption in the visible region, minimal absorption in the near-IR region, and strong absorption in the mid-IR region.

State 6 in FIG. 41 shows the system when the first fluid is isopropyl alcohol (i.e., absorber) which is absorptive to thermal radiation and heat emissive and the second fluid is absorptive to near-IR light (i.e., water) resulting in the system being transparent to visible light, absorptive to near-IR light due to the second fluid, and absorptive to thermal radiation due to the first fluid. For State 6 the reflection spectrum shows no reflection in any region; while the transmission spectrum shows strong transmission in the visible region, minimal transmission in the near-IR region, and no transmission in the mid-IR region; and the absorption spectrum shows minimal absorption in the visible region, and strong absorption in the near-IR and mid-IR regions.

State 7 in FIG. 41 shows the system when the first fluid is isopropyl alcohol (i.e., absorber) which is absorptive to thermal radiation and heat emissive and the second fluid is 0.5 mg/mL carbon black in water (i.e., black solution) to control absorption of light resulting in the system being absorptive to visible and near-IR light due to the second fluid and absorptive to thermal radiation due to the first fluid. For State 7 the reflection spectrum shows no reflection in any region; the transmission spectrum shows no transmission in any region; and the absorption spectrum shows strong absorption in all regions.

State 8 in FIG. 41 shows the system when the first fluid is isopropyl alcohol (i.e., absorber) which is absorptive to thermal radiation and heat emissive and the second fluid is 64 mg/mL P25 titanium dioxide (i.e., white solution) resulting in the system being reflective to visible and near-IR light due to the second fluid and absorptive to thermal radiation due to the first fluid. For State 8 the reflection spectrum shows strong reflection in the visible region, moderate reflection in the near-IR region, and no reflection in the MIR region; the transmission spectrum shows no transmission in any region; and the absorption spectrum shows minimal absorption in the visible region, moderate absorption in the near-IR region, and strong absorption in the mid-IR region.

This example demonstrates the simultaneous, independent control of light transmitted through a single system in three dimensions, e.g., scattering direction (forward/transmission or backward/reflection), darkening or shading (absorption), and thermal control (absorption or reflection of mid-IR) using different fluids flowed selectively into and out of separate gaps within the system, consistent with the embodiment described in FIG. 31.

### Example 7

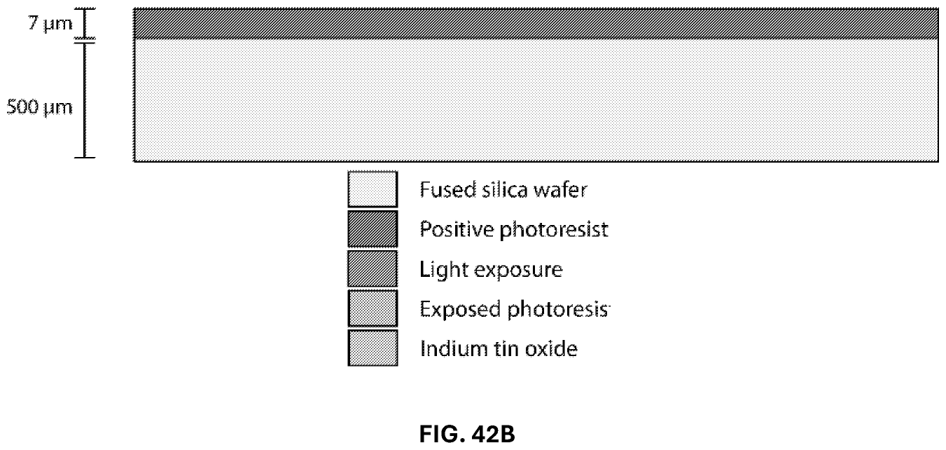

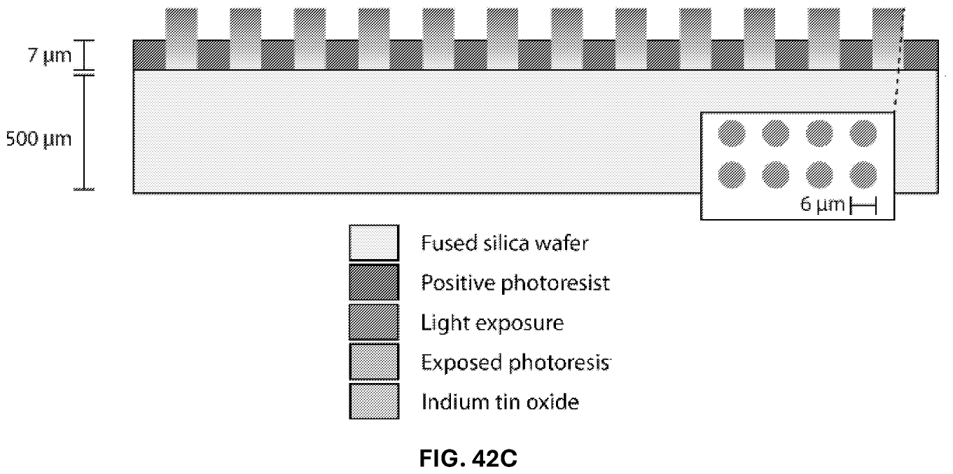

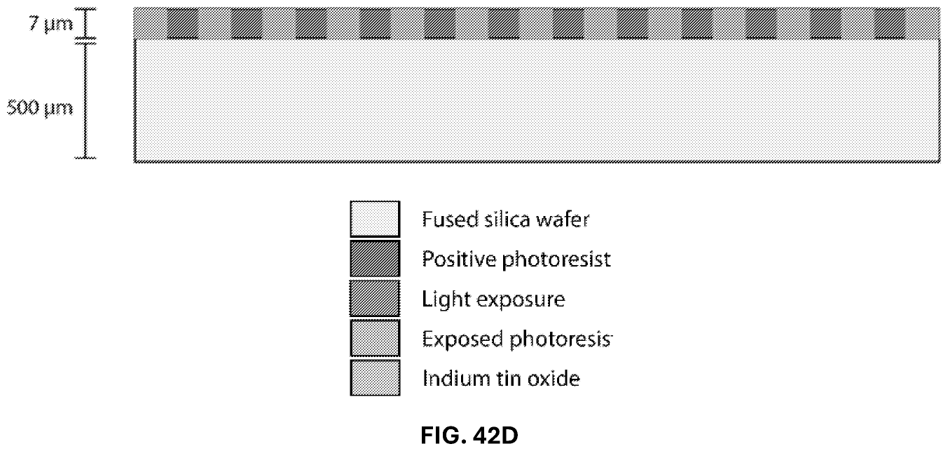

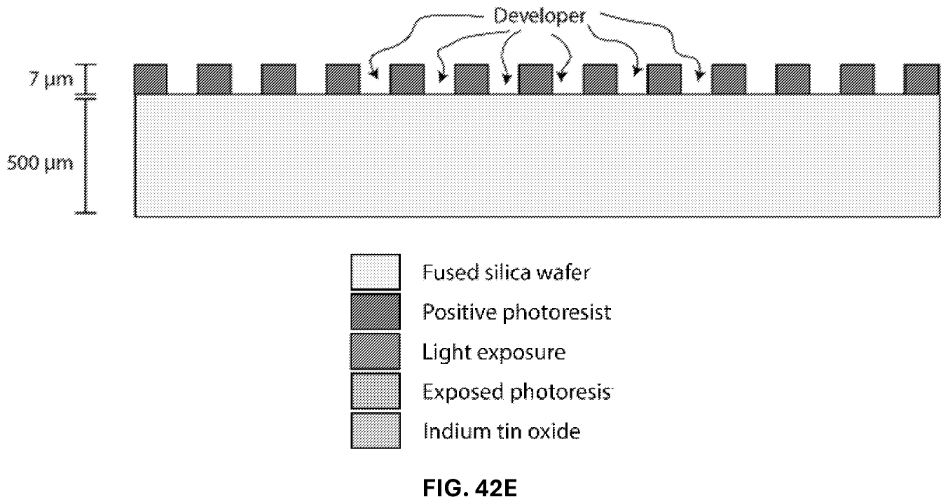

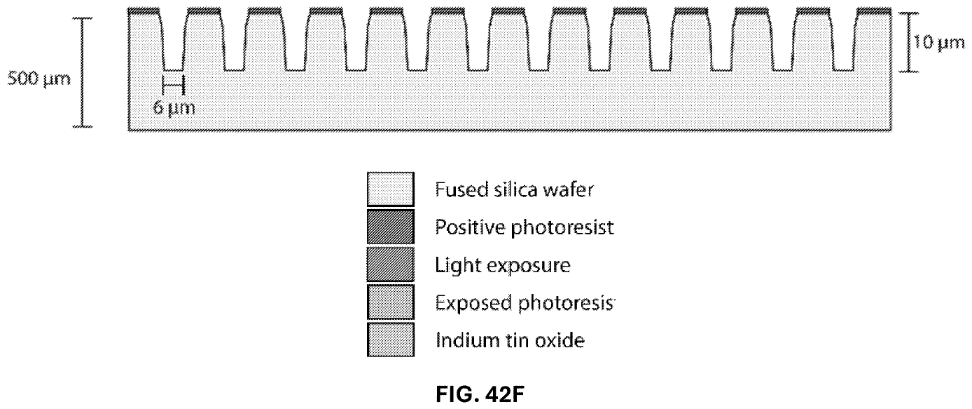

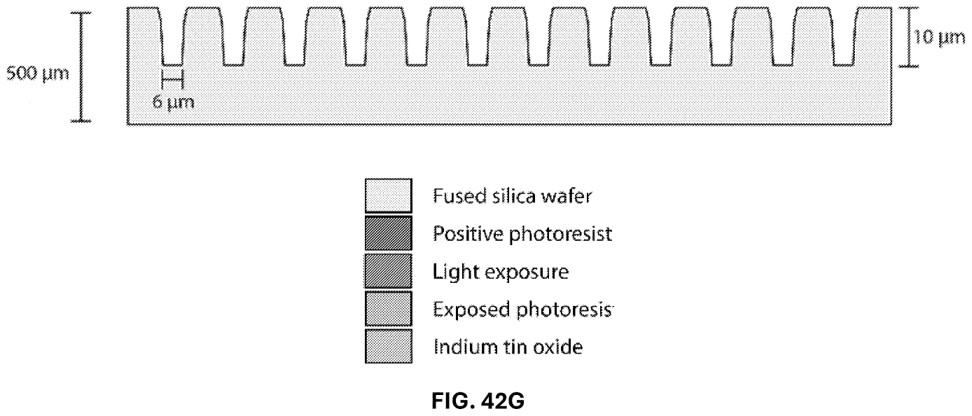

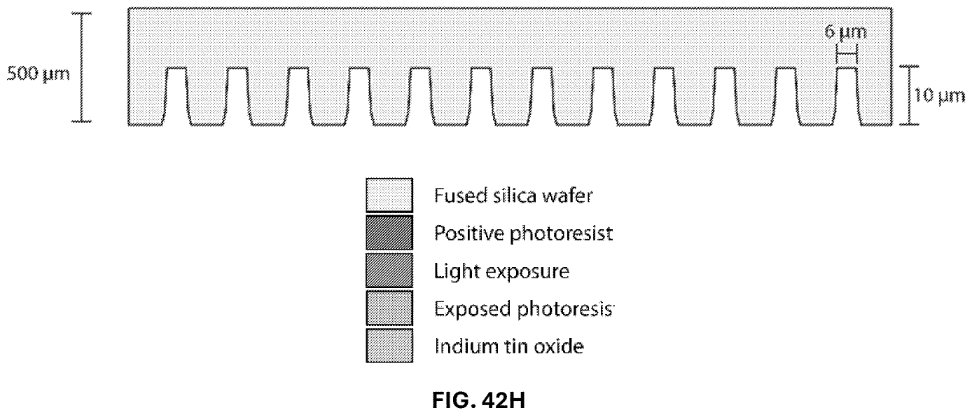

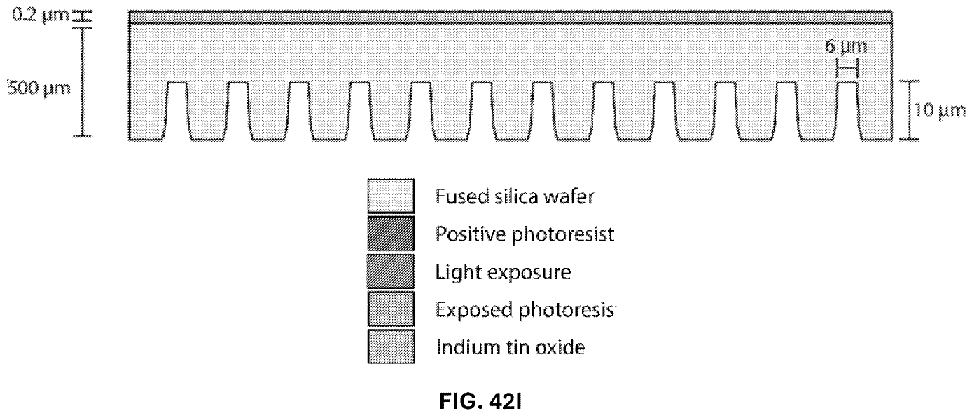

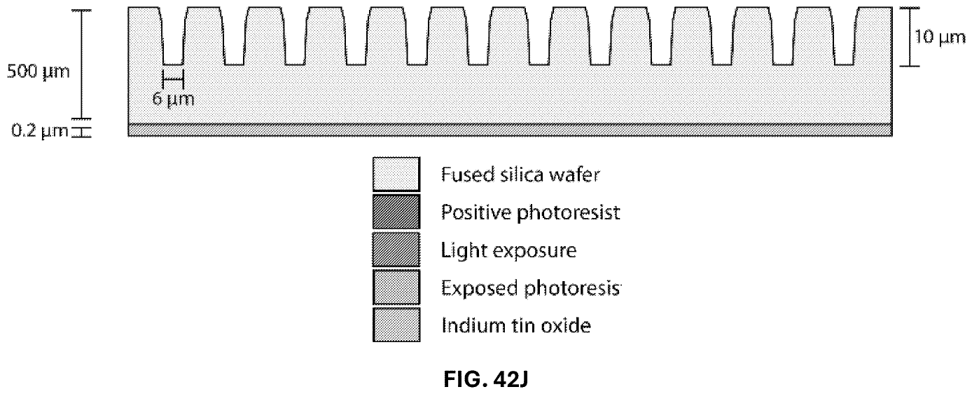

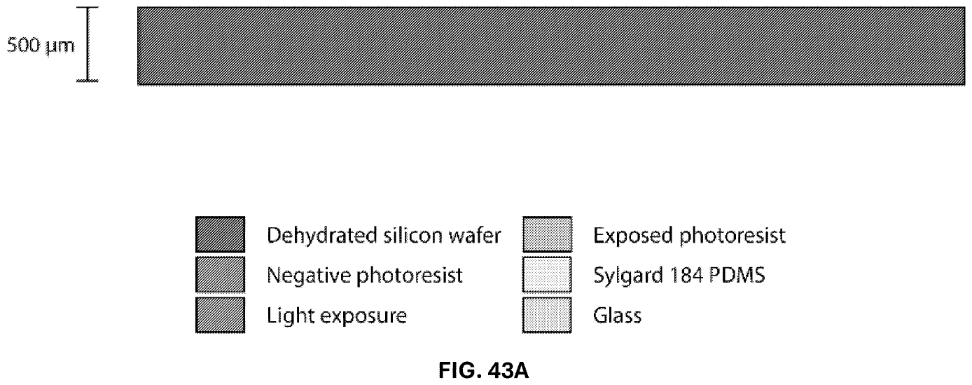

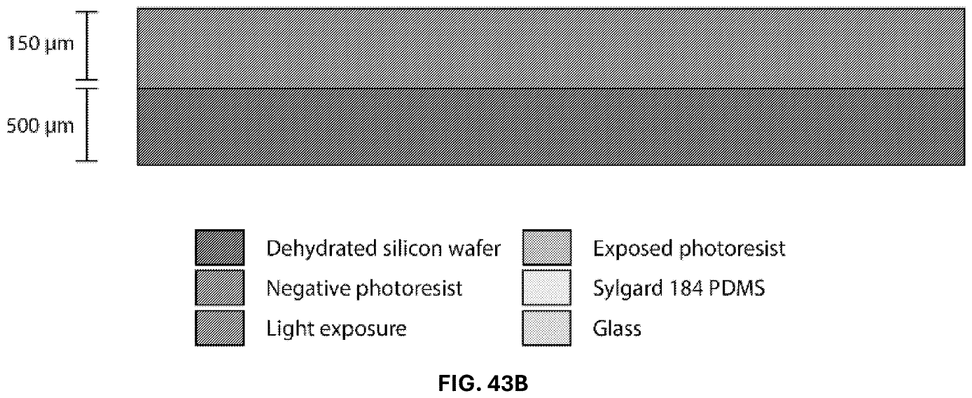

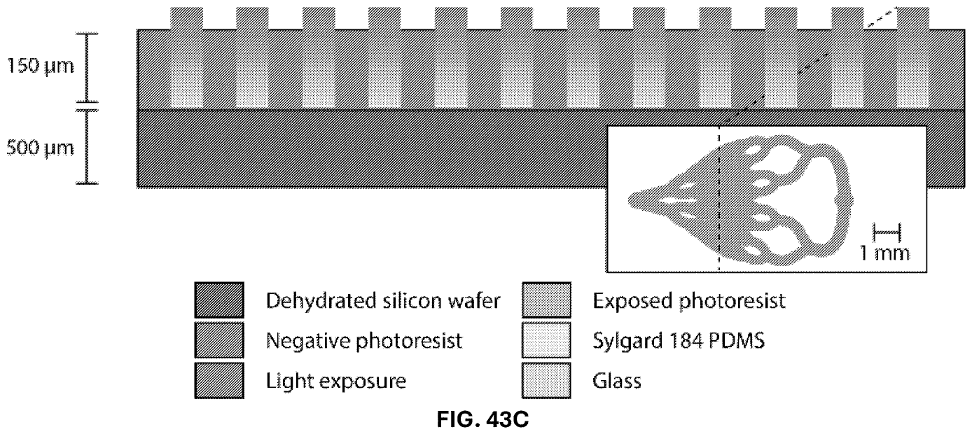

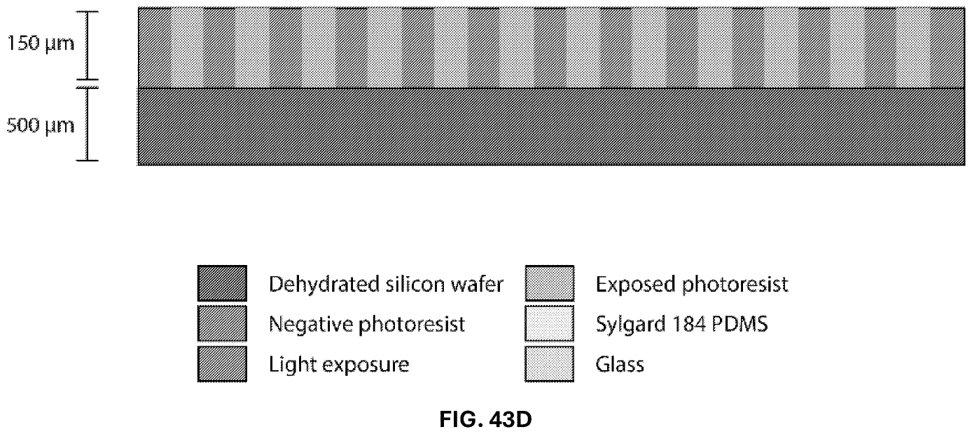

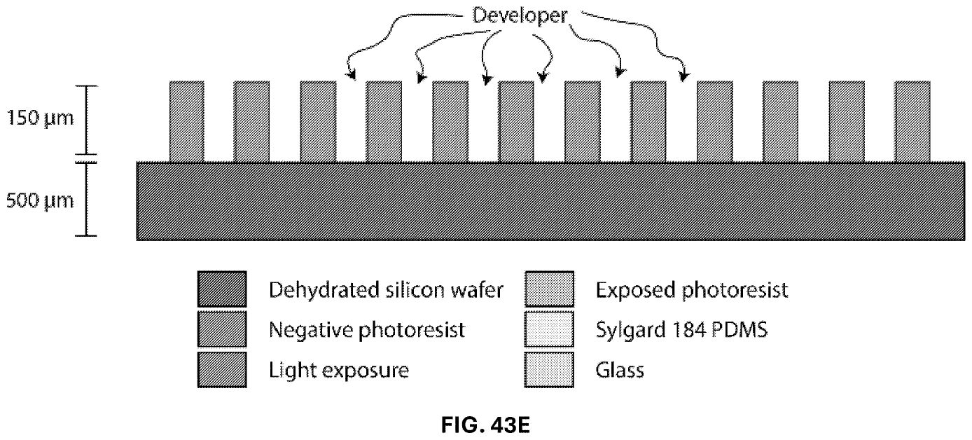

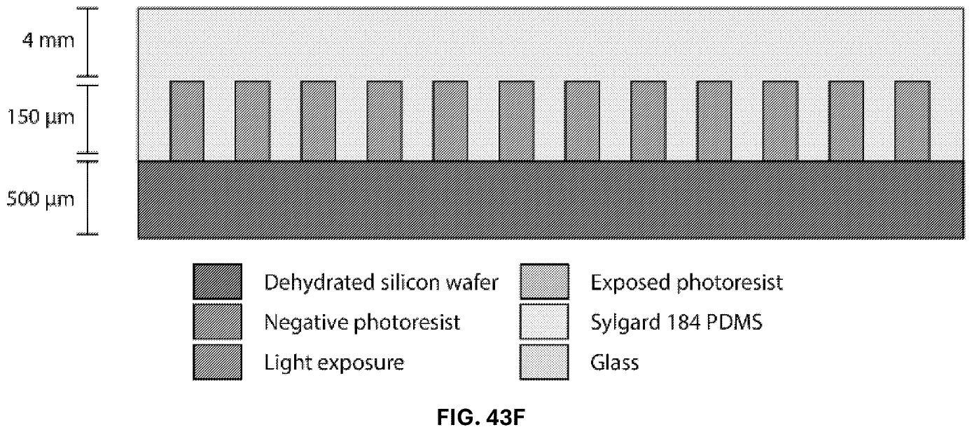

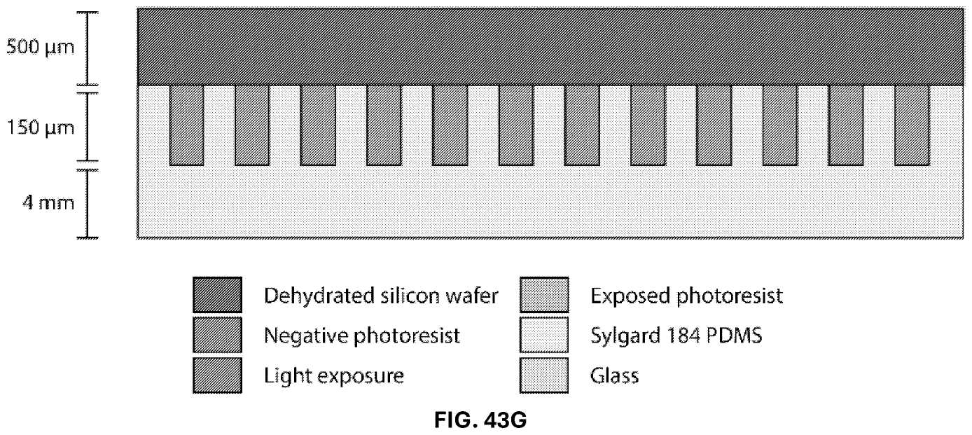

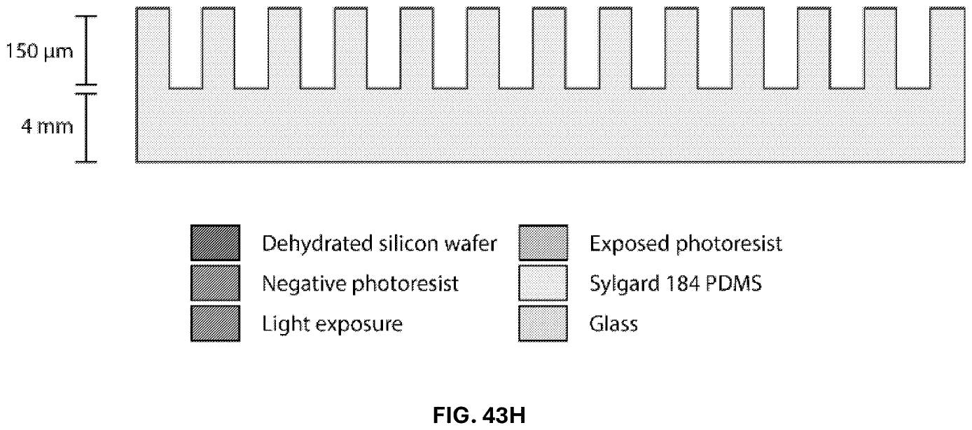

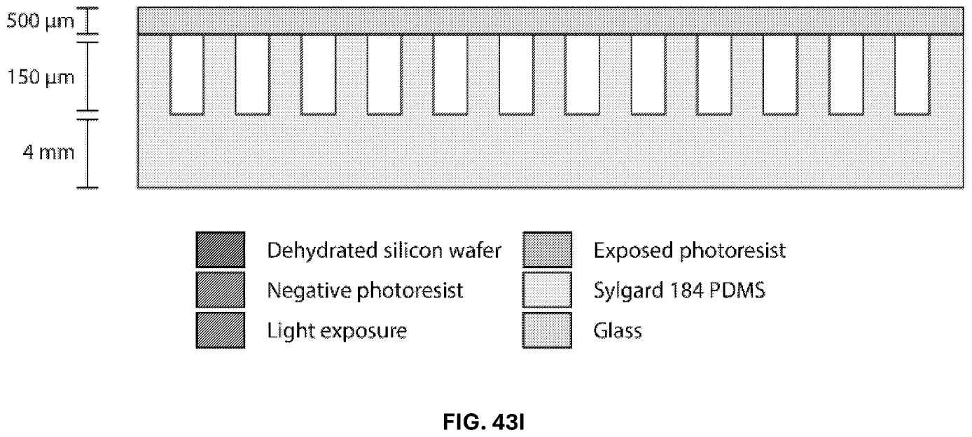

A system was fabricated according to an embodiment of the system shown in FIG. 35. In this example, the first layer is designed from a fused silica glass pane (wafer), which offers both high visible light transparency and high mid-IR emissivity. The mid-IR emissivity is further enhanced by etching repeating cavity micron-scale structures into the glass surface, smoothing the refractive index contrast at the air-glass interface to reduce mid-IR reflectivity without impacting visible transparency. The first gap is gated by selectively infiltrating the first gap with the first fluid (e.g., water), greatly increasing convection and conduction to transfer heat across the first gap or using the absence of the first fluid to insulate the system by reducing heat transfer across the first gap. In addition, the inside face of the first layer includes a transparent coating (e.g., ITO) to minimize radiative heat transfer in the absence of the first fluid and thereby maximize the change in heat transfer between the configurations where the first fluid is present or absent, respectively. Finally, the second layer is a patterned polydimethylsiloxane (PDMS) mold, sealed with glass. A method of fabricating this system is shown in FIGS. 42A-42J and 43A-43I.

FIGS. 42A-42J show the microfabrication procedure of the first layer, i.e., the thermal radiator. As shown in FIG. 42A, a 500-μm-thick 100-mm-diameter double-side-polished fused silica wafer can be cleaned using IPA and acetone in a sonicating bath for three minutes each, and dried using compressed nitrogen gas. FIG. 42B shows an illustration of a 7-μm-thick layer of SPR 220-7.0 positive photoresist (red layer) that can be spin-coated onto the silica wafer. FIG. 42C shows an illustration of a maskless aligner that can be used to expose the photoresist according to the pattern illustrated in the inset. FIG. 42D shows an illustration of the pattern left behind by the aligner. Next, the layer can be developed for 15 minutes in a photoresist developer, as illustrated by FIG. 42E. FIG. 42F illustrates the silica wafer after cavities have been dry-etched to a 10 μm depth using CHF₃—O₂ in reactive-ion etching. The remaining photoresist residue can be plasma-ashed away leaving the layer as illustrated in FIG. 42G. Next, as shown in FIG. 42H, the sample is turned over and cleaned as described in FIG. 42A. Then, by physical vapor deposition methods, a 200 nm thick layer of indium tin oxide (ITO) can be deposited, as shown in FIG. 42I. FIG. 42J shows the thermal radiator for the first layer as constructed.

FIGS. 43A-43I show the microfabrication procedure for a second layer that includes a heat exchanger. As shown in FIG. 43A, a 500-μm-thick 100-mm-diameter double-side-polished fused silica wafer can be cleaned using IPA and acetone in a sonicating bath for three minutes each, and dried using compressed nitrogen gas. As shown in FIG. 43B, a 150-μm-thick layer of SU-8 negative photoresist can be spin-coated onto the silica wafer followed by prebaking the wafer for 20 min at 65° C. The next step, shown in FIG. 43C, is to use a maskless aligner to expose the photoresist according to a prescribed pattern as illustrated. FIG. 43D shows an illustration of the pattern left behind by the aligner. The layer can then be developed for 15 minutes in a photoresist developer resulting in the structure shown in FIG. 43E. FIG. 43F shows an illustration of a process of molding PDMS with the structure fabricated in FIGS. 43A-E. The molding process consists of the following steps: 1) taping the sample from 43E to a 100-mm-diameter petri dish; 2) blowing dust off the sample using compressed nitrogen gas; 3) filling a cup or beaker with Sylgard™ 184 silicone elastomer base and the curing agent in a ~10:1 weight ratio; 4) mixing the solution; 5) applying an anti-stick/stick-release coating to the sample; 6) pouring the mixed elastomer solution into the petri dish to a desired thickness (e.g., 2 mm); 7) degassing the elastomer solution to remove air bubbles; 8) curing the solution in an oven at 70° C. for ~2 hours. Once this procedure is completed, the sample is turned over as shown in FIG. 43G. FIG. 43H shows the sample with the silica wafer removed, leaving the molded PDMS layer. The molded PDMS layer can then be bonded to a plasma-cleaned glass wafer resulting in the structure shown in FIG. 43I.

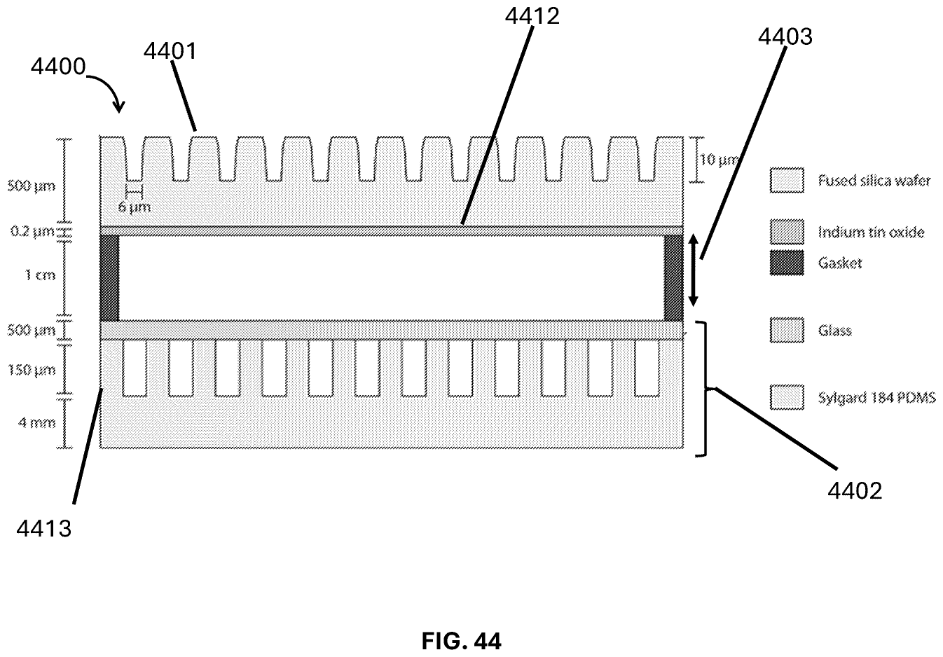

FIG. 44 shows the fully-assembled system 4400 of FIGS. 42A-42J and 43A-43I, where the first layer 4401 that includes a transparent coating 4412 from FIG. 42J and the second layer 4401 that includes a heat exchange layer 4413 from FIG. 43I have been joined together by applying a gasket (e.g., 3M double-sided-tape to a desired thickness) between the first layer 4401 and a second layer 4402 to form a fluid gap 4403. Inlet and outlet ports in the form of needles can be punctured into the gasket and sealed using 2-part epoxy resin, while the flow of the first fluid into and out of the system can be controlled using micro-peristaltic pumps.

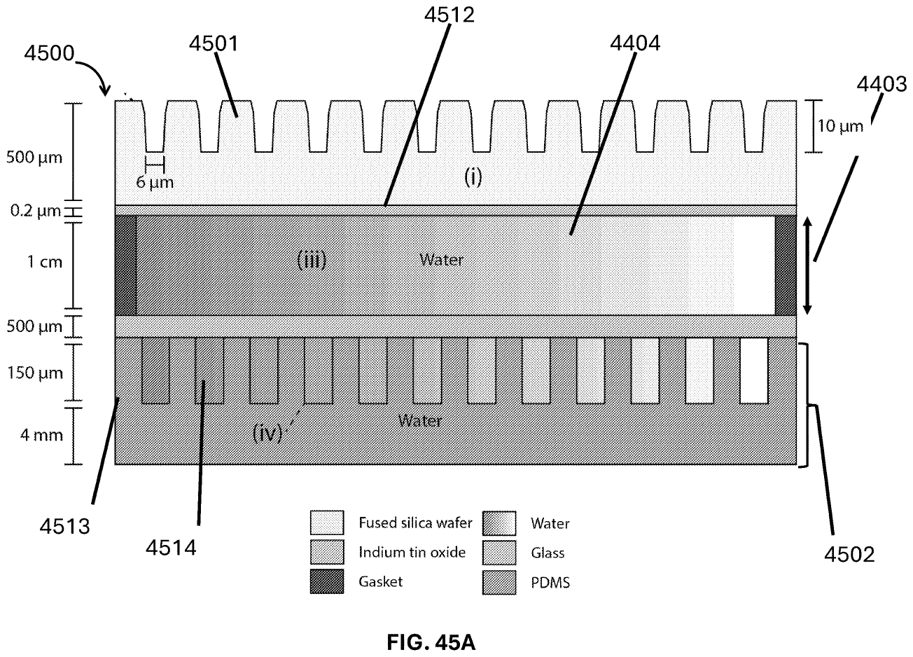

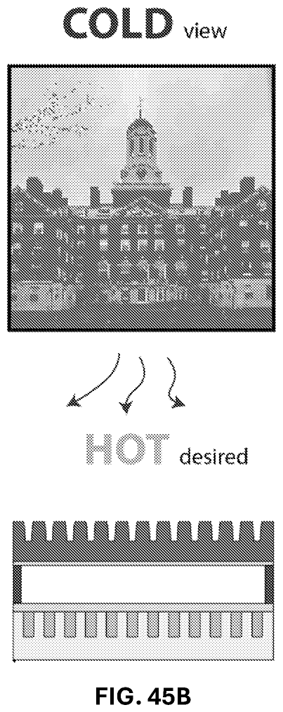

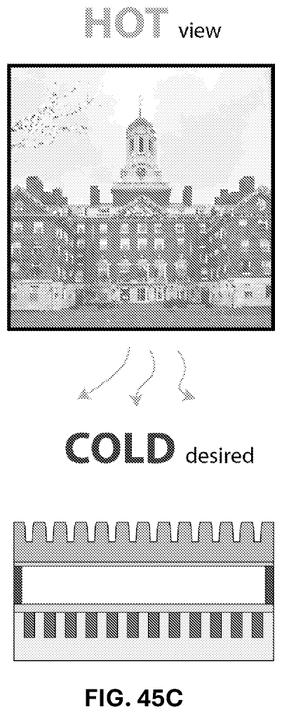

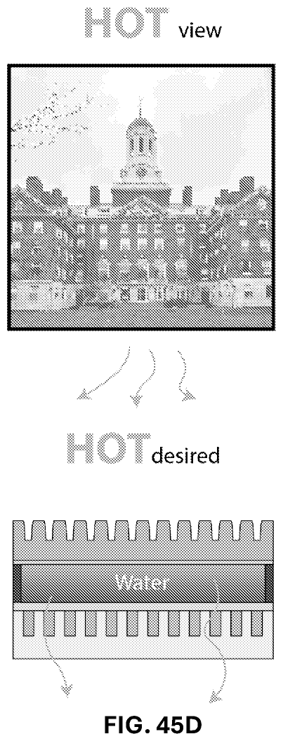

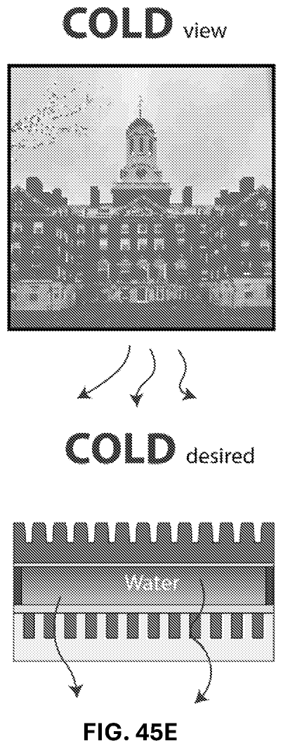

FIGS. 45A-45E show an exemplary schematic of the system of FIG. 35 and illustrations of distinct environmental and operational conditions corresponding to distinct operational modes of the system. FIG. 45A shows an exemplary schematic of the system according to FIG. 44 where the first layer 4501 that includes a transparent coating 4512 and the second layer 4401 that includes a heat exchange layer 4513 have been joined to form a fluid gap 4503. In FIG. 45A, first gap is filled with a first fluid 4504 (water) and a heat transfer fluid 4514 (water) is flowed into the plurality of channels in the heat exchange layer 4513 of the second layer 4502. In this configuration, thermal energy can be absorbed through the first layer by the first fluid in the first gap. The heat absorbed by the first fluid can be transferred through the second layer to the heat transfer fluid where the flow of the heat transfer fluid through the plurality of channels can transfer heat into and out of the system based on the heat absorbed or emitted from the heat transfer fluid.

FIGS. 45B-45E show different configurations of the system. FIG. 45B shows an exemplary configuration of the system to match cold environmental conditions while maintaining warm indoor conditions. In this configuration, the system is configured to retain heat while the external environment is colder than the system. Thus, the system is configured such that the first fluid is absent so that the first gap is filled with air, resulting in the first gap insulating the system from the environment (acting as a thermal barrier) so that the indoor climate remains warm. FIG. 45C shows an exemplary configuration of the system to match hot environmental conditions while maintaining cool indoor conditions. In this configuration, the system is configured to reflect heat while the external environment is hotter than the system. Thus, the system is configured such that the first fluid is absent so that the first gap is filled with air resulting in the first gap insulating the system from the environment (acting as a thermal barrier) so that the indoor climate remains cool. FIG. 45D shows an exemplary configuration of the system to match hot environmental conditions and transfer the environmental heat indoors. In this configuration thermal radiation is absorbed by the first fluid in the first gap (e.g., water) and that heat is transferred from the first fluid to the second layer (acting as a thermal bridge) where it is absorbed in the heat transfer fluid resulting in heat exchange with the indoor climate. FIG. 45E shows an exemplary configuration of the system to match cold environmental conditions and cool the indoor environment. In this configuration, heat from the indoor environment is carried in the heat transfer fluid where it is exchanged from the second layer to the first fluid. The heat absorbed by the first fluid is then transferred to the first layer (acting as a thermal bridge) through the first gap where the first layer then emits that heat energy as thermal radiation to the cooler environment. This example shows the control of heat radiated from the environment to the system or from the system to the environment through the first layer where the radiative heat transfer is coupled with conductive and convective heat transfer through the first fluid to or from the heat transfer fluid in the second layer.

It will be appreciated that while one or more particular materials or steps have been shown and described for purposes of explanation, the materials or steps may be varied in certain respects, or materials or steps may be combined, while still obtaining the desired outcome. Additionally, modifications to the disclosed embodiment and the invention as claimed are possible and within the scope of this disclosed invention.

1. A system comprising:
a first layer comprising a first transparent solid material;
a second layer comprising a second transparent solid material, the second transparent solid material comprising a scattering surface; and
a first gap between the first layer and the scattering surface of the second layer configured to allow a first fluid to selectively flow into and out of the first gap, the presence of the first fluid in the first gap configured to at least one of selectively absorb light between the first layer and the second layer or selectively control scattering of light between the first layer and the second layer by one or more of:
the scattering surface of the second layer;
a refractive index difference between the first fluid and the scattering surface of the second layer; or
suspended particles in the first fluid configured to selectively scatter light;
wherein the system is configured to independently control two or more of intensity of light transmitted, distribution of forward scattering, direction of scattering, and wavelength of light transmitted.

2. The system of claim 1, further comprising
a third layer comprising a third transparent solid material; and
a second gap between the third layer and the first layer or between the third layer and the second layer and configured to allow a second fluid into and out of the second gap, and the presence of the second fluid configured to at least one of selectively scatter, reflect, or absorb light in the second gap.

3. The system of claim 2, wherein one or more of the first transparent solid material, the second transparent solid material, or the third transparent solid material comprises transparent plastics/polymers, glass, quartz, polymethylmethacrylate, polyethylene, polydimethylsiloxane, polyvinyl chloride, polycarbonate, polyurethane, polysulphonate, polytetrafluoroethylene, ethylene-chlorotrifluoroethylene, biaxially oriented polyethylene terephthalate, polypropylene, epoxy, acetal, poly(vinylidene difluoride), poly(vinylidene difluoride-co-hexafluoropropene), poly(vinyl fluoride), poly(styrene), poly(vinyl alcohol), ethyl-cellulose, methyl-cellulose, cellulose acetate, or any combination thereof.

4-6. (canceled)

7. The system of claim 1, wherein the scattering surface comprises a roughened surface, a frosted surface, a patterned surface, a porous surface, an ordered surface, a grated surface, a lens-like surface, a photonic crystal surface, a Fresnel surface, or any combination thereof.

8-12. (canceled)

13. The system of claim 1, wherein the first gap defines a distance between the first layer and the second layer of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm.

14. (canceled)

15. The system of claim 2, wherein the second gap defines a distance between the second layer and the third layer of between 0.1 mm and 10 mm, between 0.1 mm and 5 mm, between 0.1 mm and 1 mm, between 0.5 mm and 10 mm, between 0.5 mm and 5 mm, between 0.5 mm and 1 mm, between 1 mm and 10 mm, between 5 mm and 10 mm, or between 1 mm and 5 mm.

16. (canceled)

17. The system of claim 1, wherein the first fluid comprises water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

18-20. (canceled)

21. The system of claim 1, wherein the first fluid and the scattering surface have the refractive index difference, the refractive index difference is between 0 and 0.6, between 0 and 0.5, between 0.2 and 0.5, or between 0.4 and 0.5.

22-24. (canceled)

25. The system of claim 1, wherein the first fluid comprises a pigment.

26-30. (canceled)

31. The system of claim 1, wherein the first fluid includes the suspended particles and the suspended particles comprise TiO₂, MgO, BaSO₄, CaCO₃, CaHPO4, CaS, AlN, Diamond, Gd₂O₃, Gd₂SiO₅, La₂O₃, LaPO₄, MgAl₂O₄, MgO, Si₃N₄, SiO₂ (crystalline or amorphous), Y₂O₃, ZrO₂, ZrSiO₄, or a combination thereof.

32-45. (canceled)

46. The system of claim 1, wherein the first fluid selectively scatters, reflects, or absorbs light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

47-49. (canceled)

50. The system of claim 2, wherein one or more of the first fluid or the second fluid comprises a plurality of fluids, the plurality of fluids being configured to selectively and independently fill the respective first gap or second gap.

51. The system of claim 50, wherein at least one of the plurality of fluids is a cleansing fluid, the cleansing fluid being immiscible with at least one of the other plurality of fluids, and the cleansing fluid and at least one of the other plurality of fluids are configured to be dynamically exchanged with each other such that the cleansing fluid removes the at least one of the other plurality of fluids from the respective first gap or second gap.

52. (canceled)

53. The system of claim 2, wherein the second fluid comprises water, ethanol, isopropanol, mineral oil, glycerol, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, and vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or any combination thereof.

54. (canceled)

55. The system of claim 2, wherein the second fluid comprises a pigment.

56-60. (canceled)

61. The system of claim 2, wherein the second fluid comprises suspended particles.

62-70. (canceled)

71. The system of claim 2, wherein the second fluid selectively scatters, reflects, or absorbs light having a wavelength of between 300 nm and 30000 nm, between 300 nm and 2500 nm, between 300 nm and 700 nm, between 700 nm and 30000 nm, between 700 nm and 2500 nm, or between 2500 nm and 30000 nm.

72-74. (canceled)

75. The system of claim 2, wherein the system comprises a fourth layer:
the fourth layer comprising a fourth transparent solid material;
the fourth layer disposed on the opposite side of the third layer from the first layer;
a third gap between the third layer and the fourth layer configured to allow a third fluid to selectively flow into and out of the third gap, the presence of the third fluid in the third gap configured to selectively reduce transmission of light between the fourth layer and the third layer.

76-105. (canceled)

106. The system of claim 75, wherein the system comprises a fifth layer:
the fifth layer comprising a fifth transparent solid material;
the fifth layer disposed opposite the second layer from the first layer;
a fourth gap defining a distance of between 5 mm and 50 mm between the second layer and the fifth layer configured to allow a fourth fluid to selectively flow into and out of the fourth gap, the presence of the fourth fluid in the third gap configured to control the convection of heat within the fourth gap and conduction of heat through the fourth gap.

107. (canceled)

108. The system of claim 106, wherein one or more of the first solid material, the second solid material, the third solid material, the fourth solid material, or the fifth solid material comprises a transparent coating.

109-112. (canceled)

113. A system comprising:
a first layer comprising a first transparent solid material;
a second layer comprising at least one second transparent solid material;
at least a first gap between the first layer and the second layer configured to allow at least a first fluid to selectively flow into and out of the first gap, presence of the first fluid in the first gap is configured to at least one of selectively scatter light, reflect light, or absorb light between the first layer and the second layer;
a third layer comprising a third transparent solid material; and
a second gap defining a distance of 5-50 mm between the second layer and the third layer and configured to allow a second fluid to selectively flow into and out of the second gap, the second gap being on an opposite side of the second layer from the first gap, and presence of the second fluid in the second gap is configured to transfer heat energy through the second gap based on convection and conduction of heat in the second fluid.

114-198. (canceled)

199. A system comprising:
a first layer comprising a first transparent solid material;
a second layer comprising a second transparent solid material and a transparent coating, the transparent coating configured to transmit light having a wavelength between 300 nm and 2500 nm and reflect light having wavelength between 2500 nm and 30000 nm;
a first gap between the first layer and the second layer configured to allow a first fluid to selectively flow into and out of the first gap, the presence of the first fluid in the first gap configured to be heat emissive and absorb heat energy having a wavelength between 2500 nm and 30000 nm such that the first fluid in the system absorbs heat energy from an environment outside the first layer or emits heat energy from the first fluid into the environment outside the first layer, and absence of the first fluid reduces absorption or emission of heat energy through the first gap due to the transparent coating of the second layer;
a third layer comprising a third transparent solid material; and
a second gap between the second layer and the third layer configured to allow a second fluid to selectively flow into and out of the second gap, the second gap being on an opposite side of the second layer from the first gap, and the presence of the second fluid in the second gap configured to one or more of selectively scatter, reflect, or absorb light between the second layer and the third layer, or transfer heat energy based on conduction of heat through the second fluid.

200-271. (canceled)

272. A system comprising,
a first layer comprising a first transparent solid material emissive to light having a wavelength between 2500 nm and 30000nm;
a second layer comprising a second transparent solid material; and
a first gap defining a distance of between 5 mm and 50 mm between the first layer and the second layer and configured to allow a first fluid to selectively flow into and out of the first gap, the presence of the first fluid in the first gap configured to transfer heat energy through the first gap based on convection and conduction of heat in the first fluid.

273-334. (canceled)
